(19) United States
(12) Patent Application Publication
(10) Pub. No.: US 2010/0070556 A1
(43) Pub. Date: Mar. 18, 2010

(54) Architectural Design for Data Migration Application Software

(75) Inventors: Knut Heusermann, Bad Schoenborn (DE); Volker Schott, Nussloch (DE); Roland Kaschner, Heidelberg (DE); Sandra Fischbach, Bruchsal (DE); Henry Borreill, Le Cannet (FR); Rene Dehn, Sinsheim (DE); Guillaume Duchene, Suresnes (FR); Olivier Ficatier, Nice (FR); Stefano Gagliardi, Antibes (FR); Axel Haury, Le Cannet (FR); Ebru Polat, Cagnes Sur Mer (FR); Jochen Schmitt, Antibes (FR); Lutz Rosenpflanzer, Valbonne (FR); Michael Jung, Quierschied (DE); Tao Yu, Wiesloch (DE); Dietmar Storz, Heidelberg (DE); Christof Weissenberger, Sinsheim (DE); Gururaj Raman, Bangalore (IN); Simon Dieterich, Heidelberg (DE); Alexandra Mark, Wiesloch (DE); Arun Kumar Reddy, Hanamkonda (IN); Steffen Tatzel, Nussloch (DE); Ralph Meiswinkel, Bad Schoenborn (DE); Christian Haas, Heidelberg (DE); Andrea Sudbrack, Heidelberg (DE); Joachim Barnbeck, Heidelberg (DE); Sabine Lamprecht, Walldorf (DE); Achim Enenkiel, Karlsruhe (DE); Jan Gabriel, Rauenberg (DE); Mathias Sonnek, Oberhausen-Rheinhausen (DE); Jan Rumig, Gondelheim (DE); Stephan Heinz, Heddesheim (DE); Yongbin He, Schriesheim (DE); Achim Heger, Meckesheim (DE); Andreas Reccius, Walldorf (DE); Panagiotis Kokkalis, Rauenberg (DE); Thomas Vogt, Neustadt (DE); Heiko Steffen, Ruelzheim (DE); Christian Boehrer, Hoepfingen (DE); Benjamin Klehr, Rastatt (DE); Simone Jorda, Schwetzingen (DE); Rene Le Maire, Ketsch (DE); Shailaja Police Patil, Bangalore (IN); Klaus Groth, Neckargemuend (DE); Klaus Reinelt, Kraichtal (DE); Yaron Livneh, Tel-Aviv (IL); Petra Meyer, Walldorf (DE); Michael Hartel, Heidelberg (DE); Karsten Kimme, Heidelberg (DE); Benjamin Ringl, Leimen (DE); Ahmed Ali Shah, Indore (IN); Reiner Bildmayer, Bad Schoenborn (DE); Gesa Westberg, Hamburg (DE); Monika Morey, Hattingen (DE); Dirk Rohdemann, Muehlhausen (DE)

Correspondence Address: FISH & RICHARDSON, P.C., PO BOX 1022, MINNEAPOLIS, MN, 55440-1022, US

(73) Assignee: SAP AG

(21) Appl. No.: 12/233,489

(22) Filed: Sep. 18, 2008

(51) Int. Cl. G06F 15/16; G06F 13/00; G06F 9/46; G06F 3/00; G06F 9/44

(52) U.S. Cl. 709/202; 719/313; 719/315; 719/317; 717/120

(57) ABSTRACT

Methods, systems, and apparatus, including computer program products, for implementing a software architecture design for a software application implementing data migration. The application is structured as multiple process components interacting with each other through service interfaces, and multiple service operations, each being implemented for a respective process component. The process components include a Product Property Management process component, a Production Model Management process component, a Business Partner Data Management process component, a Product Data Maintenance process component, an Installed Base Data Management process component, a Price Master Data Management process component, an Identity Management process component, an Engineering Change Processing process component, a Migration Data Dispatching process component, and several other process components.

### BACKGROUND

The subject matter of this patent application relates to computer software architecture, and, more particularly, to the architecture of application software for data migration.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

### SUMMARY

This specification presents a software architecture design for a data migration software application.

In its various aspects, the invention can be implemented its methods, systems, and apparatus, including computer program products, for implementing a software architecture design for a software application implementing data migration. The application is structured as multiple process components interacting with each other through service operations, each implemented for a respective process component. The process components include a Product Property Management process component, a Production Model Management process component, a Business Partner Data Management process component, a Product Data Maintenance process component, an Installed Base Data Management process component, a Price Master Data Management process component, an Identity Management process component, all Engineering Change Processing process component, a Migration Data Dispatching process component, a Due Item Processing process component, an Accounting process component, a Financial Accounting Master Data Management process component, a Payment Processing process component, a Purchase Order Processing process component, a Purchasing Contract Processing process component, an External Procurement Trigger and Response process component, a Supplier Invoice Processing process component, a Sales Order Processing process component, a Service Request Processing process component, a Customer Problem and Solution Administration process component, an Inventory Processing process component, a Project Processing process component, a Personnel Administration process component, a Compensation Management process component, a Time and Labor Management process component, an Employee Payroll Administration process component, a DE Employer Regulatory Compliance process component, a US Employer Regulatory Compliance process component, an AU Employer Regulatory Compliance process component, a CA Employer Regulatory Compliance process component, a CN Employer Regulatory Compliance process component, a DK Employer Regulatory Compliance process component, an FR Employer Regulatory Compliance process component, a GB Employer Regulatory Compliance process component, an IT Employer Regulatory Compliance process component, an NL Employer Regulatory Compliance process component, an SG Employer Regulatory Compliance process component, a ZA Employer Regulatory Compliance process component, an AT Employer Regulatory Compliance process component, and a CH Employer Regulatory Compliance process component.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIGS. 1A-D are block diagrams collectively showing a software architectural design for a data migration software application.

FIG. 2 illustrates the elements of the architecture as they are drawn in the figures.

FIG. 3 is a block diagram showing interactions between a Data Migration System process component and a CN Employer Regulatory Compliance process component.

FIG. 4 is a block diagram showing interactions between the Data Migration System process component and a Migration Data Dispatching process component.

FIG. 5 is a block diagram showing interactions between the Data Migration System process component and an IT Employer Regulatory Compliance process component.

FIG. 6 is a block diagram showing interactions between the Data Migration System process component and a DE Employer Regulatory Compliance process component.

FIG. 7 is a block diagram showing interactions between the Data Migration System process component and a Product Data Maintenance process component.

FIG. 8 is a block diagram showing interactions between a Purchase Order Processing process component and an Accounting process component.

FIG. 9 is a block diagram showing interactions between the Data Migration System process component and a US Employer Regulatory Compliance process component.

FIG. 10 is a block diagram showing interactions between the Migration Data Dispatching process component and a Due Item Processing process component.

FIG. 11 is a block diagram showing interactions between the Data Migration System process component and a GB Employer Regulatory Compliance process component.

FIG. 12 is a block diagram showing interactions between the Data Migration System process component and a Product Property Management process component.

FIG. 13 is a block diagram showing interactions between the Data Migration System process component and a Business Partner Data Management process component.

FIG. 14 is a block diagram showing interactions between the Data Migration System process component and the Purchase Order Processing process component.

FIG. 15 is a block diagram showing interactions between the Data Migration System process component and an Inventory Processing process component.

FIG. 16 is a block diagram showing interactions between the Data Migration System process component and an Installed Base Data Management process component.

FIG. 17 is a block diagram showing interactions between the Migration Data Dispatching process component and a Payment Processing process component.

FIG. 18 is a block diagram showing interactions between the Data Migration System process component and a Sales Order Processing process component.

FIG. 19 is a block diagram showing interactions between the Data Migration System process component and a Service Request Processing process component.

FIG. 20 is a block diagram showing interactions between the Data Migration System process component and the Business Partner Data Management process component related to a supplier.

FIG. 21 is a block diagram showing interactions between the Data Migration System process component and the Accounting process component.

FIG. 22 is a block diagram showing interactions between the Data Migration System process component and a Compensation Management process component.

FIG. 23 is a block diagram showing interactions between the Data Migration System process component and the Product Data Maintenance process component related to a service product, a service product sales process control, a service product financials process control, and a service product procurement process control.

FIG. 24 is a block diagram showing interactions between the Data Migration System process component and a Production Model Management process component.

FIG. 25 is a block diagram showing interactions between the Data Migration System process component and the Accounting process component related to an accounting entry.

FIG. 26 is a block diagram showing interactions between the Data Migration System process component and a Project Processing process component.

FIG. 27 is a block diagram showing interactions between the Data Migration System process component and a DK Employer Regulatory Compliance process component.

FIG. 28 is a block diagram showing interactions between the Data Migration System process component and an NL Employer Regulatory Compliance process component.

FIG. 29 is a block diagram showing interactions between the Data Migration System process component and the Business Partner Data Management process component related to a customer, a payment agreement, and a sales arrangement.

FIG. 30 is a block diagram showing interactions between the Data Migration System process component and a Price Master Data Management process component.

FIG. 31 is a block diagram showing interactions between the Data Migration System process component and the Business Partner Data Management process component related to a business partner.

FIG. 32 is a block diagram showing interactions between the Data Migration System process component and a Financial Accounting Master Data Management process component.

FIG. 33 is a block diagram showing interactions between the Data Migration System process component and an SG Employer Regulatory Compliance process component.

FIG. 34 is a block diagram showing interactions between the Data Migration System process component and a Purchasing Contract Processing process component.

FIG. 35 is a block diagram showing interactions between the Data Migration System process component and an FR Employer Regulatory Compliance process component.

FIG. 36 is a block diagram showing interactions between the Data Migration System process component and the Accounting process component related to an accounting notification.

FIG. 37 is a block diagram showing interactions between the Data Migration System process component and the Production Model Management process component related to a production bill of material.

FIG. 38 is a block diagram showing interactions between the Data Migration System process component and an Engineering Change Processing process component.

FIG. 39 is a block diagram showing interactions between the Data Migration System process component and a CA Employer Regulatory Compliance process component.

FIG. 40 is a block diagram showing interactions between the Data Migration System process component and the Product Data Maintenance process component related to an identified stock.

FIG. 41 is a block diagram showing interactions between the Data Migration System process component and a Personnel Administration process component.

FIG. 42 is a block diagram showing interactions between the Data Migration System process component and the Installed Base Data Management process component related to an installed base.

FIG. 43 is a block diagram showing interactions between the Data Migration System process component and a Customer Problem and Solution Administration process component.

FIG. 44 is a block diagram showing interactions between the Data Migration System process component and the Accounting process component related to a fixed asset and an accounting entry.

FIG. 45 is a block diagram showing interactions between the Data Migration System process component and a ZA Employer Regulatory Compliance process component.

FIG. 46 is a block diagram showing interactions between the Data Migration System process component and an AU Employer Regulatory Compliance process component.

FIG. 47 is a block diagram showing interactions between the Purchase Order Processing process component and a Supplier Invoice Processing process component.

FIG. 48 is a block diagram showing interactions between the Data Migration System process component and the Product Data Maintenance process component related to an individual material and an individual material service process control.

FIG. 49 is a block diagram showing interactions between the Data Migration System process component and the Price Master Data Management process component related to a sales price specification.

FIG. 50 is a block diagram showing interactions between the Data Migration System process component and the Product Data Maintenance process component related to a warranty service process control business and a warranty.

FIG. 51 is a block diagram showing interactions between the Purchase Order Processing process component and an External Procurement Trigger and Response process component.

FIG. 52 is a block diagram showing interactions between the Data Migration System process component and an Identity Management process component.

FIG. 53 is a block diagram showing interactions between the Data Migration System process component and a Time and Labor Management process component.

FIG. 54 is a block diagram showing interactions between the Migration Data Dispatching process component and the Accounting process component.

FIG. 55 is a block diagram showing interactions between the Data Migration System process component and the Migration Data Dispatching process component related to a payment migration list.

FIG. 56 is a block diagram showing interactions between the Data Migration System process component and an Employee Payroll Administration process component.

FIG. 57 is a block diagram showing interactions between the Data Migration System process component and an AT Employer Regulatory Compliance process component.

FIG. 58 is a block diagram showing interactions between the Data Migration System process component and a CH Employer Regulatory Compliance process component.

### DETAILED DESCRIPTION

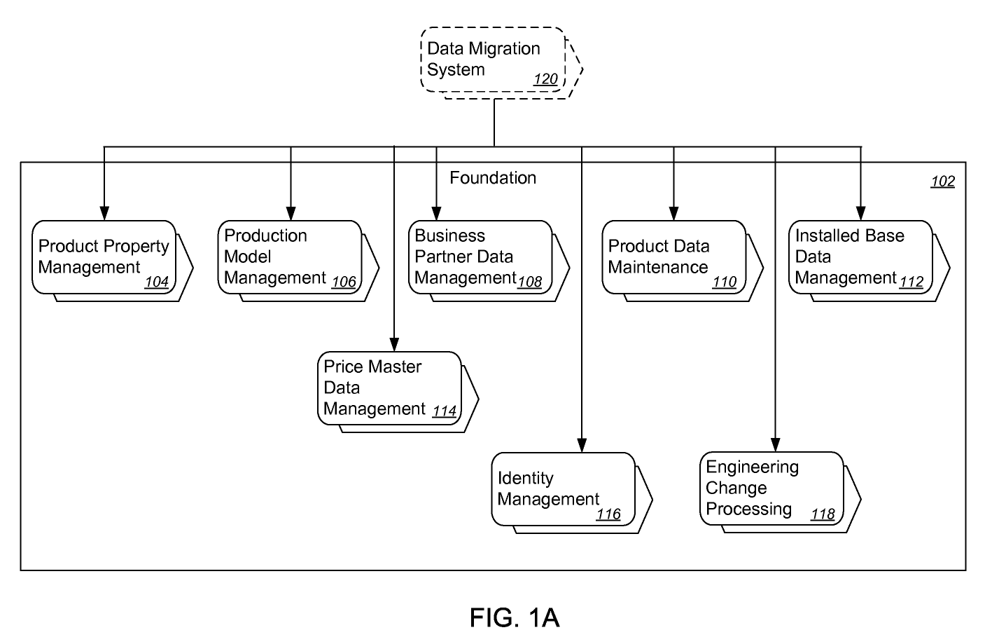

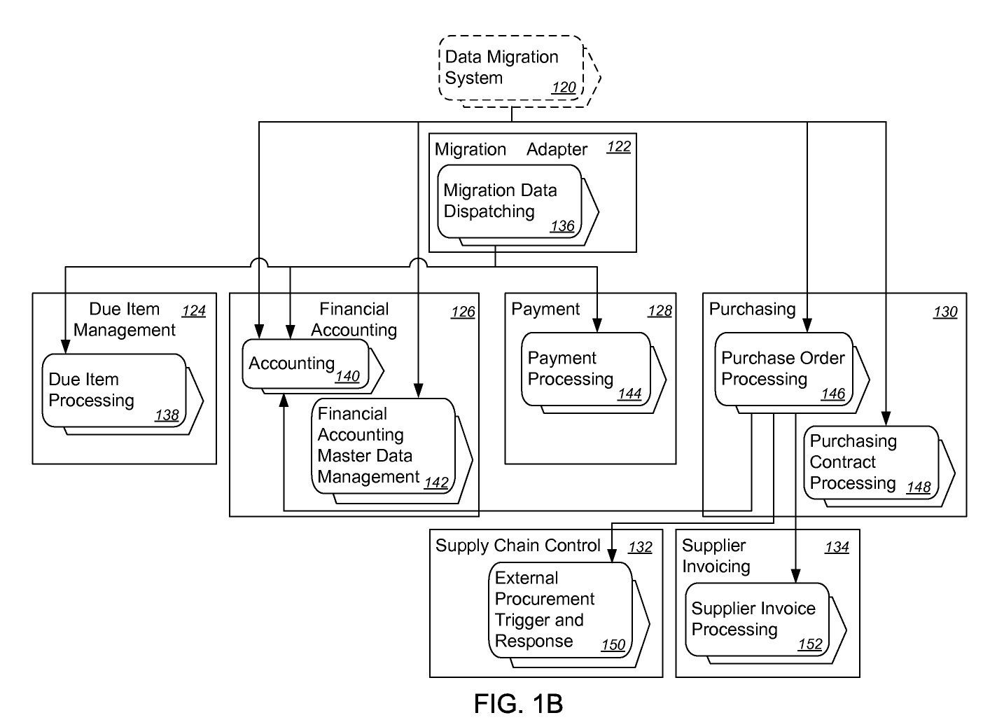

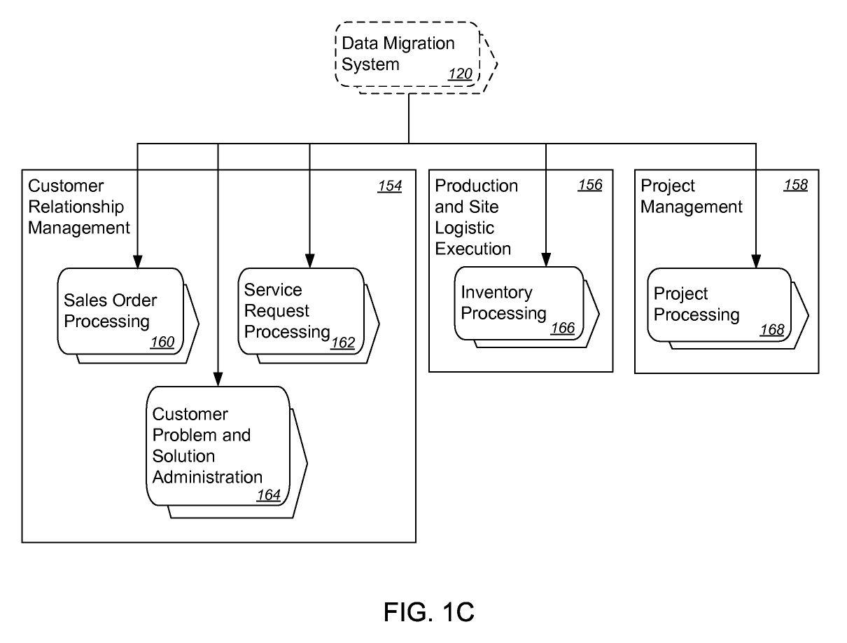

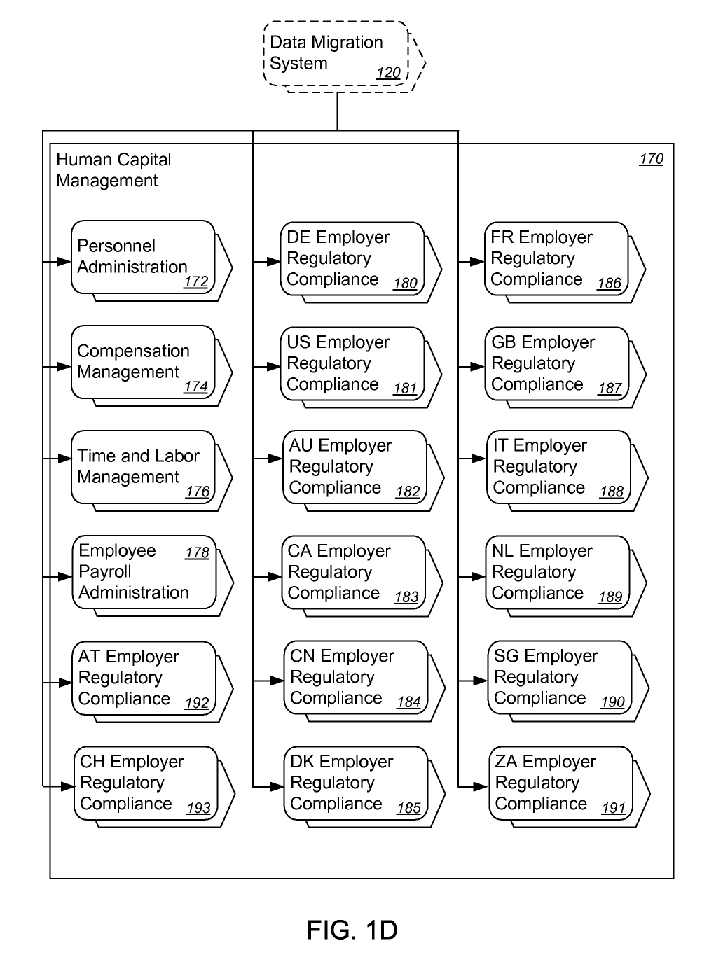

FIGS. 1A-D are block diagrams collectively showing a software architectural design for a data migration software application. The data migration application is software that implements the migration of data from a particular source, for example, a system, or file, to a target system. In some implementations, the data migration process is a one time activity that occurs before a go-live event.

As shown in FIG. 1A, the data migration design includes a Foundation deployment unit 102. The Foundation deployment unit 102 provides a layer of fundamental entities that are used by other deployment units. Entities of the Foundation layer are active in every system instance. The Foundation deployment unit 102 is not conceptually considered a separate deployment unit, though it is depicted in FIG. 1A as such to show its process components. The Foundation deployment unit 102 includes a Product Property Management process component 104 that manages product properties along with their valuations; a Production Model Management process component 106 that maintains and releases master data required for production planning and production execution; a Business Partner Data Management process component 108 that manages all the business partner master data of a company, including the information needed to describe the rights and obligations of a business partner participating in various business processes, such as sales, purchasing, and accounting processes; a Product Data Maintenance process component 110 that maintains all product data that describes a company's tangible and intangible products, and that is used to control business processes such as sales, purchasing, planning, production, and accounting; an Installed Base Data Management process component 112 that manages and structures installed objects, such as personal computers or parts of a software installation, in an installed base, according to their logical or physical location; a Price Master Data Management process component 114 that manages prices and price-related data for sales and procurement processes; an Identity Management process component 116 that handles identifying individuals in a system landscape and controlling their access by associating user rights and restrictions; and an Engineering Change Processing process component 118 that processes changes to master data used in the product life-cycle phases engineering and manufacturing, including the definition of validity parameters and the release of the changes.

As shown in FIG. 1B, the data migration design further includes seven additional deployment units: a Migration Adapter deployment unit 122, a Due Item Management deployment unit 124, a Financial Accounting deployment unit 126, a Payment deployment unit 128, a Purchasing deployment unit 130, a Supply Chain Control deployment unit 132, and a Supplier Invoicing deployment unit 134.

The Migration Adapter deployment unit 122 handles the processing of data that is migrated to more than one deployment unit and that is kept consistent across the deployment units. The Migration Adapter deployment unit 122 includes a Migration Data Dispatching process component 136 that processes data that is migrated to more than one deployment unit and that must be kept consistent across the deployment units.

The Due Item Management deployment unit 124 handles the collection, management, and monitoring of trade receivables or payables and corresponding sales tax or withholding tax. The Due Item Management deployment unit 124 includes a Due Item Processing process component 138 that handles the collection, management, and monitoring of trade receivables or payables and corresponding sales tax or withholding tax.

The Financial Accounting deployment unit 126 handles the recording and valuation of business transactions and the estimation of costs and profits. Financial Accounting is responsible for both financial and management accounting. The Financial Accounting deployment unit 126 includes two process components: an Accounting process component 140 that handles the representation of all relevant business transactions for valuation and profitability analysis; and a Financial Accounting Master Data Management process component 142 that handles the management of financial accounting master data that is used both for accounting and costing purposes.

The Payment deployment unit 128 handles the processing and management of payments, as well as the management and optimization of current and future liquidity. The Payment deployment unit 128 includes a Payment Processing process component 144 that handles the processing and management of all payments. Payment Processing is also responsible for the associated communication with financial institutions such as banks, and provides the primary input for liquidity management.

The Purchasing deployment unit 130 handles the integrated management of the operational purchasing life cycle, covering activities to control and centrally manage purchase requests, manage contracts, perform purchase order collaboration, and confirm goods and services. The Purchasing deployment unit 130 includes two process components: a Purchase Order Processing process component 146 that handles the creation and maintenance of purchase orders and purchase order confirmations; and a Purchasing Contract Processing process component 148 that handles the creation and maintenance of purchasing contracts.

The Supply Chain Control deployment unit 132 handles the management and planning of on-time demand fulfillment. This includes checking availability for demands, matching supplies to demands, monitoring supplies and demands, and triggering the necessary production, procurement, and logistics execution processes. The Supply Chain Control deployment unit 132 includes an External Procurement Trigger and Response process component 150 that handles the management of all the tasks necessary for processing procurement planning orders and the interface to purchasing from a supply planning perspective.

The Supplier Invoicing deployment unit 134 handles the management and volume processing of supplier invoices, including exception handling and approval. The Supplier Invoicing deployment unit 134 includes a Supplier Invoice Processing process component 152 that handles the management and volume processing of supplier invoices, including exception handling and approval.

As shown in FIG. 1C, the data migration design further includes three additional deployment units: a Customer Relationship Management deployment unit 154, a Production and Site Logistics Execution deployment unit 156, and a Project Management deployment unit 158.

The Customer Relationship Management deployment unit 154 handles the management of all customer-related activities within marketing, presales, sales and service. This includes the recording and processing of all interactions throughout the entire customer life cycle. The Customer Relationship Management deployment unit 154 includes three process components: a Sales Order Processing process component 160 that handles the processing of customers' requests to seller for the delivery of goods, on a specific date, for a specific quantity, and for a specific price; a Service Request Processing process component 162 that handles the logging and resolving of service requests concerning issues that customers have, usually with regard to products; and a Customer Problem and Solution Administration process component 164 that handles the administration and maintenance of customer problem and solution master data that has, for example, been migrated or replicated from an external system.

The Production and Site Logistics Execution deployment unit 156 handles the production, assembly, packing, movement, and storage of goods, including the execution of logistic processes, from the receiving of raw materials through to the shipment of a sales item. It includes the management of inbound and outbound deliveries, production, material inspection, site logistics processing, inventory, and physical inventory processing. The Production and Site Logistics Execution deployment unit 156 includes an Inventory Processing process component 166 that handles the management of inventory and recording of inventory changes. It provides services to maintain current stock, content, and structure of logistic units and allocations. The Project Management deployment unit 158 handles the management of simple short-term measures and complex projects. The Project Management deployment unit 158 includes a Project Processing process component 168 that handles the structuring, planning, and execution of simple short-term measures and complex projects.

As shown in FIG. 1D, the data migration design further includes an additional deployment unit: a Human Capital Management deployment unit 170. The Human Capital Management deployment unit 170 handles the management of essential employee-related processes in a company, such as personnel administration, time and labor management, and compensation management. It includes integration with payroll. The Human Capital Management deployment unit 170 includes a Personnel Administration process component 172 that handles the administration of personnel changes concerning employee master data and work agreements; a Compensation Management process component 174 that handles the planning and specification compensation data for employees using appropriate reward strategies, which are based on predefined compensation structures and components; a Time and Labor Management process component 176 that handles the management of employees' planned working times, and the recording and valuation of work performed and absence times; an Employee Payroll Administration process component 178 that handles the administration of the employee specific payroll agreement and the overview of completed and planned payroll processes; a DE Employer Regulatory Compliance process component 180 that handles the administration of employee data and reporting to authorities that employers in Germany are legally obligated to perform; a US Employer Regulatory Compliance process component 181 that handles the administration of employee data and reporting to authorities that employers in the United States of America are legally obligated to perform; an AU Employer Regulatory Compliance process component 182 that combines all activities an employer in Australia is obliged to perform with respect to employees; a CA Employer Regulatory Compliance process component 183 that combines all activities an employer in Canada is obliged to perform with respect to employees; a CN Employer Regulatory Compliance process component 184 that combines all reporting and other administrative activities that employers in China, with respect to employees, are legally obligated to perform; a DK Employer Regulatory Compliance process component 185 that combines all reporting and other administrative activities that an employer in Denmark is obliged to perform with respect to employees; an FR Employer Regulatory Compliance process component 186 that handles the administration of employee data and reporting to authorities that employers in France are legally obligated to perform; a GB Employer Regulatory Compliance process component 187 that handles the administration of employee data and reporting to authorities that employers in the United Kingdom are legally obligated to perform; an IT Employer Regulatory Compliance process component 188 that handles the administration of employee data and reporting to authorities that employers in Italy are legally obligated to perform; an NL Employer Regulatory Compliance process component 189 that combines all activities an employer in the Netherlands is obliged to perform with respect to employees; an SG Employer Regulatory Compliance process component 190 that combines all activities an employer in Singapore is obliged to perform with respect to employees; a ZA Employer Regulatory Compliance process component 191 that combines all activities an employer in South Africa is obliged to perform with respect to employees; an AT Employer Regulatory Compliance process component 192 that combines all reporting and other administrative activities that an employer in Austria is obliged to perform with respect: to employees; and a CH Employer Regulatory Compliance process component 193 that combines all reporting and other administrative activities that an employer in Switzerland is obliged to perform with respect to employees.

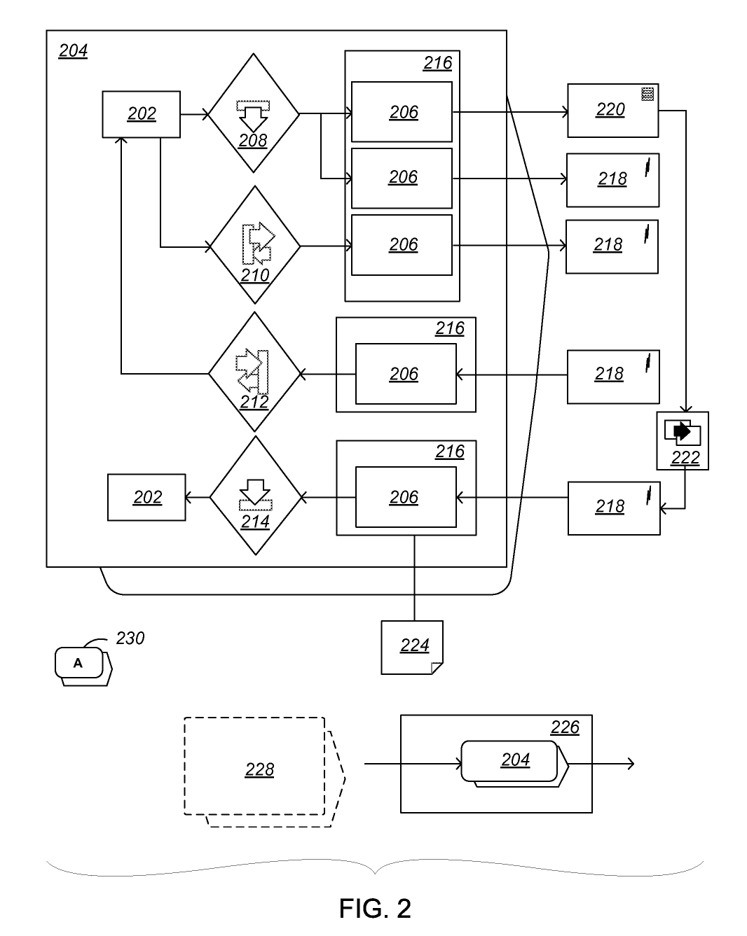

FIG. 2 illustrates the elements of the architecture as they are drawn in the figures of this patent application. The elements of the architecture include the business object 202, the process component 204, the operation 206, the outbound process agent 208, the synchronous outbound process agent 210, the synchronous inbound process agent 212, the inbound process agent 214, the service interface or interface 216, the message 218, the form message 220, the mapping entity 222, the communication channel template 224, and the deployment unit 226.

Not explicitly represented in the figures is a foundation layer that contains all fundamental entities that are used in multiple deployment units 226. These entities can be process components, business objects and reuse service components. A reuse service component is a piece of software that is reused in different transactions. A reuse service component is used by its defined interfaces, which can be, e.g., local APIs (Application Programming Interfaces) or service interfaces.

A process component of an external system is drawn as a dashed-line process component 228. Such a process component 228 represents the external system in describing interactions with the external system; however, the process component 228 need not represent more of the external system than is needed to produce and receive messages as required by the process component that interacts with the external system.

The connector icon 230 is used to simplify the drawing of interactions between process components 204. Interactions between process component pairs 204 involving their respective business objects 202, process agents (at 208, 210, 212, and 214), operations 206, interfaces 216, and messages (at 218 and 22) are described as process component interactions, which determine the interactions of a pair of process components across a deployment unit boundary, i.e., from one deployment unit 226 to another deployment unit 226. Interactions between process components 204 are indicated in FIG. 1 by directed lines (arrows). Interactions between process components within a deployment unit need not be described except to note that they exist, as these interactions are not constrained by the architectural design and can be implemented in any convenient fashion. Interactions between process components that cross a deployment unit boundary will be illustrated by the figures of this patent application; these figures will show the relevant elements associated with potential interaction between two process components 204, but interfaces 216, process agents (at 208, 210, 212, and 214), and business objects 202 that are not relevant to the potential interaction will not be shown.

The architectural design is a specification of a computer software application, and elements of the architectural design can be implemented to realize a software application that implements the end-to-end process mentioned earlier. The elements of the architecture are at times described in this specification as being contained or included in other elements; for example, a process component 204 is described as being contained in a deployment unit 226. It should be understood, however, that such operational inclusion can be realized in a variety of ways and is not limited to a physical inclusion of the entirety of one element in another.

The architectural elements include the business object 202. A business object 202 is a representation of a type of a uniquely identifiable business entity (an object instance) described by a structural model. Processes operate on business objects. This example business object represents a specific view on some well-defined business content. A business object represents content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component 204, is an object that encapsulates transactional data (i.e., data that is valid for a point in time). The term business object will be used generically to refer to a business process object and a master data object, unless the context requires otherwise. Properly implemented, business objects 202 are implemented free of redundancies.

The architectural elements also include the process component 204. A process component 204 is a software package that realizes a business process and generally exposes its functionality as services. The functionality includes the ability to perform all or parts of particular kinds of business transactions. A process component 204 contains one or more semantically related business objects 202. Any business object belongs to no more than one process component. Process components can be categorized as a standard process component, a process component at a business partner, a third party process component, or a user centric process component. The standard process component (named simply process component) is a software package that realizes a business process and exposes its functionality as services. The process component at a business partner is a placeholder for a process component (or other technology that performs the essential functions of the process component) used at a business partner. The third party process component is a process component (or other technology that performs the essential functions of the process component) provided by a third party. The user centric process component is a process component containing user interface parts.

Process components 204 arc modular and context-independent. That they are context-independent means that a process component 204 is not specific to any specific application and is reusable. The process component 204 is often the smallest (most granular) element of reuse in the architecture.

The architectural elements also include the operation 206. An operation 206 belongs to exactly one process component 204. A process component 204 generally is able to perform multiple operations 206. Operations 206 can be synchronous or asynchronous, corresponding to synchronous or asynchronous process agents (e.g. at 208, 210, 212, and 214), which will be described below. Operation 206 may be the smallest, separately-callable function, described by a set of data types used as input, output, and fault parameters serving as a signature.

The architectural elements also include the service interface 216, referred to simply as the interface. An interface 216 is a named group of operations 206. Interface 216 typically specifies inbound service interface functionality or outbound service interface functionality. Each operation 206 belongs to exactly one interface 216. An interface 216 belongs to exactly one process component 204. A process component 204 might contain multiple interfaces 216. In some implementations, an interface contains only inbound or outbound operations, but not a mixture of both. One interface can contain both synchronous and asynchronous operations. All operations of the same type (either inbound or outbound) which belong to the same message choreography will belong to the same interface. Thus, generally, all outbound operations 206 directed to the same other process component 204 are in one interface 216.

The architectural elements also include tie message 218. Operations 206 transmit and receive messages 218. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component. In some implementations, the message is a form based message 220 that can be translated into a recognized format for an external process component 228. The form message type 220 is a message type used for documents structured in forms. The form message type 220 can be used for printing, faxing, emailing, or other events using documents structured in forms. In some implementations, the form message type 220 provides an extended signature relative to the normal message type. For example, the form message type 220 can include text information in addition to identification information to improve human reading.

The architectural elements also include the process agent (e.g. at 208, 210, 212, and 214). Process agents do business processing that involves the sending or receiving of messages 218. Each operation 206 will generally have at least one associated process agent. The process agent can be associated with one or more operations 206. Process agents (at 208, 210, 212, and 214) can be either inbound or outbound, and either synchronous or asynchronous.

Asynchronous outbound process agents 208 are called after a business object 202 changes, e.g., after a create, update, or delete of a business object instance. Synchronous outbound process agents 210 are generally triggered directly by a business object 202.

An outbound process agent (208 and 210) will generally perform some processing of the data of the business object instance whose change triggered the event. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent cam be implemented without knowledge of the exact business object design of the recipient process component.

Inbound process agents (212 and 214) are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents (210 and 212) are used when a process component requires a more or less immediate response from another process component, and is waiting for that response to continue its work.

Operations and process components are described in this specification in terms of process agents. However, in alternative implementations, process components and operations can be implemented without use of agents by using other conventional techniques to perform the functions described in this specification.

The architectural elements also include the communication channel template. The communication channel template is a modeling entity that represents a set of technical settings used for communication. The technical settings can include details for inbound or outbound processing of a message. The details can be defined in the communication channel template. In particular, the communication channel template defines an adapter type, a transport protocol, and a message protocol. In some implementations, various other parameters may be defined based on a selected adapter type. For example, the communication channel template can define a security level, conversion parameters, default exchange infrastructure parameters, processing parameters, download URI parameters, and specific message properties.

The communication channel template 224 can interact with internal or external process components (at 204 and 228). To interact with an internal process component, the communication channel template is received and uploaded to be used with an operation and interface pair. To interact with an external process component, the communication channel template is received and uploaded to be used with an external entity, such as an external bank, business partner, or supplier.

The architectural elements also include the deployment unit 226. A deployment unit 226 includes one or more process components 204 that are deployed together on a single computer system platform. Conversely, separate deployment units can be deployed on separate physical computing systems. For this reason, a boundary of a deployment unit 226 defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components 204 of one instance of one deployment unit 226.

The process components 204 of one deployment unit 226 interact with those of another deployment unit 226 using messages 218 passed through one or more data communication networks or other suitable communication channels. Thus, a deployment unit 226 deployed on a platform belonging one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units 226 is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interaction within other deployment units. Similarly, process components 204 that interact with other process components 204 or external systems only through messages 218, e.g., as sent and received by operations 206, can also be replaced as long as the replacement supports the operations 206 of the original 204. In contrast to a deployment unit 226, the foundation layer does not define a limit for application-defined transactions. Deployment units 226 communicate directly with entities in the foundation layer, which communication is typically not message based. The foundation layer is active in every system instance on which the application is deployed. Business objects 202 in the foundation layer will generally be master data objects. In addition, the foundation layer will include some business process objects that are used by multiple deployment units 226. Master data objects and business process objects that should be specific to a deployment unit 226 are assigned to their respective deployment unit 226.

### Interactions Between Process Components “Data Migration System” and “CN Employer Regulatory Compliance”

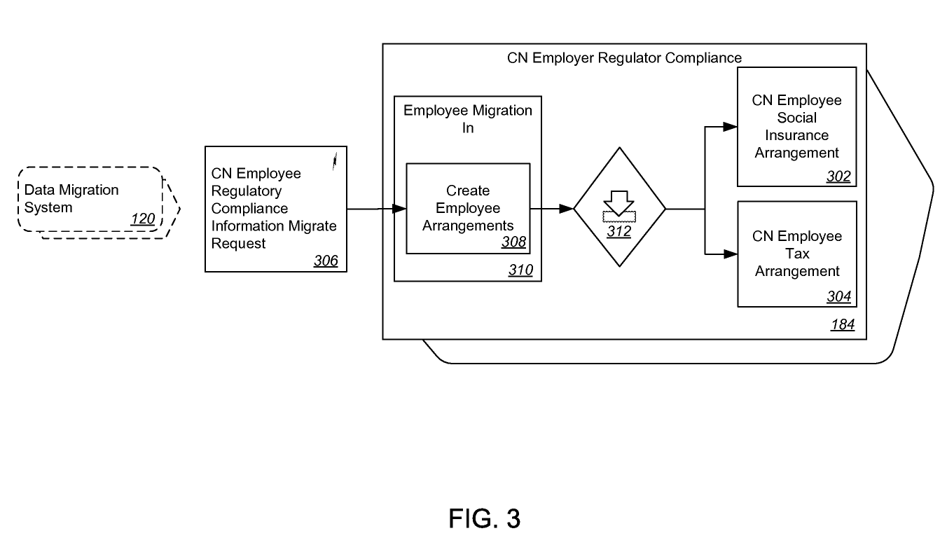

FIG. 3 is a block diagram showing interactions between the Data Migration System process component 120 and the CN Employer Regulatory Compliance process component 184 in the architectural design of FIGS. 1A-D. The Data Migration System process component 120 provides data migration to the CN Employer Regulatory Compliance process component 184. The interaction starts when employee arrangement information is posted.

As shown in FIG. 3, the CN Employer Regulatory Compliance process component 184 includes a CN Employee Tax Arrangement business object 302 and a CN Employee Social Insurance Arrangement business object 304. The CN Employee Tax Arrangement business object 302 represents an arrangement between the employee and the tax authorities of the People's Republic of China that defines the rules of how the employer must calculate and report taxes for this employee to be compliant with the legal requirements. The CN Employee Social Insurance Arrangement business object 304 represents an arrangement for the employee by the People's Republic of China bodies that are legally responsible for administering the employee's social insurance contributions and benefits. This arrangement concerns the information required for calculation of the People's Republic of China social insurance contributions and reporting according to the People's Republic of China Social Insurance Bodies.

A Create Employee Arrangements operation 308 receives a CN Employee Regulatory Compliance Information Migrate Request message 306. The operation 308 is included in an Employee Migration In interface 310. The operation 308 creates business objects for employee arrangements in the CN Employer Regulatory Compliance process component 184. The operation 308 uses a Create CN Employee Arrangements based on Migration inbound process agent 312 to update the CN Employee Tax Arrangement business object 302 and the CN Employee Social Insurance Arrangement business object 304.

### Interactions Between Process Components “Data Migration System” and “Migration Data Dispatching”

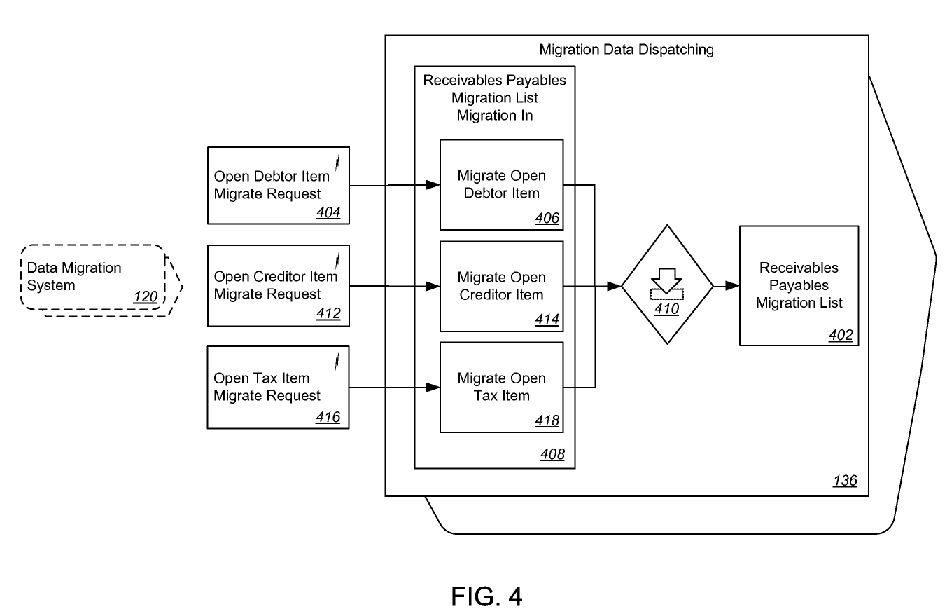

FIG. 4 is a block diagram showing interactions between the Data Migration System process component 120 and the Migration Data Dispatching process component 136 in the architectural design of FIGS. 1A-D. The Data Migration System process component 120 provides data migration requests to the Migration Data Dispatching process component 136. The interaction starts when a migration request is received.

As shown in FIG. 4, the Migration Data Dispatching process component 136 includes a Receivables Payables Migration List business object 402. The Receivables Payables Migration List business object 402 represents a list of open receivables or payables of a company that have to be migrated to a new system.

A Migrate Open Debtor Item operation 406 receives an Open Debtor Item Migrate Request message 404. The operation 406 is included in a Receivables Payables Migration List Migration In interface 408. The operation 406 converts information about open debtor items from the Migration Data Dispatching process component 136 into a receivables payables migration list and forwards this information to Due Item Processing process component 138 and the Accounting process component 140. The operation 406 uses a Migrate Receivables Payables Migration List inbound process agent 410 to update the Receivables Payables Migration List business object 402.

A Migrate Open Creditor Item operation 414 receives an Open Creditor Item Migrate Request message 412. The operation 414 is included in a Receivables Payables Migration List Migration In interface 408. The operation 414 converts information about open creditor items from Migration Data Dispatching into a receivables payables migration list and forwards this information to Due Item Processing and Accounting. The operation 414 uses the Migrate Receivables Payables Migration List inbound process agent 410 to update the Receivables Payables Migration List business object 402.

A Migrate Open Tax Item operation 418 receives an Open Tax Item Migrate Request message 416. The operation 418 is included in a Receivables Payables Migration List Migration In interlace 408. The operation 418 converts information about open tax items from Migration Data Dispatching into a receivables payables migration list and forwards this information to Due Item Processing and Accounting. The operation 418 uses the Migrate Receivables Payables Migration List inbound process agent 410 to update the Receivables Payables Migration List business object 402.

### Interactions Between Process Components “Data Migration System” and “IT Employer Regulatory Compliance”

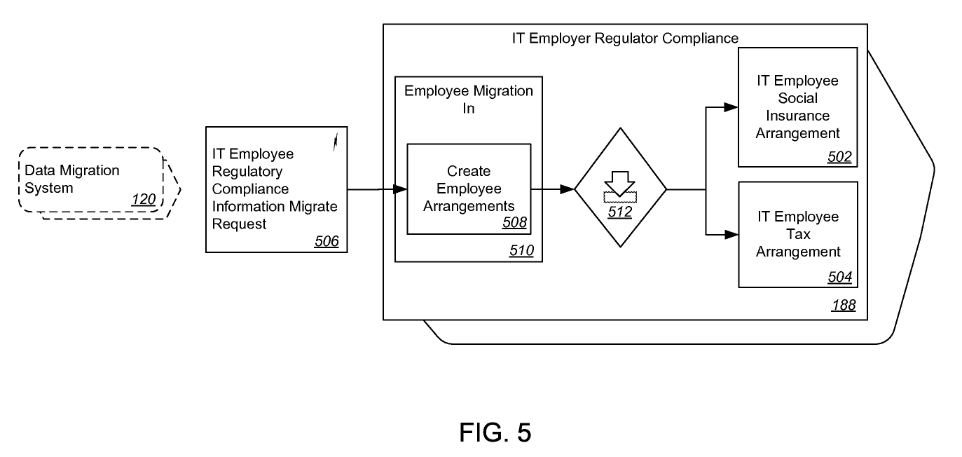

FIG. 5 is a block diagram showing interactions between the Data Migration System process component 120 and the IT Employer Regulatory Compliance process component 188 in the architectural design of FIGS. 1A-D. The Data Migration System process component 120 provides data migration to the IT Employer Regulatory Compliance process component 188. The interaction starts when employee arrangement information is posted.

As shown in FIG. 5, the IT Employer Regulatory Compliance process component 188 includes an IT Employee Tax Arrangement business object 502 and an IT Employee Social Insurance Arrangement business object 504. The IT Employee Tax Arrangement business object 502 represents an arrangement by the responsible tax authorities for the employee concerning calculation and reporting of income tax deductions according to Italian legal requirements. The IT Employee Social Insurance Arrangement business object 504 represents an arrangement for the employee by the Italian bodies that are legally responsible for administering the employee's social insurance contributions and benefits. This arrangement concerns the information required for calculation of Italian social insurance contributions and reporting according to the Italian's Social Insurance bodies.

A Create Employee Arrangements operation 508 receives an IT Employee Regulatory Compliance Information Migrate Request message 506. The operation 508 is included in an Employee Migration In interface 510. The operation 508 creates business objects for employee arrangements in the IT Employer Regulatory Compliance process component 188. The operation 508 uses a Create IT Employee Arrangements based on Migration inbound process agent 512 to update the IT Employee Tax Arrangement business object 502 and the IT Employee Social Insurance Arrangement business object 504.

### Interactions Between Process Components “Data Migration System” and “DE Employer Regulatory Compliance”

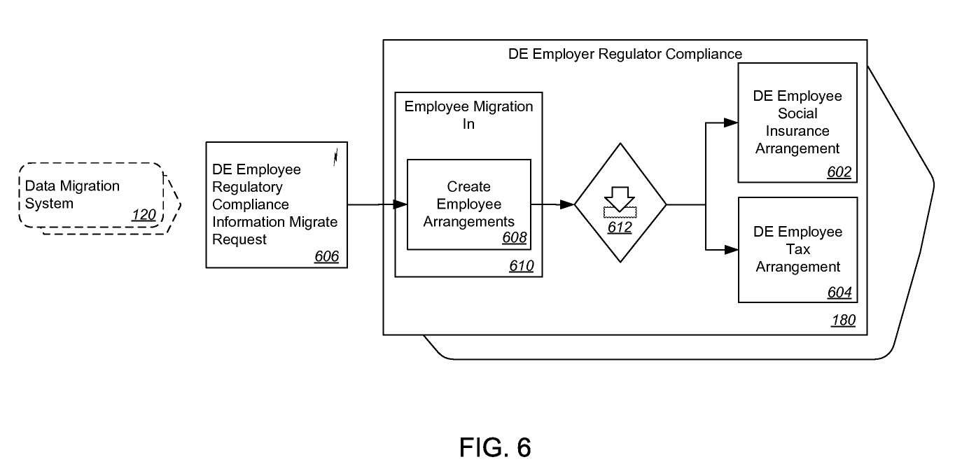

FIG. 6 is a block diagram showing interactions between the Data Migration System process component 120 and the DE Employer Regulatory Compliance process component 180 in the architectural design of FIGS. 1A-D. The Data Migration System process component 120 provides data migration to the DE Employer Regulatory Compliance process component 180. The interaction starts when employee arrangement information is posted.

As shown in FIG. 6, the DE Employer Regulatory Compliance process component 180 includes a DE Employee Tax Arrangement business object 602 and a DE Employee Social Insurance Arrangement business object 604. The DE Employee Tax Arrangement business object 602 represents an arrangement by the German tax authority for the employee, concerning calculation and reporting of income tax deductions according to German legal requirements. The DE Employee Social Insurance Arrangement business object 604 represents an arrangement for the employee by the German bodies that are legally responsible for administering the employee's social insurance contributions and benefits. This arrangement concerns the information required for calculation of German social insurance contributions and reporting according to the German Data Entry and Transfer Regulation.

A Create Employee Arrangements operation 608 receives a DE Employee Regulatory Compliance Information Migrate Request message 606. The operation 608 is included in an Employee Migration In interface 610. The operation 608 creates business objects for employee arrangements in the DE Employer Regulatory Compliance process component 180. The operation 608 uses a Create DE Employee Arrangements based on Migration inbound process agent 612 to update the DE Employee Tax Arrangement business object 602 and the DE Employee Social Insurance Arrangement business object 604.

### Interactions Between Process Components “Data Migration System” and “Product Data Maintenance”

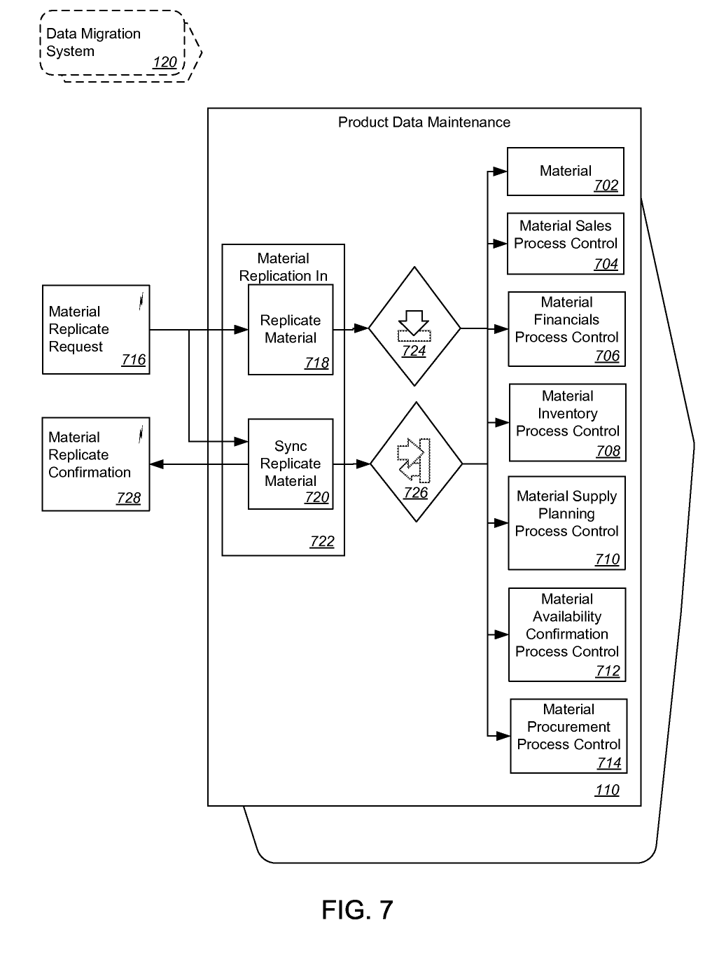

FIG. 7 is a block diagram showing interactions between the Data Migration System process component 120 and the Product Data Maintenance process component 110 in the architectural design of FIGS. 1A-D. The Data Migration System process component 120 provides data migration to the Product Data Maintenance process component 110. The interaction starts when a replicate request is received.

As shown in FIG. 7, the Product Data Maintenance process component 110 includes a Material business object 702, a Material Sales Process Control business object 704, a Material Financials Process Control business object 706, a Material Inventory Process Control business object 708, a Material Supply Planning Process Control business object 710, a Material Availability Confirmation Process Control business object 712, and a Material Procurement Process Control business object 714.

The Material business object 702 represents a tangible product, such as a sellable article, packaging, auxiliary material, and expendable supplies, that can be created and then represents a business value. A material can be traded, consumed, or produced. The Material Sales Process Control business object 704 represents a process-driven view that contains information about a material that is required to use the material in presales, sales, and customer service processes. The Material Financials Process Control business object 706 represents a process-driven view that contains information about a material that is required to use the material in financial processes. The Material Inventory Process Control business object 708 represents a process-driven view that contains information about a material that is required to use the material in logistics processes. The Material Supply Planning Process Control business object 710 represents a process-driven view that contains information about a material that is required to use the material in supply planning processes. The Material Availability Confirmation Process Control business object 712 a represents process-driven view that contains information about a material that is used in availability confirmation processes. The Material Procurement Process Control business object 714 represents a process-driven view that contains information about a material that is required to use the material in procurement-relevant processes.

A Replicate Material operation 718 receives a Material Replicate Request message 716. The operation 718 is included in a Material Replication In interface 722. The operation 718 creates or updates material master data in a target system, using material master data from a source system or file. The operation 718 uses a Replicate Material inbound process agent 724 that migrates or replicates material master data from a source system or file to a target system and updates the business objects 702-714.

A Synchronous Replicate Material operation 720 also receives the Material Replicate Request message 716. The operation 726 is included in the Material Replication In interface 722. The operation 720 creates or updates material master data in a target system, using material master data from a source file. The operation 720 uses a Synchronous Replicate Material synchronous inbound process agent 724 that migrates or replicates material master data from a source system or file to a target system and updates the business objects 702-714. The operation 720 sends a Material Replicate Confirmation message 728.

### Interactions Between Process Components “Purchase Order Processing” and “Accounting”

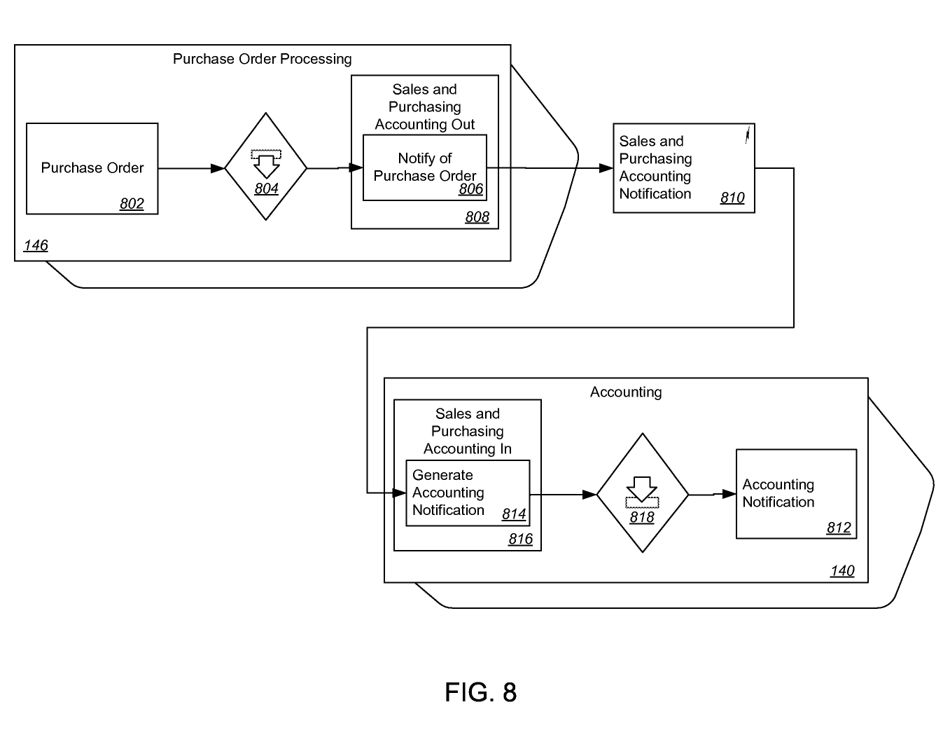

FIG. 8 is a block diagram showing interactions between the Purchase Order Processing process component 146 and the Accounting process component 140 in the architectural design of FIGS. 1A-D. The interaction starts when a purchase order is created or updated. The Purchase Order Processing process component 146 requests the creation or update of sub-ledger accounts (based on purchasing) from the Accounting process component 140.

As shown in FIG. 8, the Purchase Order Processing process component 146 includes a Purchase Order business object 802. The Purchase Order business object 802 represents a request from a buyer to a seller to deliver a specified quantity of material, or perform a specified service, at a specified price within a specified time.

The Purchase Order business object 802 uses a Notify of Purchase Order to Accounting outbound process agent 804 to invoke a Notify of Purchase operation 806. The Notify of Purchase operation 806 sends a notification about a created, changed or cancelled purchase order to the Accounting process component 140. The operation 806 is included in a Sales and Purchasing Accounting Out interface 808. The operation 806 generates a Sales and Purchasing Accounting Notification message 810.

The Accounting process component 140 includes an Accounting Notification business object 812. The Accounting Notification business object 812 represents a notification sent to Financial Accounting by an operational component regarding a business transaction. The notification represents this operational business transaction in a standardized form for all business transaction documents and contains the data needed to valuate the business transaction.

A Create Accounting Notification operation 814 receives the Sales and Purchasing Accounting Notification message 810. The operation 814 is included in a Sales and Purchasing Accounting In interface 816. The operation 814 receives order accounting notification from Service Confirmation Processing, Service Contract Processing, the Service Request Processing process component 162, the Service Order Processing process component 160, the Purchase Order Processing process component 146, and/or the Sales Order Processing process component 160. The notification is to inform Accounting Processing about creation, change, or deletion of any kind of order business objects. The operation 814 uses a Maintain Sub-ledger Account based on Sales and Purchasing inbound process agent 818 to update the Accounting Notification business object 812.

### Interactions Between Process Components “Data Migration System” and “US Employer Regulatory Compliance”

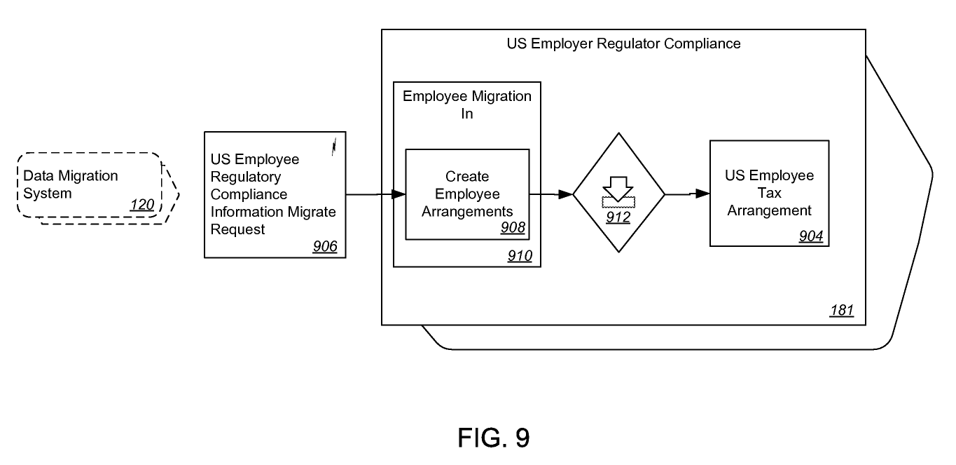

FIG. 9 is a block diagram showing interactions between the Data Migration System process component 120 and the US Employer Regulatory Compliance process component 181 in the architectural design of FIGS. 1A-D. The Data Migration System process component 120 provides data migration to the US Employer Regulatory Compliance process component 181. The interaction starts when employee arrangement information is posted.

As shown in FIG. 9, the US Employer Regulatory Compliance process component 181 includes a US Employee Tax Arrangement business object 902. The US Employee Tax Arrangement business object 902 represents an arrangement by the responsible tax authorities for the employee concerning calculation and reporting of withholding tax according to US federal, state, and local legal requirements.

A Create Employee Arrangements operation 908 receives a US Employee Regulatory Compliance Information Migrate Request message 906. The operation 908 is included in an Employee Migration In interface 910. The operation 908 creates business objects for employee arrangements in the US Employer Regulatory Compliance process component 181. The operation 908 uses a Create US Employee Arrangements based on Migration inbound process agent 912 to update the US Employee Tax Arrangement business object 902.

### Interactions Between Process Components “Migration Data Dispatching” and “Due Item Processing”

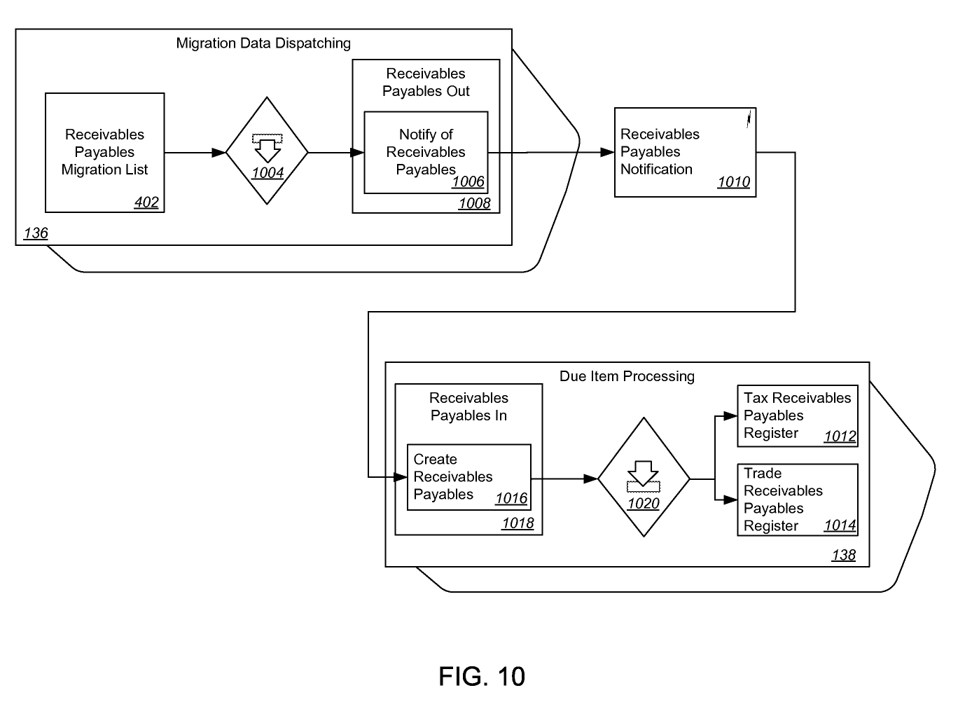

FIG. 10 is a block diagram showing interactions between the Migration Data Dispatching process component 136 and the Due Item Processing process component 138 in the architectural design of FIGS. 1A-D. The interaction starts when open receivables and payables are migrated. The Migration Data Dispatching process component 136 sends open trade and tax receivables and payables to the Due Item Processing process component 138.

As shown in FIG. 10, the Migration Data Dispatching process component 136 includes the Receivables Payables Migration List business object 402. The Receivables Payables Migration List business object 402 represents a list of open receivables or payables of a company that have to be migrated to a new system.

The Receivables Payables Migration List business object 402 uses a Notify of Receivables Payables Migration List to Due Item Processing outbound process agent 1004 to invoke a Notify of Receivables Payables operation 1006. The operation 1006 sends information relevant for due item processing from a receivables payables migration list to the Due Item Processing process component 138. The operation 1006 is included in a Receivables Payables Out interface 1008. The operation 1006 generates a Receivables Payables Notification message 1010.

The Due Item Processing process component 138 includes a Tax Receivables Payables Register business object 1012 and a Trade Receivables Payables Register business object 1014. The Tax Receivables Payables Register business object 1012 represents the register of tax receivables and payables of a company that include: delivered goods and rendered services between buyers and sellers, consumption of goods, transfer of goods, and amounts withheld from payments to sellers. The Trade Receivables Payables Register business object 1014 represents the register of the trade receivables and payables of a company from or to its business partners.

A Create Receivables Payables operation 1016 receives the Receivables Payables Notification message 1010. The operation 1016 is included in a Receivables Payables In interface 1018. The operation 1016 creates a trade or tax receivable or payable. The operation 1016 uses a Maintain Trade and Tax Receivables Payables inbound process agent 1020 to create, change, or cancel a trade or tax receivable or payable and to update the Accounting Notification business object 1012.

### Interactions Between Process Components “Data Migration System” and “GB Employer Regulatory Compliance”

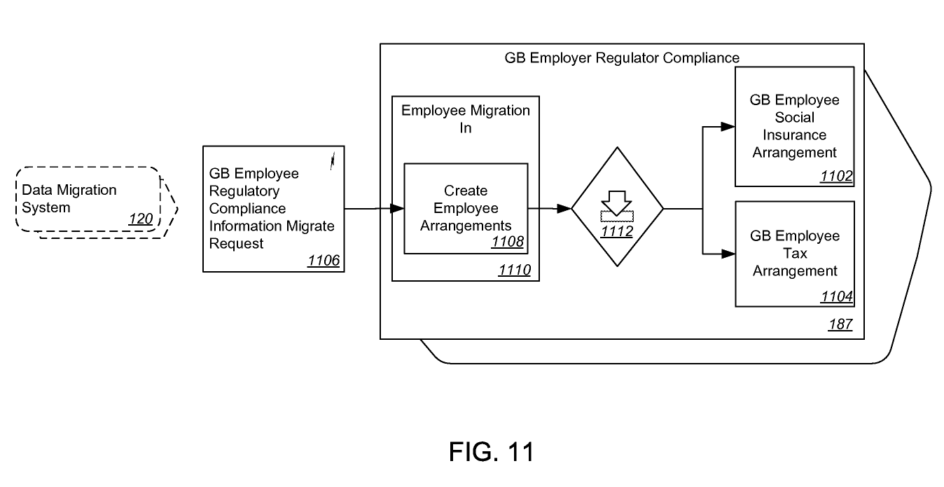

FIG. 11 is a block diagram showing interactions between the Data Migration System process component 120 and the GB Employer Regulatory Compliance process component 187 in the architectural design of FIGS. 1A-D. The Data Migration System process component 120 provides data migration to the GB Employer Regulatory Compliance process component 187. The interaction starts when employee arrangement information is posted.

As shown in FIG. 11, the GB Employer Regulatory Compliance process component 187 includes a GB Employee Tax Arrangement business object 1102 and a GB Employee Social Insurance Arrangement business object 1104. The GB Employee Tax Arrangement business object 1102 represents an arrangement by the United Kingdom tax authority for the employee concerning calculation and reporting of income tax deductions according to United Kingdom legal requirements. The GB Employee Social Insurance Arrangement business object 1104 represents an arrangement for the employee by United Kingdom social insurance authority concerning calculation and reporting of contributions according to the United Kingdom legal requirements.

A Create Employee Arrangements operation 1108 receives a GB Employee Regulatory Compliance Information Migrate Request message 1106. The operation 1108 is included in an Employee Migration In interface 1110. The operation 1108 creates business objects for employee arrangements in the GB Employer Regulatory Compliance process component 187. The operation 1108 uses a Create GB Employee Arrangements based on Migration inbound process agent 1112 to update the GB Employee Tax Arrangement business object 1102 and the GB Employee Social Insurance Arrangement business object 1104.

### Interactions Between Process Components “Data Migration System” and “Product Property Management”

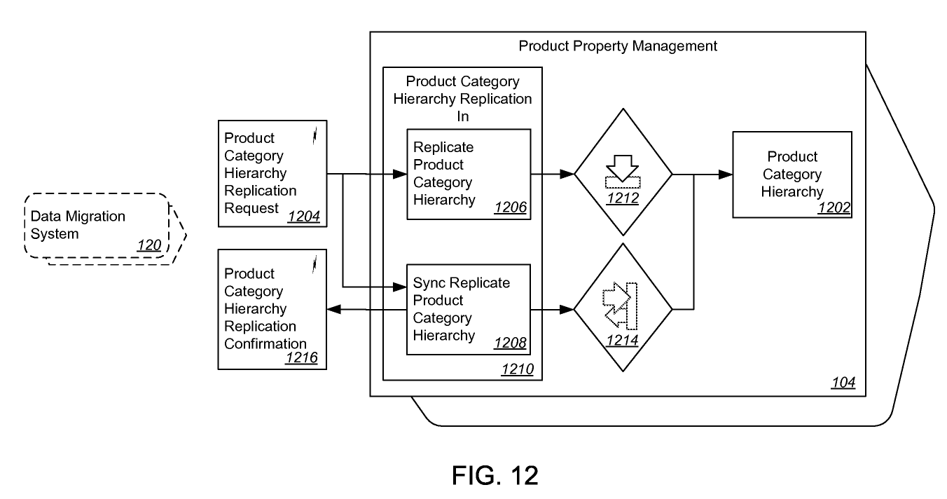

FIG. 12 is a block diagram showing interactions between the Data Migration System process component 120 and the Product Property Management process component 104 in the architectural design of FIGS. 1A-D. The Data Migration System process component 120 provides data migration to the Product Property Management process component 104. The interaction starts when product category hierarchy master data is to be the migrated or replicated from a source system or file to a target system.

As shown in FIG. 12, the Product Property Management process component 104 includes a Product Category hierarchy business object 1202. The Product Category Hierarchy business object 1202 represents a hierarchical arrangement of product categories according to objective business aspects. Subordinate product categories represent a semantic refinement of the respective higher-level product category.

A Replicate Product Category Hierarchy operation 1206 receives a Product Category Hierarchy Replicate Request message 1204. The operation 1206 is included in a Product Category Hierarchy Replication In interface 1208. The operation 1206 creates, updates or deletes product category hierarchy master data in a target system, using product category hierarchy master data from a source system or file. The operation 1206 uses a Replicate Product Category Hierarchy inbound process agent 1212 to migrate or replicate product category hierarchy master data from a source system or file to a target system and to update the Product Category Hierarchy business object 1202.

A Synchronous Replicate Product Category Hierarchy operation 1208 also receives the Product Category Hierarchy Replicate Request message 1204. The operation 1208 is included in the Product Category Hierarchy Replication In interface 1210. The operation 1208 creates, updates, or deletes product category hierarchy master data in a target system, using product category hierarchy master data from a source file. The operation 1208 uses a Synchronous Replicate Product Category Hierarchy synchronous inbound process agent 1214 that migrates or replicates product category hierarchy master data from a source system or file to a target system and updates the Product Category Hierarchy business object 1202. The operation 1208 sends a Product Category Hierarchy Replicate Confirmation message 1216.

### Interactions Between Process Components “Data Migration System” and “Business Partner Data Management”

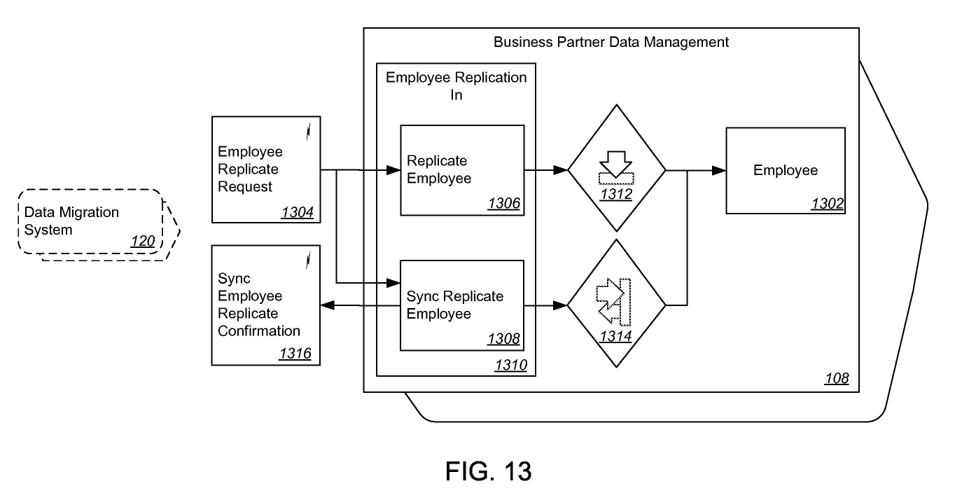

FIG. 13 is a block diagram showing interactions between the Data Migration System process component 120 and the Business Partner Data Management process component 108 in the architectural design of FIGS. 1A-D. The Data Migration System process component 120 provides data migration to the Business Partner Data Management process component 108. The interaction starts when product category hierarchy master data is to be the migrated or replicated from a source system or file to a target system.

As shown in FIG. 13, the Business Partner Data Management process component 108 includes an Employee business object 1302. The Employee business object 1302 represents a person who contributes or has contributed to the creation of goods or services for a company. Employees include both internal and external employees (service performers). Unlike external employees, internal employees are bound by instructions and obliged to adhere to the company's policies and regulations.

A Replicate Employee operation 1306 receives an Employee Replicate Request message 1304. The operation 1306 is included in an Employee Replication In interface 1308. The operation 1306 creates, updates or deletes employee master data in a target system, using employee master data from a source system or file. The operation 1306 uses a Replicate Employee inbound process agent 1312 to migrate or replicate employee master data from a source system or file to a target system and to update the Employee business object 1302.

A Synchronous Replicate Employee operation 1308 also receives the Employee Replicate Request message 1304. The operation 1308 is included in the Employee Replication In interface 1310. The operation 1308 creates, updates, or deletes employee master data in a target system, using employee master data from a source file. The operation 1308 uses a Synchronous Replicate Employee synchronous inbound process agent 1314 that migrates or replicates employee master data from a source system or file to a target system and updates the Employee business object 1302. The operation 1308 sends a Synchronous Employee Replicate Confirmation message 1316.

### Interactions Between Process Components “Data Migration System” and “Purchase Order Processing”

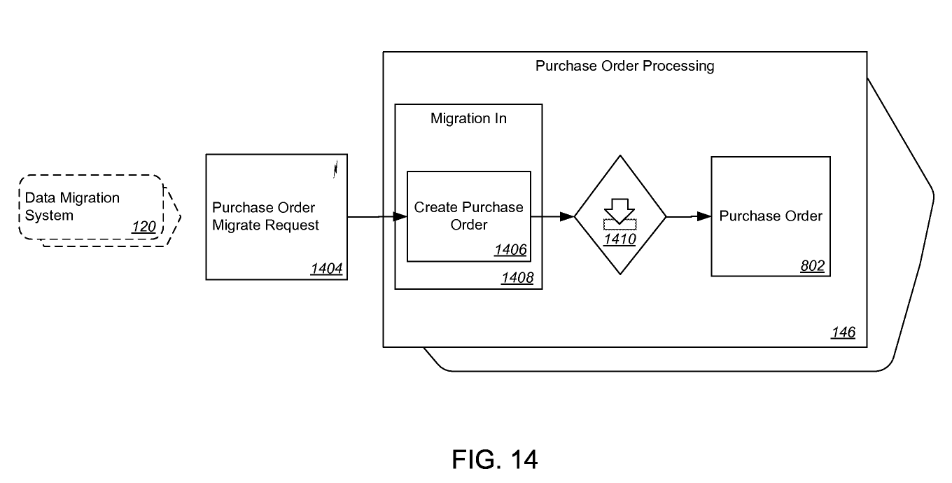

FIG. 14 is a block diagram showing interactions between the Data Migration System process component 120 and the Purchase Order Processing process component 146 in the architectural design of FIGS. 1A-D. The Data Migration System process component 120 provides data migration to the Purchase Order Processing process component 146. The interaction starts when purchase order data is received for migrating from a source to the Purchase Order Processing process component 146.

As shown in FIG. 14, the Purchase Order Processing process component 146 includes the Purchase Order business object 802. The Purchase Order business object 802 represents a request from a buyer to a seller to deliver a specified quantity of material, or perform a specified service, at a specified price within a specified time.

A Create Purchase Order operation 1406 receives a Purchase Order Migrate Request message 1404. The operation 1406 is included in a Migration In interface 1408. The operation 1406 creates a purchase order based on a migrated data. The operation 1406 uses a Create Purchase Order based on Migration inbound process agent 1410 to update the Purchase Order business object 802.

### Interactions Between Process Components “Data Migration System” and “Inventory Processing”

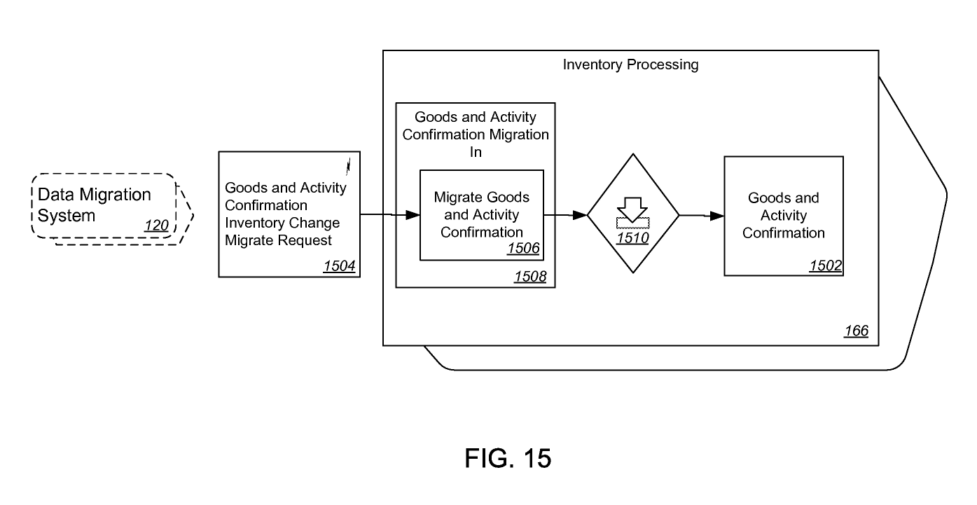

FIG. 15 is a block diagram showing interactions between the Data Migration System process component 120 and the Inventory Processing process component 166 in the architectural design of FIGS. 1A-D. The Data Migration System process component 120 provides data migration to the Inventory Processing process component 166. The interaction starts when inventory data is received for migrating from a source to the Inventory Processing process component 166.

As shown in FIG. 15, the Inventory Processing process component 166 includes a Goods and Activity Confirmation business object 1502. The Goods and Activity Confirmation business object 1502 represents a record of confirmed inventory changes that occurred at a specific time.

A Migrate Goods and Activity Confirmation operation 1506 receives a Goods and Activity Confirmation Inventory Change Migrate Request message 1504. The operation 1506 is included in a Goods and Activity Confirmation Migration In interface 1508. The operation 1506 replicates a goods and activity confirmation data for migration. The operation 1506 uses a Migrate Goods and Activity Confirmation inbound process agent 1510 to update the Goods and Activity Confirmation business object 1502.

### Interactions Between Process Components “Data Migration System” and “Installed Base Data Management”

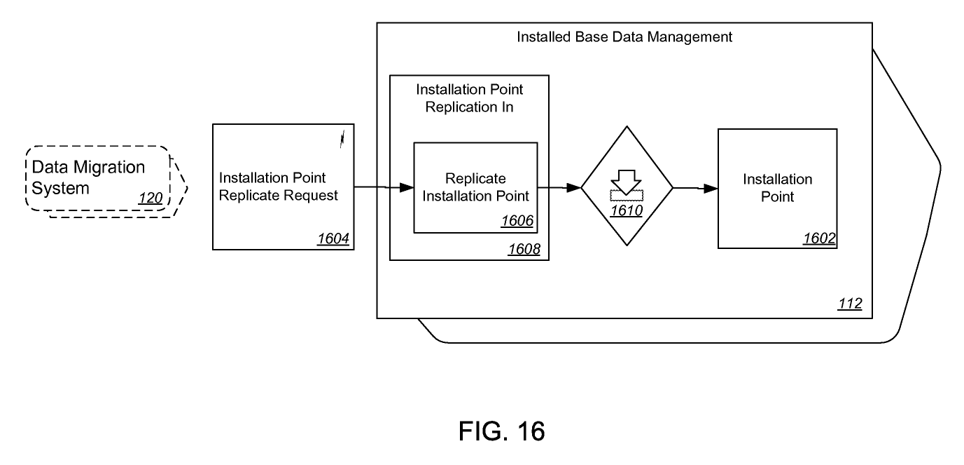

FIG. 16 is a block diagram showing interactions between the Data Migration System process component 120 and the Installed Base Data Management process component 112 in the architectural design of FIGS. 1A-D. The Data Migration System process component 120 provides data migration to the Installed Base Data Management process component 112. The interaction starts when installation point master data from a source system or file to a target system data is received for migrating from a source to the Installed Base Data Management process component 112.

As shown in FIG. 16, the Installed Base Data Management process component 112 includes an Installation Point business object 1602. The Installation Point business object 1602 represents a physical or logical location at which a business object, for example, software or a material, is installed during a certain period of time. An installation point can include descriptive information about its installed object, for example, the quantity of materials used, and can be structured in a hierarchical relationship with other installation points.

A Replicate Installation Point operation 1606 receives an Installation Point Replicate Request message 1604. The operation 1606 is included in an Installation Point Replication In interface 1608. The operation 1606 creates, updates, or deletes installation point master data in a target system, using installation point master data from a source system or file. The operation 1606 uses a Replicate Installation Point inbound process agent 1610 to update the Installation Point business object 1602.

### Interactions Between Process Components “Migration Data Dispatching” and “Payment Processing”

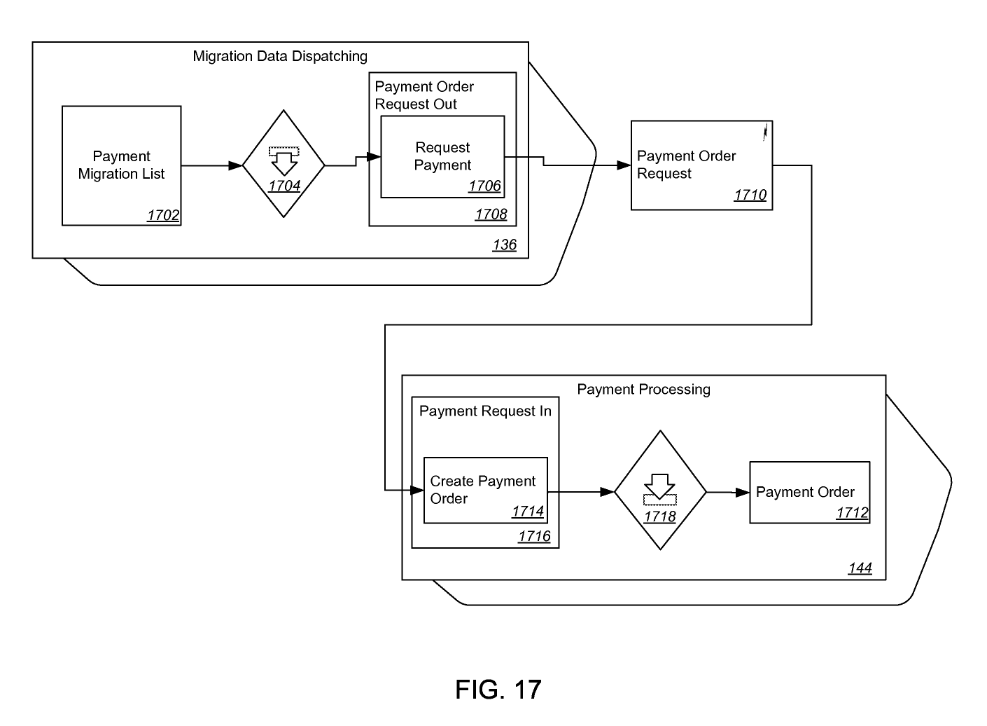

FIG. 17 is a block diagram showing interactions between the Migration Data Dispatching process component 136 and the Payment Processing process component 144 in the architectural design of FIGS. 1A-D. The interaction starts when open payment orders are migrated. The Migration Data Dispatching process component 136 sends payment information that is to be migrated to the Payment Processing process component 144.

As shown in FIG. 17, the Migration Data Dispatching process component 136 includes a Payment Migration List business object 1702. The Payment Migration List business object 1702 represents list of open payments of a company that have to be migrated to a new system.

The Payment Migration List business object 1702 uses a Notify of Payment Migration List to Payment Processing outbound process agent 1704 to invoke a Request Payment operation 1706. The operation 1706 sends information relevant for payment processing to the Payment Processing process component 144. The operation 1706 is included in a Payment Order Request Out interface 1708. The operation 1706 generates a Payment Order Request message 1710.

The Payment Processing process component 144 includes a Payment Order business object 1712. The Payment Order business object 1712 represents an order within a company to make a payment to a business partner at a specified time. A payment order can be a collective order that contains several individual orders.

A Create Payment Order operation 1714 receives the Payment Order Request message 1710. The operation 1714 is included in a Payment Request In interface 1716. The operation 1714 creates a request for payment. The operation 1714 uses a Maintain Payment Order inbound process agent 1718 to update the Payment Order business object 1712.

### Interactions Between Process Components “Data Migration System” and “Sales Order Processing”

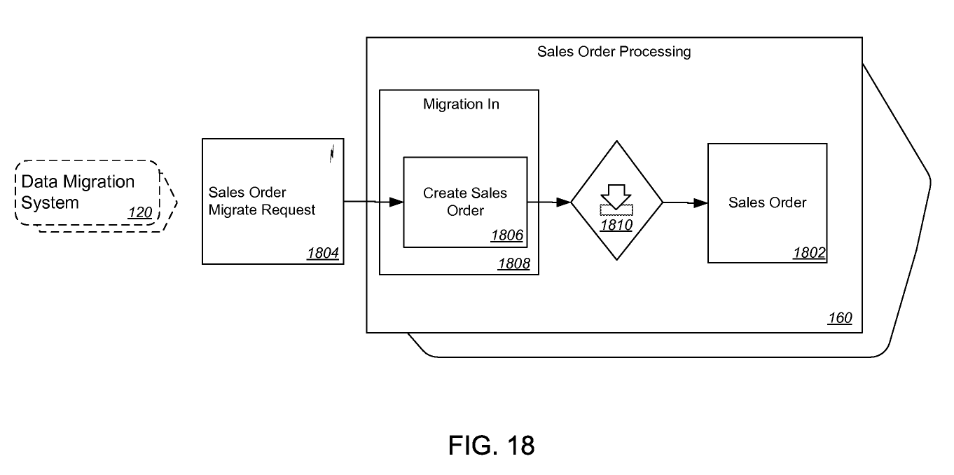

FIG. 18 is a block diagram showing interactions between the Data Migration System process component 120 and the Sales Order Processing process component 160 in the architectural design of FIGS. 1A-D. The Data Migration System process component 120 provides data migration to the Sales. Order Processing process component 160. The interaction starts when sales order data is received for migrating from a source to the Sales Order Processing process component 160.

As shown in FIG. 18, the Sales Order Processing process component 160 includes a Sales Order business object 1802. The Sales Order business object 1802 represents an agreement between a seller and a customer concerning the sale and delivery of goods, as well as any services that are associated with these processes, on a specific date, for a specific quantity, and for a specific price.

A Create Sales Order operation 1806 receives a Sales Order Migrate Request message 1804. The operation 1806 is included in a Migration In interface 1808. The operation 1806 creates a sales order based on a migrated data. The operation 1806 uses a Create Sales Order based on Migration inbound process agent 1810 to update the Sales Order business object 1802.

### Interactions Between Process Components “Data Migration System” and “Service Request Processing”

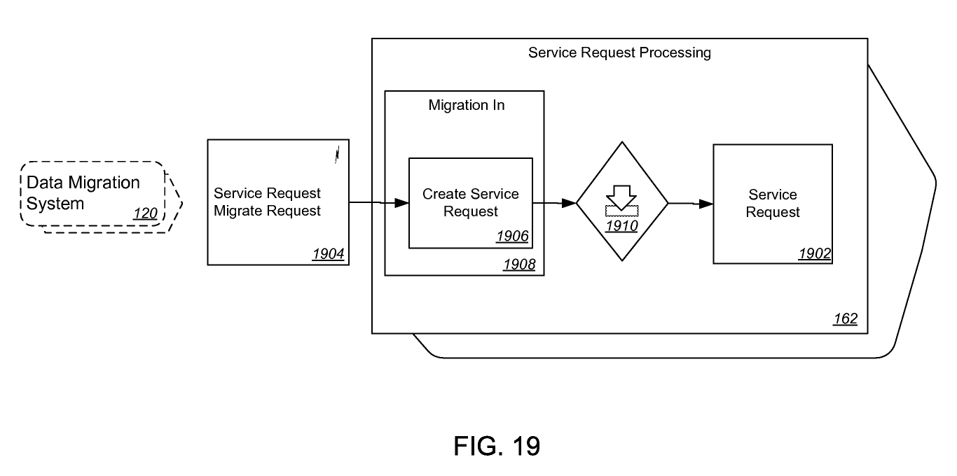

FIG. 19 is a block diagram showing interactions between the Data Migration System process component 120 and the Service Request Processing process component 162 in the architectural design of FIGS. 1A-D. The Data Migration System process component 120 provides data migration to the Service Request Processing process component 162. The interaction starts when service request data is received for migrating from a source to the Service Request Processing process component 162.

As shown in FIG. 19, the Service Request Processing process component 162 includes a Service Request business object 1902. The Service Request business object 1902 represents a request from a customer to a service provider to solve an issue that the customer has with regard to a product. In addition to the description and the categorization of the issue, the Service Request can include the documentation and the results of the resolution, as well as the expenses incurred.

A Create Service Request operation 1906 receives a Service Request Migrate Request message 1904. The operation 1906 is included in a Migration In interface 1908. The operation 1906 creates a service request based on a migrated data. The operation 1906 uses a Create Service Request based on Migration inbound process agent 1910 to update the Service Request business object 1902.

### Interactions Between Process Components “Data Migration System” and “Business Partner Data Management”

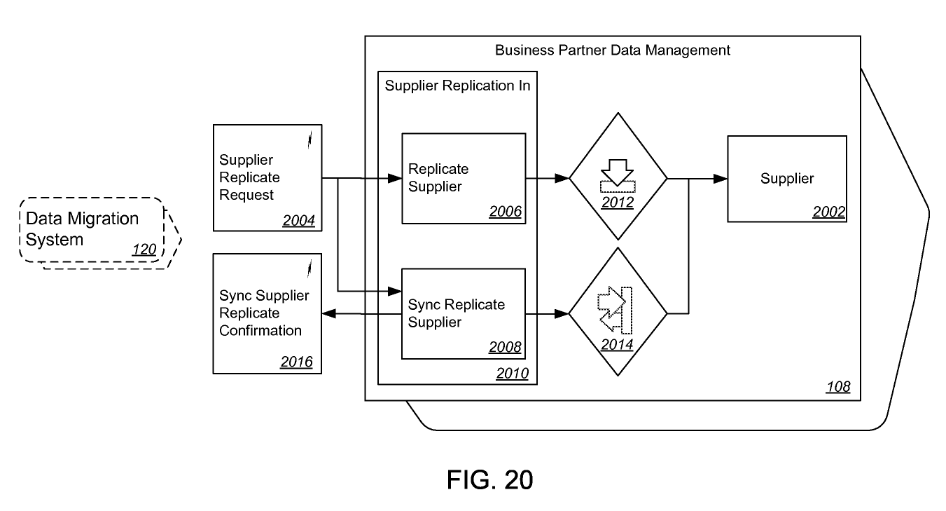

FIG. 20 is a block diagram showing interactions between the Data Migration System process component 120 and the Business Partner Data Management process component 108, related to a supplier, in the architectural design of FIGS. 1A-D. The Data Migration System process component 120 provides data migration to the Business Partner Data Management process component 108. The interaction starts when supplier data is to be the migrated or replicated from a source system or file to a target system.

As shown in FIG. 20, the Business Partner Data Management process component 108 includes a Supplier business object 2002. The Supplier business object 2002 represents a business partner who offers or provides materials or services.

A Replicate Supplier operation 2006 receives a Supplier Replicate Request message 2004. The operation 2006 is included in a Supplier Replication In interface 2008. The operation 2006 creates or updates supplier master data in a target system, using supplier master data from a source system or file. The operation 2006 uses a Replicate Supplier inbound process agent 2012 to migrate or replicate supplier data from a source system or file to a target system and to update the Supplier business object 2002.

A Synchronous Replicate Supplier operation 2008 also receives the Supplier Replicate Request message 2004. The operation 2008 is included in the Supplier Replication In interface 2010. The operation 2008 creates or updates supplier master data in a target system, using supplier master data from a source file. The operation 2008 uses a Synchronous Replicate Supplier synchronous inbound process agent 2014 that migrates or replicates supplier data from a source system or file to a target system and updates the Supplier business object 2002. The operation 2008 sends a Synchronous Supplier Replicate Confirmation message 2016.

### Interactions Between Process Components “Data Migration System” and “Accounting”

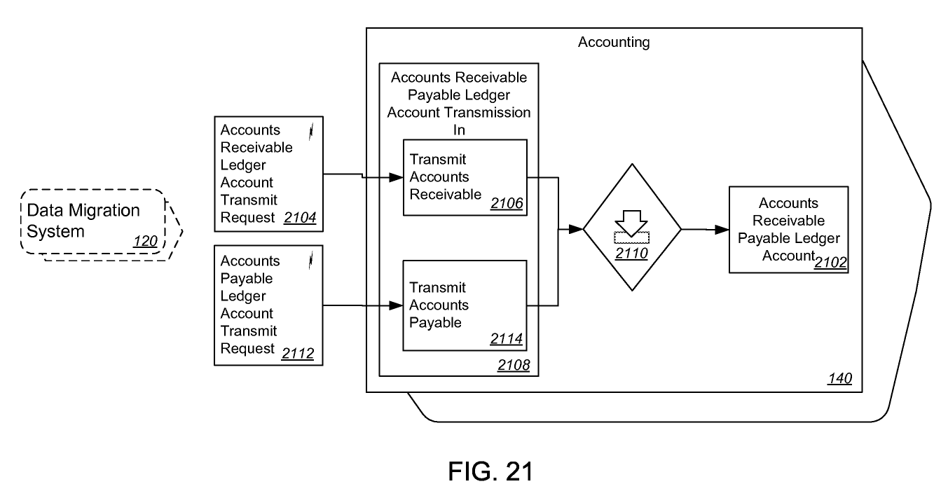

FIG. 21 is a block diagram showing interactions between the Data Migration System process component 120 and the Accounting process component 140 in the architectural design of FIGS. 1A-D. The Data Migration System process component 120 provides data migration to the Accounting process component 140. The interaction starts when accounting data is received for migrating from a source to the Accounting process component 140.

As shown in FIG. 21, the Accounting process component 140 includes an Accounts Receivable Payable Ledger Account business object 2102. The Accounts Receivable Payable Ledger Account business object 2102 represents a record for a company based on the principle of double-entry bookkeeping that reflects the effects of business transactions on the valuated balance of trade payables and receivables. It serves as a structuring element for collecting and evaluating postings in the customer/vendor sub-ledger (e.g., payables/receivables sub-ledger). It contains values concerning the payables or receivables that a company has with a business partner.

A Transmit Accounts Receivable operation 2106 receives an Accounts Receivable Ledger Account Transmit Request message 2104. The operation 2106 is included in an Accounts Receivable Payable Ledger Account Transmission In interface 2108. The operation 2106 creates or updates accounts receivable payable ledger account data in a target system, using accounts receivable payable ledger account data from a source system or file. The operation 2106 converts information about master data parts (root nodes) of the Accounts Receivable Payable Ledger Account business object 2102 which are to be migrated from a legacy system to a new ERP system into master data parts (root nodes) of the Accounts Receivable Payable Ledger Account business object 2102. The operation 2106 uses a Transmit Accounts Receivable Payable Ledger Account inbound process agent 2110 to migrate or replicate supplier data from a source system or file to a target system and to update the Accounts Receivable Payable Ledger Account business object 2102.

A Transmit Accounts Payable operation 2114 receives an Accounts Payable Ledger Account Transmit Request message 2112. The operation 2114 is included in the Accounts Receivable Payable Ledger Account Transmission In interface 2108. The operation 2114 creates or updates accounts receivable payable ledger account data in a target system, using accounts receivable payable ledger account data from a source file. The operation 2114 converts information about master data parts (root nodes) of the Accounts Receivable Payable Ledger Account business object 2102 which are to be migrated from a legacy system to a new ERP system into master data parts (root nodes) of the Accounts Receivable Payable Ledger Account business object 2102. The operation 2114 uses the Transmit Accounts Receivable Payable Ledger Account inbound process agent 2110 to update the Accounts Receivable Payable Ledger Account business object 2102.

### Interactions Between Process Components “Data Migration System” and “Compensation Management”

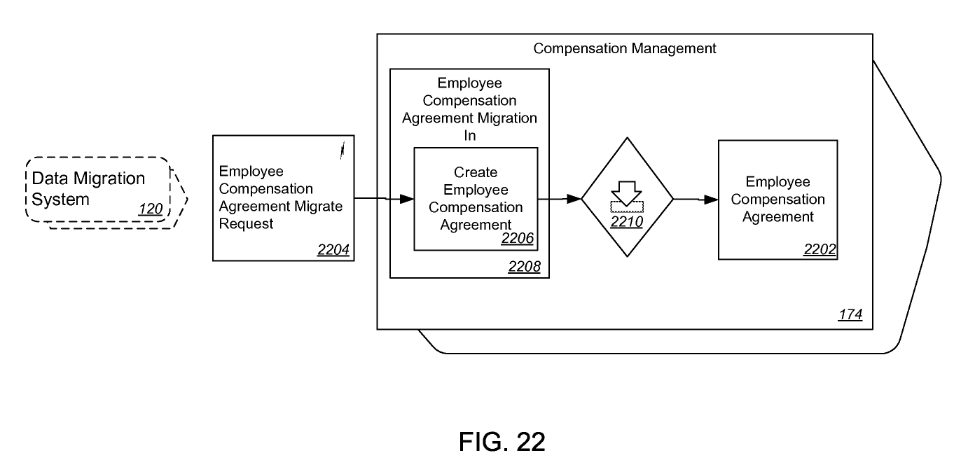

FIG. 22 is a block diagram showing interactions between the Data Migration System process component 120 and the Compensation Management process component 174 in the architectural design of FIGS. 1A-D. The Data Migration System process component 120 provides data migration to the Compensation Management process component 174. The interaction starts when employee compensation data is received for migrating from a source to the Compensation Management process component 174.

As shown in FIG. 22, the Compensation Management process component 174 includes an Employee Compensation Agreement business object 2202. The Employee Compensation Agreement business object 2202 represents an agreement between an employer and an employee detailing all compensation components that are relevant to the employee, such as base salary, one-time and recurring payments, and payments for employee benefits. Moreover, part of this agreement can include the assignment of a compensation structure grade that is valid for the employee.

A Create Employee Compensation operation 2206 receives an Employee Compensation Agreement Migrate Request message 2204 which is a request to migrate an employee compensation agreement from a data migration system to compensation management. The operation 2206 is included in an Employee Compensation Agreement Migration In interface 2208. The operation 2206 creates an employee compensation agreement based on a migrated data. The operation 2206 uses a Create Employee Compensation Agreement based on Migration inbound process agent 2210 to update the Employee Compensation Agreement business object 2202.

### Interactions Between Process Components “Data Migration System” and “Product Data Maintenance”

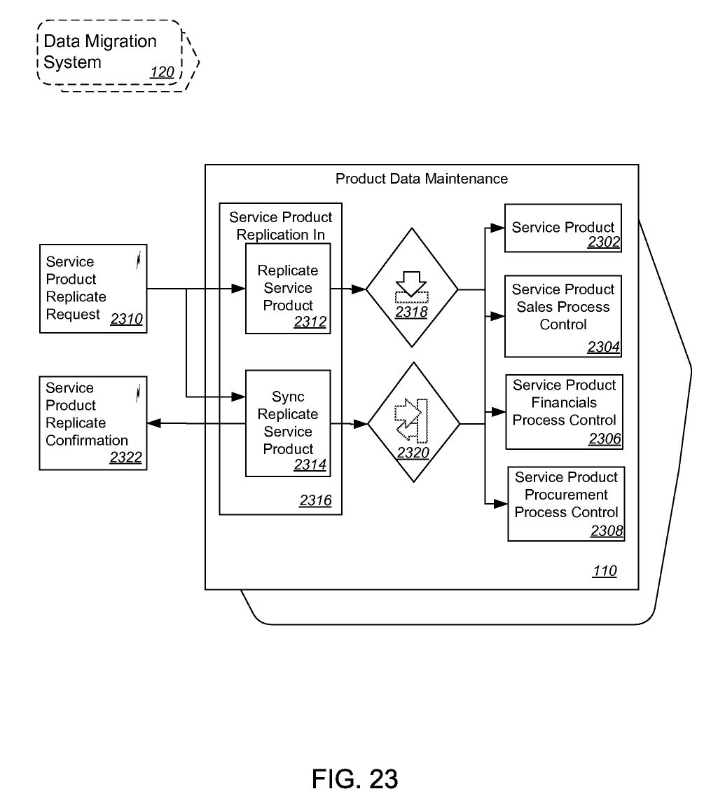

FIG. 23 is a block diagram showing interactions between the Data Migration System process component 120 and the Product Data Maintenance process component 110, related to a service product, a service product sales process control, a service product financials process control, and a service product procurement process control, in the architectural design of FIGS. 1A-D. The Data Migration System process component 120 provides data migration to the Product Data Maintenance process component 110. The interaction starts when a replicate request is received for migration or replication of service product master data from a source system or file to a target system.

As shown in FIG. 23, the Product Data Maintenance process component 110 includes four business objects: a Service Product business object 2302, a Service Product Sales Process Control business object 2304, a Service Product Financials Process Control business object 2306, and a Service Product Procurement Process Control business object 2308.

The Service Product business object 2302 represents an intangible product that describes the provision of a service. A service is provided at the time of its use. The Service Product Sales Process Control business object 2304 represents a process-driven view that contains information about a service that is required to use the service in presales, sales, and customer service processes. The Service Product Financials Process Control business object 2306 represents a process-driven view that contains information about a service that is required to use the service in financial processes. The Service Product Procurement Process Control business object 2308 represents a process-driven view that contains information about a service that is required to use the service in procurement-relevant processes.

A Replicate Service Product operation 2312 receives a Service Product Replicate Request message 2310. The operation 2312 is included in a Service Product Replication In interface 2316. The operation 2312 creates or updates service product master data in a target system, using, service product master data from a source system or file. The operation 2312 uses a Replicate Service Product inbound process agent 2318 that migrates or replicates service product master data from a source system or file to a target system and updates the business objects 2302-2308.

A Synchronous Replicate Service Product operation 2314 also receives the Service Product Replicate Request message 2310. The operation 2314 is included in the Service Product Replication In interface 2316. The operation 2314 creates or updates service product master data in a target system, using service product master data from a source file. The operation 2314 uses a Synchronous Replicate Service Product synchronous inbound process agent 2320 that migrates or replicates service product data from a source system or file to a target system and updates the business objects 2302-2308. The operation 2314 sends a Service Product Replicate Confirmation message 2322.

### Interactions Between Process Components “Data Migration System” and “Production Model Management”

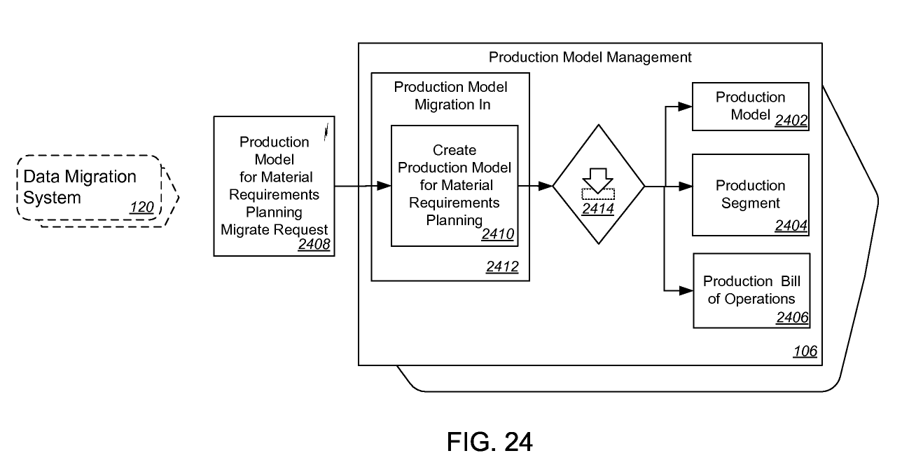

FIG. 24 is a block diagram showing interactions between the Data Migration System process component 120 and the Production Model Management process component 106 in the architectural design of FIGS. 1A-D. The Data Migration System process component 120 provides data migration to the Production Model Management process component 106. The interaction starts when production model data for material requirements planning is received for migrating from a source to the Production Model Management process component 106.

As shown in FIG. 24, the Production Model Management process component 106 includes three business objects: a Production Model business object 2402, a Production Segment business object 2404, and a Production Bill of Operations business object 2406. The Production Model business object 2402 represents model of a production process that is defined by a network of production segments. The Production Segment business object 2404 represents a part of a production process specified by a network of operations and assigned materials for the production of a material. The Production Bill of Operations business object 2406 represents a description of a production process for manufacturing a product. It contains all the processing or transformation steps that have to be executed. It can also define all the resources to be used with all the necessary technical specifications such as the standard times, capacity requirements, and work instructions.

A Create Production Model for Material Requirements Planning operation 2410 receives a Production Model for Material Requirements Planning Migrate Request message 2408. The operation 2410 is included in a Production Model Migration In interface 2412. The operation 2410 creates a production model for material requirements planning with a production segment and production bill of operations. The operation 2410 uses a Create Production Model based on Migration inbound process agent 2414 to update the Production Model business object 2402, the Production Segment business object 2404, and the Production Bill of Operations business object 2406.

### Interactions Between Process Components “Data Migration System” and “Accounting”

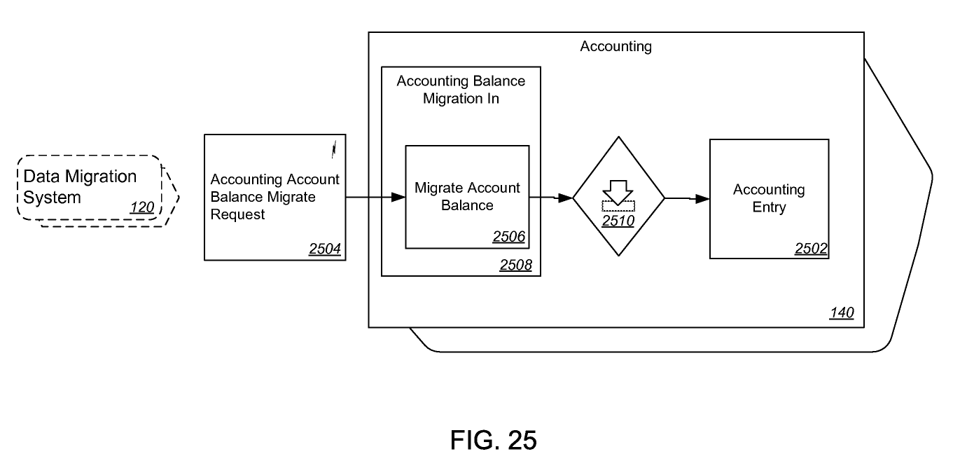

FIG. 25 is a block diagram showing interactions between the Data Migration System process component 120 and the Accounting process component 140, related to an accounting entry, in the architectural design of FIGS. 1A-D. The Data Migration System process component 120 provides data migration to the Accounting process component 140. The interaction starts when accounting data is received for migrating from a source to the Accounting process component 140.

As shown in FIG. 25, the Accounting process component 140 includes an Accounting Entry business object 2502. The Accounting Entry business object 2502 represents a captured business transaction concerning a value change in the asset and equity structure of a company. The entry is made in relation to the accounts of the general ledger and of the sub-ledgers, applying the rules of one or more sets of books.

A Migrate Account Balance operation 2506 receives an Accounting Account Balance Migrate Request message 2504. The operation 2506 is included in an Account Balance Migration In interface 2508. The operation 2506 converts information about balances of a general ledger which are to be migrated from a legacy system to a new ERP system (e.g., into the Accounting Entry business object 2502). The operation 2506 uses a Migrate Account Balance inbound process agent 2510 to update the Accounting Entry business object 2502.

### Interactions Between Process Components “Data Migration System” and “Project Processing”

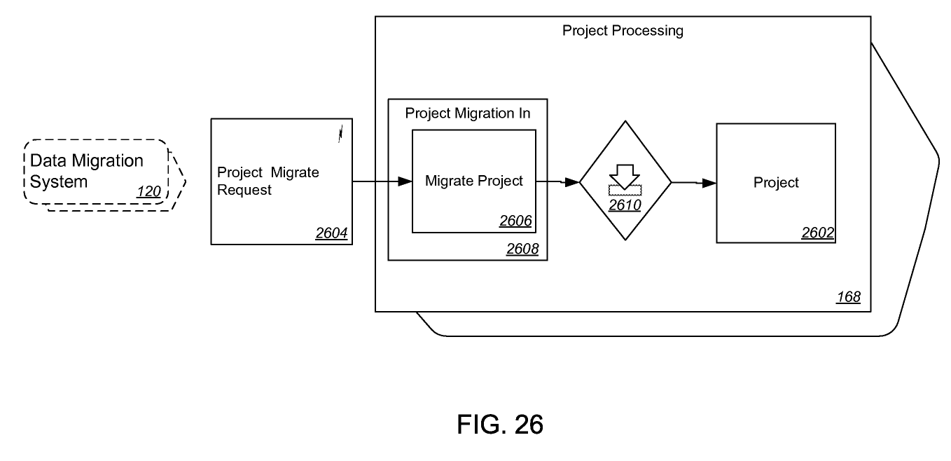

FIG. 26 is a block diagram showing interactions between the Data Migration System process component 120 and the Project Processing process, component 168 in the architectural design of FIGS. 1A-D. The Data Migration System process component 120 provides data migration to the Project Processing process component 168. The interaction starts when project data is received for migrating from a source to the Project Processing process component 168.

As shown in FIG. 26, the Project Processing process component 168 includes a Project business object 2602. The Project business object 2602 represents a business undertaking with a defined goal that is to be attained in a specified time frame. For example, the business undertaking can be achieved using predefined funds and planned resources, while reaching an agreed quality level. The project can be characterized by the fact that it is unique and that it involves an element of risk.

A Migrate Project operation 2606 receives a Project Migrate Request message 2604. The operation 2606 is included in a Project Migration In interface 2608. The operation 2606 creates a new project during the data migration process. The operation 2606 uses a Migrate Project inbound process agent 2610 to update the Project business object 2602.

### Interactions Between Process Components “Data Migration System” and “DK Employer Regulatory Compliance”

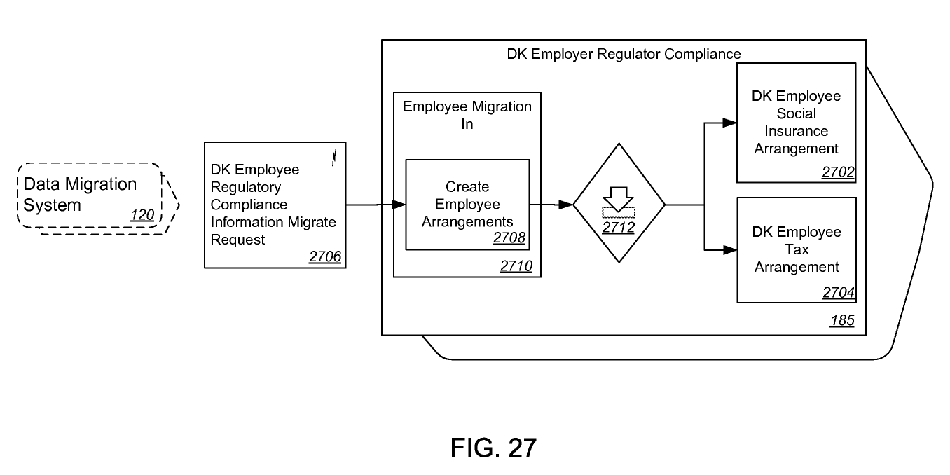

FIG. 27 is a block diagram showing interactions between the Data Migration System process component 120 and the DK Employer Regulatory Compliance process component 185 in the architectural design of FIGS. 1A-D. The Data Migration System process component 120 provides data migration to the DK Employer Regulatory Compliance process component 185. The interaction starts when employee arrangement information is posted.

As shown in FIG. 27, the DK Employer Regulatory Compliance process component 185 includes a DK Employee Tax Arrangement business object 2702 and a DK Employee Social Insurance Arrangement business object 2704. The DK Employee Tax Arrangement business object 2702 represents an arrangement between the employee and the tax authorities of the Denmark that defines the rules of how the employer must calculate and report taxes for this employee to be compliant with the legal requirements of Denmark. The DK Employee Social Insurance Arrangement business object 2704 represents an arrangement for the employee by all responsible Danish bodies that are legally responsible for administering the employees social insurance contributions. This arrangement concerns the information required for calculation of Danish social insurance contributions and reporting according to the Danish legal requirements.

A Create Employee Arrangements operation 2708 receives a DK Employee Regulatory Compliance Information Migrate Request message 2706. The operation 2708 is included in an Employee Migration In interface 2710. The operation 2708 creates business objects for employee arrangements in the DK Employer Regulatory Compliance process component 185. The operation 2708 uses a Create DK Employee Arrangements based on Migration inbound process agent 2712 to update the DK Employee Tax Arrangement business object 2702 and the DK Employee Social Insurance Arrangement business object 2704.

### Interactions Between Process Components “Data Migration System” and “NL Employer Regulatory Compliance”

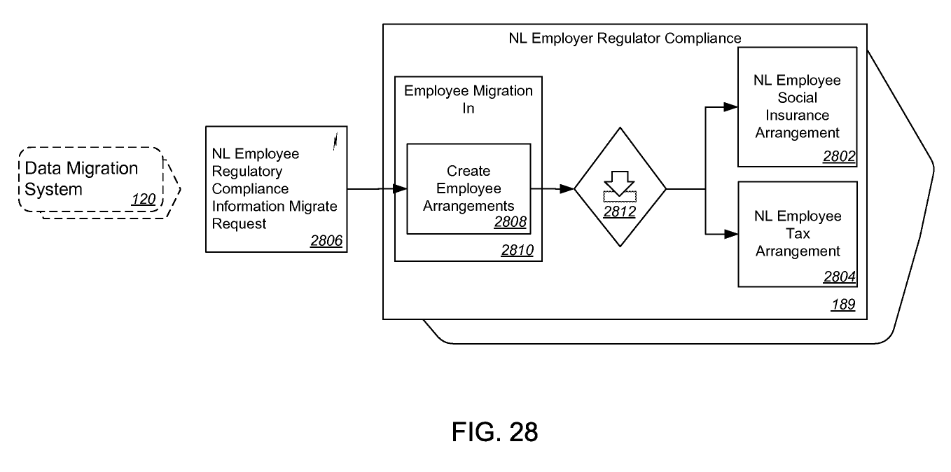

FIG. 28 is a block diagram showing interactions between the Data Migration System process component 120 and the NL Employer Regulatory Compliance process component 189 in the architectural design of FIGS. 1A-D. The Data Migration System process component 120 provides data migration to the NL Employer Regulatory Compliance process component 189. The interaction starts when employee arrangement information is posted.

As shown in FIG. 28, the NL Employer Regulatory Compliance process component 189 includes an NL Employee Tax Arrangement business object 2802 and an NL Employee Social Insurance Arrangement business object 2804. The NL Employee Tax Arrangement business object 2802 represents an arrangement between the employee and the tax authorities of the Netherlands that defines the rules of how the employer must calculate and report taxes for this employee to be compliant with the legal requirements of Netherlands. The NL Employee Social Insurance Arrangement business object 2804 represents an arrangement for the employee by all responsible Dutch bodies that are legally responsible for administering the employee's social insurance contributions. This arrangement concerns the information required for calculation of Dutch social insurance contributions and reporting according to the Netherlands legal requirements.

A Create Employee Arrangements operation 2808 receives an NL Employee Regulatory Compliance Information Migrate Request message 2806. The operation 2808 is included in an Employee Migration In interface 2810. The operation 2808 creates business objects for employee arrangements in the NL Employer Regulatory Compliance process component 189. The operation 2808 uses a Create NL Employee Arrangements based on Migration inbound process agent 2812 to update the NL Employee Tax Arrangement business object 2802 and the NL Employee Social Insurance Arrangement business object 2804.

### Interactions Between Process Components “Data Migration System” and “Business Partner Data Management”

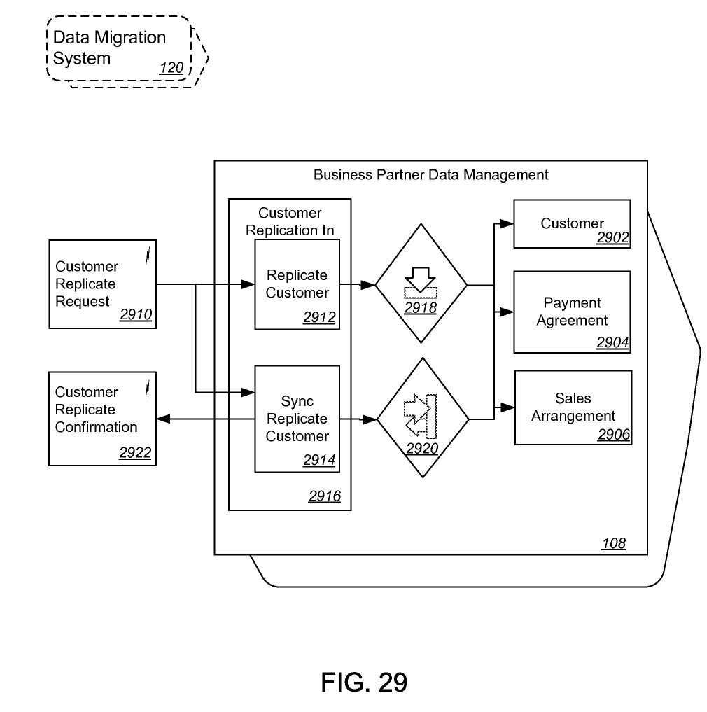

FIG. 29 is a block diagram showing interactions between the Data Migration System process component 120 and the Business Partner Data Management process component 108, related to a customer, a payment agreement, and a sales arrangement, in the architectural design of FIGS. 1A-D. The Data Migration System process component 120 provides data migration to the Business Partner Data Management process component 108. The interaction starts when a replicate request is received for migration or replication of customer data from a source system or file to a target system.

As shown in FIG. 29, the Business Partner Data Management process component 108 includes three business objects: a Customer business object 2902, a Payment Agreement business object 2904, and a Sales Arrangement business object 2906.

The Customer business object 2902 represents a business partner to whom materials or services are offered or provided. The Payment Agreement business object 2904 represents an agreement between a company and a business partner on the handling of payments. It defines, for example, the payment methods allowed and which bank details or credit cards should be used. The Sales Arrangement business object 2906 represents an arrangement between a sales organization and a customer that is used for sales transactions. The arrangement contains, for example, payment terms, invoice currency, and incoterms. The arrangement may not constitute a contract with the customer.

A Replicate Customer operation 2912 receives a Customer Replicate Request message 2910. The operation 2912 is included in a Customer Replication In interface 2916. The operation 2912 creates or updates customer master data in a target system, using customer master data from a source system or file. The operation 2912 uses a Replicate Customer inbound process agent 2918 that migrates or replicates customer master data from a source system or file to a target system and updates the business objects 2902-2906.

A Synchronous Replicate Customer operation 2914 also receives the Customer Replicate Request message 2910. The operation 2914 is included in the Customer Replication In interface 2916. The operation 2914 creates or updates customer master data in a target system, using customer master data from a source file. The operation 2914 uses a Synchronous Replicate Customer synchronous inbound process agent 2920 that migrates or replicates customer data from a source system or file to a target system and updates the business objects 2902-2906. The operation 2914 sends a Customer Replicate Confirmation message 2922.

### Interactions Between Process Components “Data Migration System” and “Price Master Data Management”

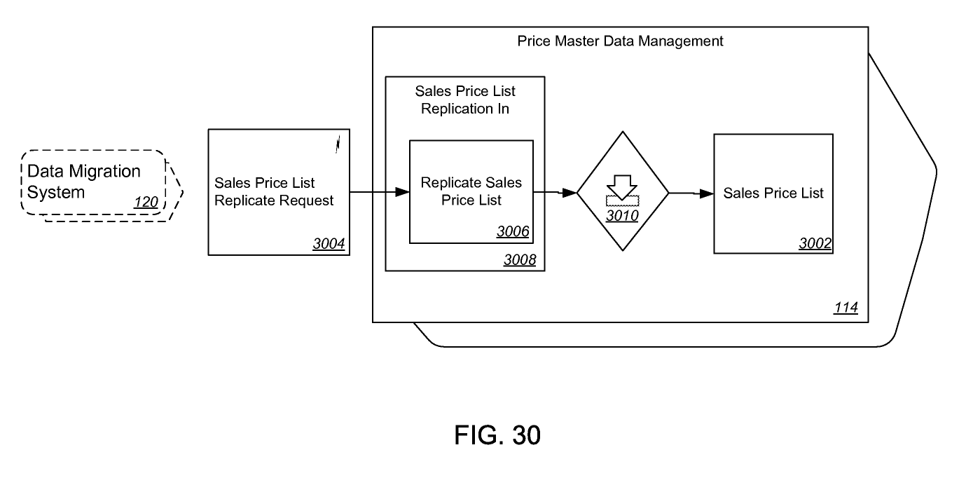

FIG. 30 is a block diagram showing interactions between the Data Migration System process component 120 and the Price Master Data Management process component 114 in the architectural design of FIGS. 1A-D. The Data Migration System process component 110 provides data migration to the Price Master Data Management process component 114. The interaction starts when sales price lists for replication data is requested and received for migrating from a source to the Price Master Data Management process component 114.

As shown in FIG. 30, the Price Master Data Management process component 114 includes a Sales Price List business object 3002. The Sales Price List business object 3002 represents a combination of specifications for prices, discounts, or surcharges in sales and service. The list can be defined for a combination of properties, and can be valid for a specific time period.

A Replicate Sales Price List operation 3006 receives a Sales Price List Replicate Request message 3004. The operation 3006 is included in a Sales Price List Replication In interface 3008. The operation 3006 creates or changes a sales price list based on input from another system, for example during data migration. The operation 3006 uses a Replicate Sales Price List inbound process agent 3010 to update the Sales Price List business object 3002.

### Interactions Between Process Components “Data Migration System” and “Business Partner Data Management”

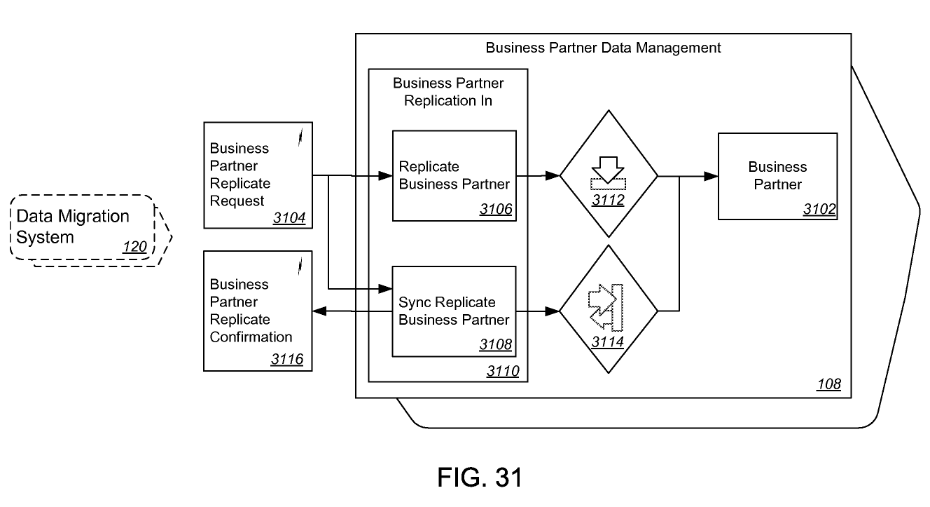

FIG. 31 is a block diagram showing interactions between the Data Migration System process component 120 and the Business Partner Data Management process component 108, related to a business partner, in the architectural design of FIGS. 1A-D. The Data Migration System process component 120 provides data migration to the Business Partner Data Management process component 108. The interaction starts when a replicate request is received for migration or replication of business partner data from a source system or file to a target system.

As shown in FIG. 31, the Business Partner Data Management process component 108 includes a Business Partner business object 3102. The Business Partner business object 3102 represents a person, an organization, or a group of persons or organizations, in which a company has a business interest.

A Replicate Business Partner operation 3106 receives a Business Partner Replicate Request message 3104. The operation 3106 is included in a Business Partner Replication In interface 3110. The operation 3106 creates or updates business partner master data in a target system, using business partner master data from a source file. The operation 3106 uses a Replicate Business Partner inbound process agent 3112 that migrates or replicates business partner data from a source system or file to a target system and updates the Business Partner business object 3102.

A Synchronous Replicate Business Partner operation 3108 also receives the Business Partner Replicate Request message 3104. The operation 3108 is included in the Business Partner Replication In interface 3110. The operation 3108 creates or updates business partner master data in a target system, using business partner master data from a source system or file. The operation 3108 uses a Synchronous Replicate Business Partner synchronous inbound process agent 3114 that migrates or replicates business partner data from a source system or file to a target system and updates the Business Partner business object 3102. The operation 2914 sends a Business Partner Replicate Confirmation message 2922.

### Interactions Between Process Components “Data Migration System” and “Financial Accounting Master Data Management”

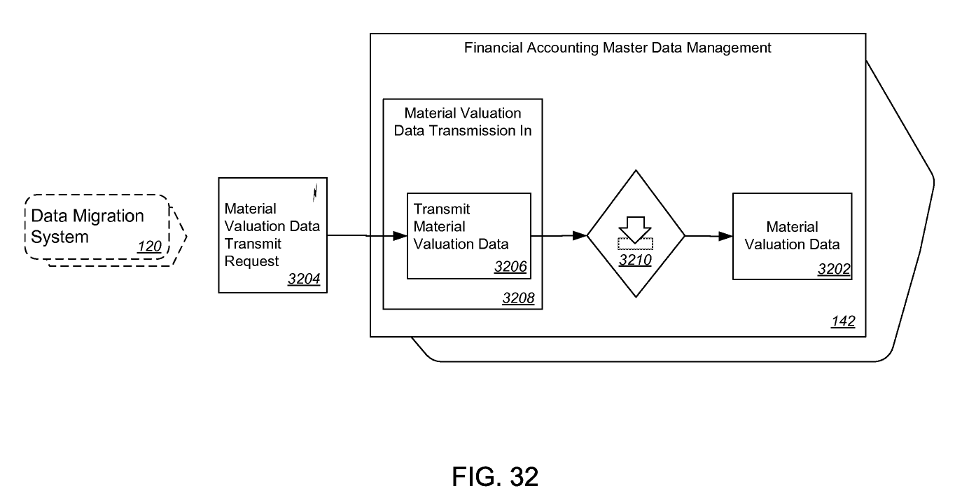

FIG. 32 is a block diagram showing interactions between the Data Migration System process component 120 and the Financial Accounting Master Data Management process component 142 in the architectural design of FIGS. 1A-D. The Data Migration System process component 120 provides data migration to the Financial Accounting Master Data Management process component 142. The interaction starts when material valuation data is received for migrating from a source to the Financial Accounting Master Data Management process component 142.

As shown in. FIG. 32, the Financial Accounting Master Data Management process component 142 includes a Material Valuation Data business object 3202. The Material Valuation Data business object 3202 represents data that references a material or material group for valuating business transactions, for cost estimates, and for value-based management of material inventories. In particular, it can include internal valuation prices for a material or material group.

A Transmit Material Valuation Data operation 3206 receives a Material Valuation Data Transmit Request message 3204. The operation 3206 is included in a Material Valuation Data Transmission In interface 3208. The operation 3206 transmits information about material valuation data from data migration processing into material valuation data and forwards this information to the Financial Accounting Master Data Management process component 142. The operation 3206 uses a Transmit Material Valuation Data inbound process agent 3210 to update the Material Valuation Data business object 3202.

### Interactions Between Process Components “Data Migration System” and “SG Employer Regulatory Compliance”

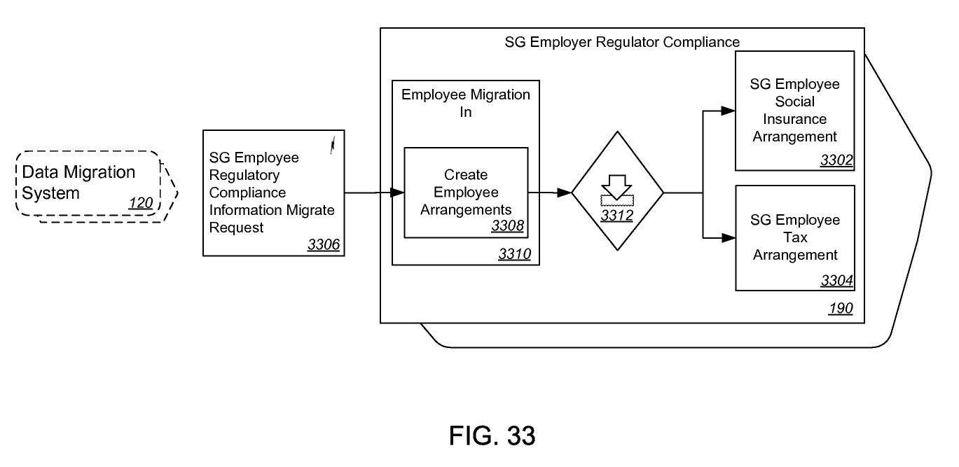

FIG. 33 is a block diagram showing interactions between the Data Migration System process component 120 and the SG Employer Regulatory Compliance process component 190 in the architectural design of FIGS. 1A-D. The Data Migration System process component 120 provides data migration to the SG Employer Regulatory Compliance process component 190. The interaction starts when employee arrangement information is posted.

As shown in FIG. 33, the SG Employer Regulatory Compliance process component 190 includes an SG Employee Tax Arrangement business object 3302 and an SG Employee Social Insurance Arrangement business object 3304. The SG Employee Tax Arrangement business object 3302 represents an arrangement between the employee and the tax authorities of the Singapore that defines the rules of how the employer must calculate and report taxes for this employee to be compliant with the legal requirements of Singapore. The SG Employee Social Insurance Arrangement business object 3304 represents an arrangement for the employee by all responsible Singaporean bodies that are legally responsible for administering the employee's social insurance contributions. This arrangement concerns the information required for calculation of Singaporean social insurance contributions and reporting according to the Singapore legal requirements.

A Create Employee Arrangements operation 3308 receives an SG Employee Regulatory Compliance Information Migrate Request message 3306. The operation 3308 is included in an Employee Migration In interface 3310. The operation 3308 creates business objects for employee arrangements in the SG Employer Regulatory Compliance process component 190. The operation 3308 uses a Create SG Employee Arrangements based on Migration inbound process agent 3312 to update the SG Employee Tax Arrangement business object 3302 and the SG Employee Social Insurance Arrangement business object 3304.

### Interactions Between Process Components “Data Migration System” and “Purchasing Contract Processing”

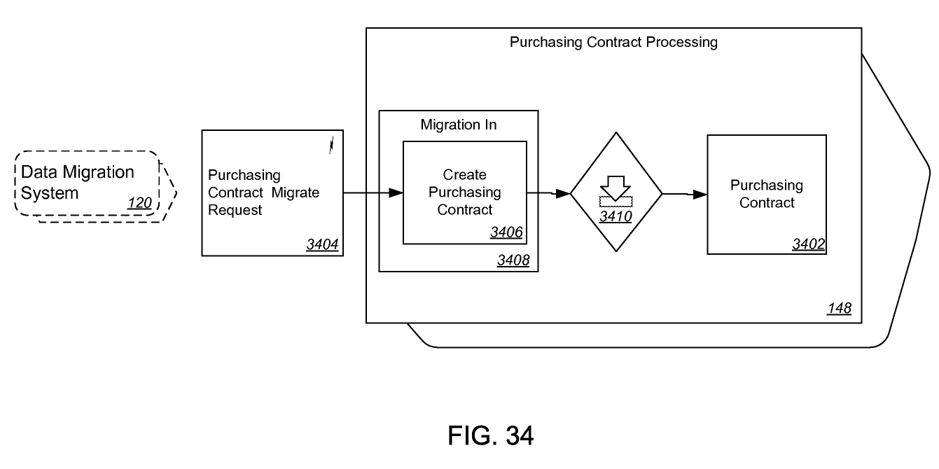

FIG. 34 is a block diagram showing interactions between the Data Migration System process component 120 and the Purchasing Contract Processing process component 148 in the architectural design of FIGS. 1A-D. The Data Migration System process component 120 provides data migration to the Purchasing Contract Processing process component 148. The interaction starts when migration-relevant information is sent from a source system to the Purchasing Contract Processing process component 148.

As shown in FIG. 34, the Purchasing Contract Processing process component 148 includes a Purchasing Contract business object 3402. The Purchasing Contract business object 3402 represents a legally binding purchase agreement that contains special conditions that are negotiated between a buyer and a seller, covering goods to be supplied or services to be performed. The purchase agreement can be valid for a specific period, during which goods and services are released against the contract.

A Create Purchasing Contract operation 3406 receives a Purchasing Contract Migrate Request message 3404. The operation 3406 is included in a Migration In interface 3408. The operation 3406 creates a purchasing contract based on a migrated data. The operation 3406 uses a Create Purchasing Contract based on Migration inbound process agent 3410 to update the Purchasing Contract business object 3402.

### Interactions Between Process Components “Data Migration System” and “FR Employer Regulatory Compliance”

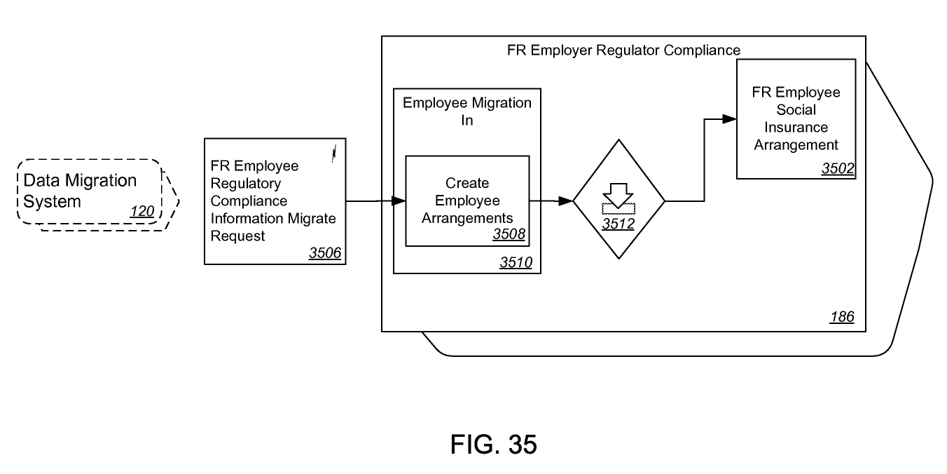

FIG. 35 is a block diagram showing interactions between the Data Migration System process component 120 and the FR Employer Regulatory Compliance process component 186 in the architectural design of FIGS. 1A-D. The Data Migration System process component 120 provides data migration to the FR Employer Regulatory Compliance process component 186. The interaction starts when employee arrangement information is posted.

As shown in FIG. 35, the FR Employer Regulatory Compliance process component 186 includes an FR Employee Social Insurance Arrangement business object 3502. The FR Employee Social Insurance Arrangement business object 3502 represents an arrangement for the employee by all responsible French bodies that are legally responsible for administering the employee's social insurance contributions. This arrangement concerns the information required for calculation of French social insurance contributions and reporting according to the French legal requirements.

A Create Employee Arrangements operation 3508 receives an FR Employee Regulatory Compliance Information Migrate Request message 3506. The operation 3508 is included in an Employee Migration In interface 3510. The operation 3508 creates business objects for employee arrangements in the FR Employer Regulatory Compliance process component 186. The operation 3508 uses a Create FR Employee Arrangements based on Migration inbound process agent 3512 to update the FR Employee Social Insurance Arrangement business object 3502.

### Interactions Between Process Components “Data Migration System” and “Accounting”

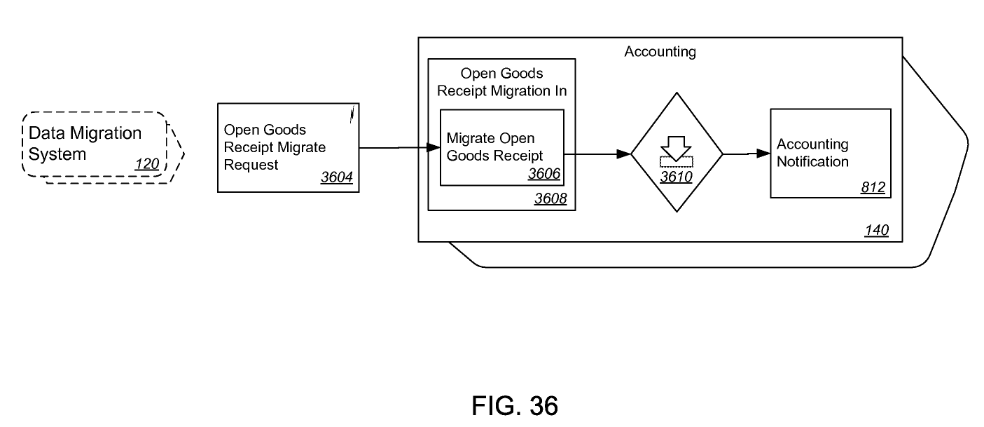

FIG. 36 is a block diagram showing interactions between the Data Migration System process component 120 and the Accounting process component 140, related to an accounting notification, in the architectural design of FIGS. 1A-D. The Data Migration System process component 120 provides data migration to the Accounting process component 140. The interaction starts when accounting data is received for migrating from a source to the Accounting process component 140.

As shown in FIG. 36, the Accounting process component 140 includes the Accounting Notification business object 812. The Accounting Notification business object 812 represents a notification sent to financial accounting by an operational component regarding a business transaction. The Accounting Notification business object 812 can represent the operational business transaction in a standardized form for all business transaction documents and contain the data needed to valuate the business transaction. A Migrate Open Goods Receipt operation 3606 receives an Open Goods Receipt Migrate Request message 3604. The operation 3606 is included in an Open Goods Receipt Migration In interface 3608. The operation 3606 can receive the open goods receipt migrate request from Data Migration System process component 120. The operation 3606 uses a Migrate Accounting Document Based On Open Goods Receipt inbound process agent 3610 to update the Accounting Notification business object 812.

### Interactions Between Process Components “Data Migration System” and “Production Model Management”

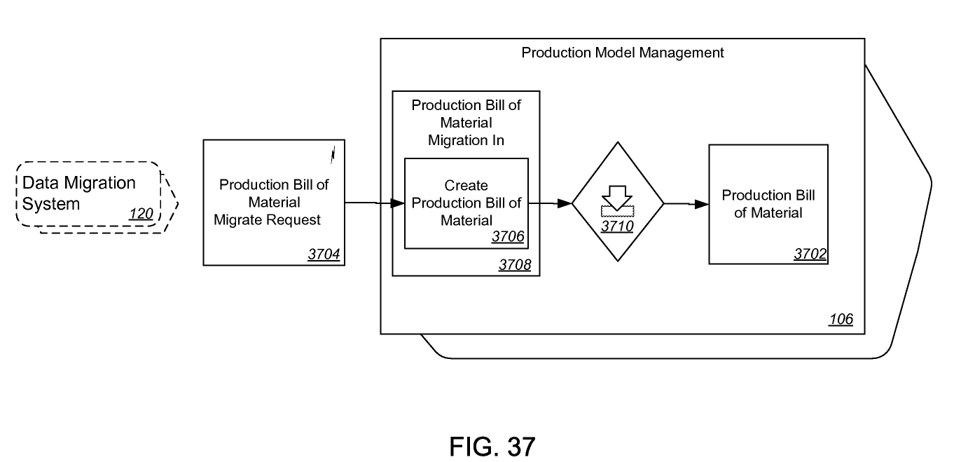

FIG. 37 is a block diagram showing interactions between the Data Migration System process component 120 and the Production Model Management process component 106, related to a production bill of material, in the architectural design of FIGS. 1A-D. The Data Migration System process component 120 provides data migration to the Production Model Management process component 106. The interaction starts when a production bill of material is to be created based on migration data from an external source to the Production Model Management process component 106.

As shown in FIG. 37, the Production Model Management process component 106 includes a Production Bill of Material business object 3702. The Production Bill of Material business object 3702 represents a complete and structured list that defines and describes the components that are required in the production of a material including all its variants.

A Create Production Bill of Material operation 3706 receives a Production Bill of Material Migrate Request message 3704. The operation 3706 is included in a Production Bill of Material Migration In interface 3708. The operation 3706 creates a production model for material requirements planning with a production segment and production bill of operations. The operation 3706 uses a Create Production Bill of Material based on Migration inbound process agent 3710 to update the Production Bill of Material business object 3702.

### Interactions Between Process Components “Data Migration System” and “Engineering Change Processing”

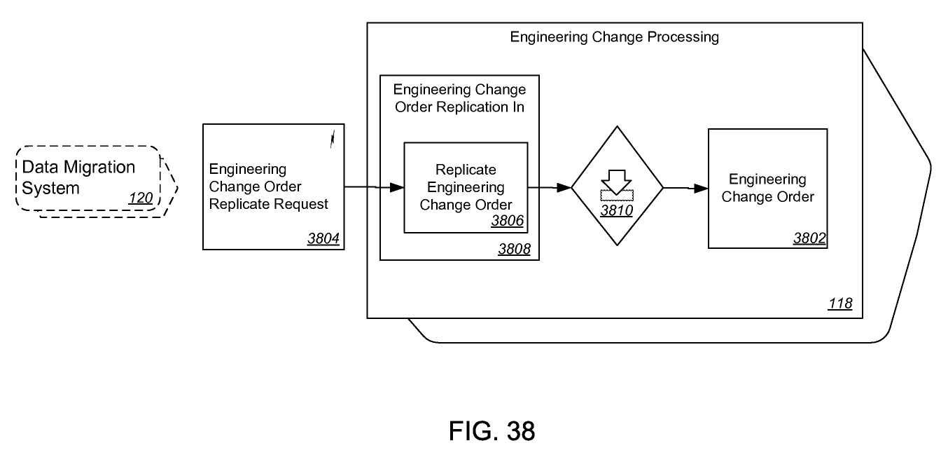

FIG. 38 is a block diagram showing interactions between the Data Migration System process component 120 and the Engineering Change Processing process component 118 in the architectural design of FIGS. 1A-D. The Data Migration System process component 120 provides data migration to the Engineering Change Processing process component 118. The interaction starts when engineering change order data is received for migrating from a source to the Engineering Change Processing process component 118.

As shown in FIG. 38, the Engineering Change Processing process component 118 includes an Engineering Change Order business object 3802. The Engineering Change Order business object 3802 represents a set of instructions to make changes to a number of objects from the areas of engineering or production. The Engineering Change Order business object 3802 defines the conditions under which these changes become effective and specifies the release status of these changes.

A Replicate Engineering Change Order operation 3806 receives an Engineering Change Order Replicate Request message 3804. The operation 3806 is included in an Engineering Change Order Replication In interface 3808. The operation 3806 creates, updates or deletes an engineering change order. The operation 3806 uses a Replicate Engineering Change Order inbound process agent 3810 to update the Engineering Change Order business object 3802.

### Interactions Between Process Components “Data Migration System” and “CA Employer Regulatory Compliance”

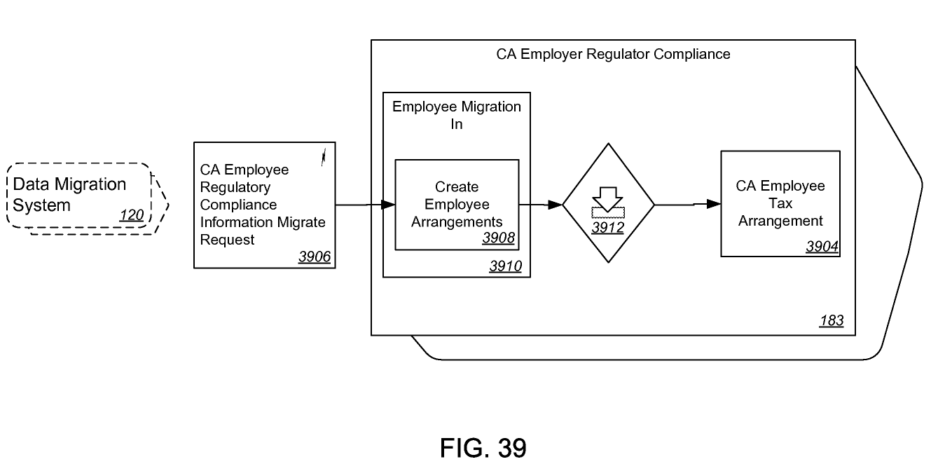

FIG. 39 is a block diagram showing interactions between the Data Migration System process component 120 and the CA Employer Regulatory Compliance process component 183 in the architectural design of FIGS. 1A-D. The Data Migration System process component 120 provides data migration to the CA Employer Regulatory Compliance process component 183. The interaction starts when employee arrangement information is posted.

As shown in FIG. 39, the CA Employer Regulatory Compliance process component 183 includes a CA Employee Tax Arrangement business object 3902. The CA Employee Tax Arrangement business object 3902 represents an arrangement between the employee and the tax authorities of Canada that defines the rules of how the employer must calculate and report taxes for this employee to be compliant with the legal requirements of Canada.

A Create Employee Arrangements operation 3908 receives a CA Employee Regulatory Compliance Information Migrate Request message 3906. The operation 3908 is included in an Employee Migration In interface 3910. The operation 3908 creates business objects for employee arrangements in the CA Employer Regulatory Compliance process component 183. The operation 3908 uses a Create CA Employee Arrangements based on Migration inbound process agent 3912 to update the CA Employee Tax Arrangement business object 3902.

### Interactions Between Process Components “Data Migration System” and “Product Data Maintenance”

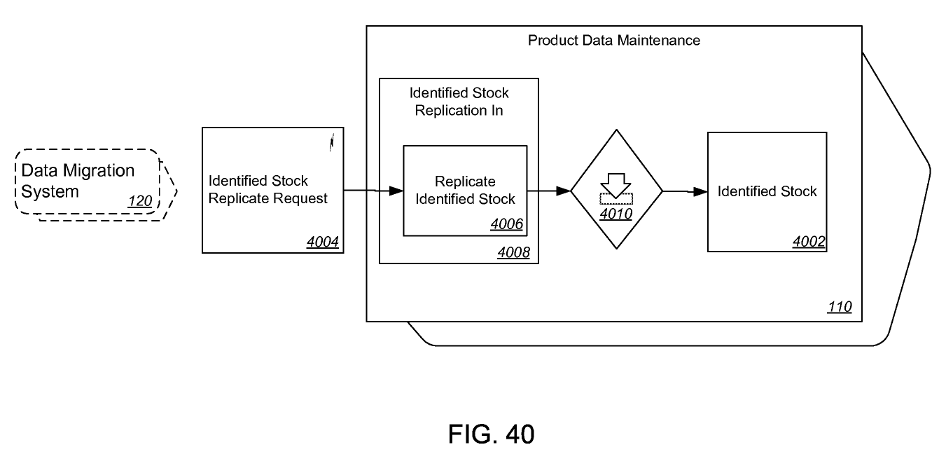

FIG. 40 is a block diagram showing interactions between the Data Migration System process component 120 and the Product Data Maintenance process component 110, related to an identified stock, in the architectural design of FIGS. 1A-D. The Data Migration System process component 120 provides data migration to the Product Data Maintenance process component 110. The interaction starts when a replicate request is received.

As shown in FIG. 40, the Product Data Maintenance process component 110 includes an Identified Stock business object 4002. The Identified Stock business object 4002 represents a subset of a material that shares a set of common characteristics, is logistically handled separately from other subsets of the same material and is uniquely identified.

A Replicate Identified Stock operation 4006 receives an Identified Stock Replicate Request message 4004. The operation 4006 is included in an Identified Stock Replication In interface 4008. The operation 4006 creates, updates or deletes the Identified Stock business object 4002 based on a migrated data. The operation 4006 uses a Replicate Identified Stock inbound process agent 4010 to update the Identified Stock business object 4002.

### Interactions Between Process Components “Data Migration System” and “Personnel Administration”

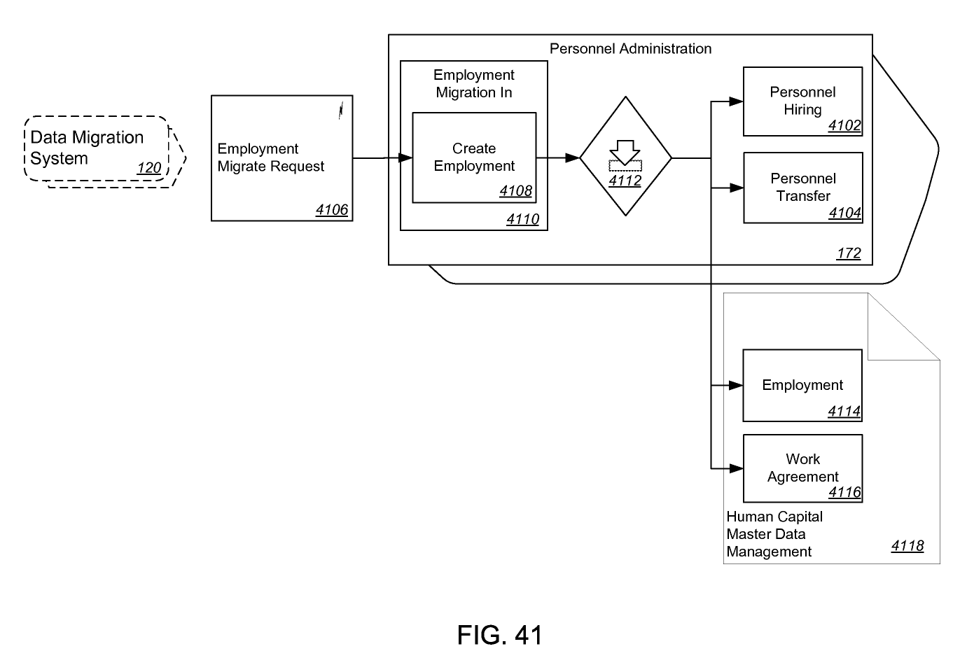

FIG. 41 is a block diagram showing interactions between the Data Migration System process component 120 and the Personnel Administration process component 172 in the architectural design of FIGS. 1A-D. The Data Migration System process component 120 provides data migration to the Personnel Administration process component 172. The interaction starts when legacy personnel data is received for migrating from a source to the Personnel Administration process component 172.

As shown in FIG. 41, the Personnel Administration process component 172 includes a Personnel Hiring business object 4102 and a Personnel Transfer business object 4104. The Personnel Hiring business object 4102 represents a hiring, rehiring, or creation of another work agreement of an employee. The Personnel Transfer business object 4104 represents an organizational reassignment of an employee within the company.

A Create Employment operation 4108 receives an Employment Migrate Request message 4106. The operation 4108 is included in an Employment Migration In interface 4110. The operation 4108 converts employment information which is to be migrated from a legacy system into Employment. The operation 4108 uses a Create Employment based on Migration inbound process agent 4112 to update the Personnel Hiring business object 4102, the Personnel Transfer business object 4104, an Employment business object 4114, and a Work Agreement business object 4116. The Employment business object 4114 represents a relationship that comes into being by virtue of one or more valid work agreements. Whereas the work agreement consists only of the specific labor-related arrangements agreed between company and employee, the employment encompasses the entire legal relationship between the contracting parties. The Work Agreement business object 4116 represents a contract between employer and employee that obligates the employee to provide his or her labor and the employer to provide the agreed compensation. The objects 4114, 4116 are included in a Human Capital Master Data Management communication channel template 4118.

### Interactions Between Process Components “Data Migration System” and “Installed Base Data Management”

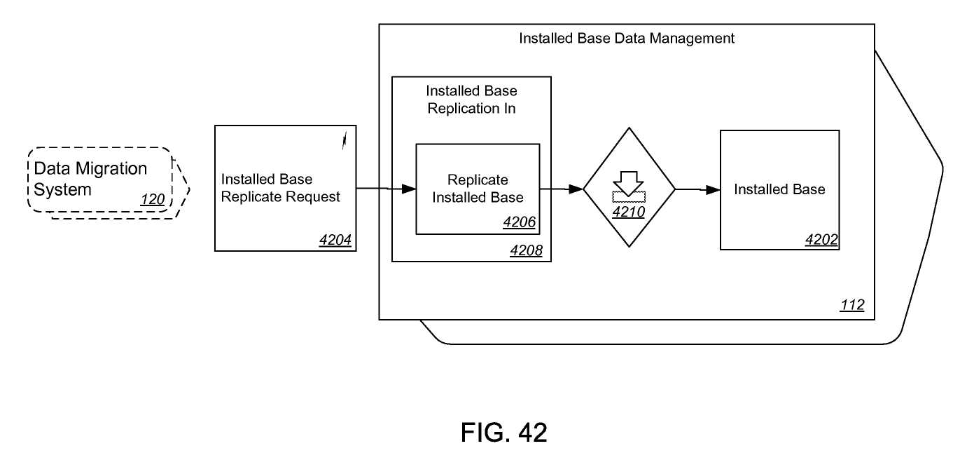

FIG. 42 is a block diagram showing interactions between the Data Migration System process component 120 and the Installed Base Data Management process component 112, related to an installed base, in the architectural design of FIGS. 1A-D. The Data Migration System process component 120 provides data migration to the Installed Base Data Management process component 112. The interaction starts when installed base data from a source system or file to a target system data is received for migrating from the source to the Installed Base Data Management process component 112.

As shown in FIG. 42, the Installed Base Data Management process component 112 includes an Installed Base business object 4202. The Installed Base business object 4202 represents a container that holds structured information of business components and their compositions as well as their business features. Installed base components carry properties of business objects (e.g. Material or Individual Material), which have been assigned to an installed base. They can be multi-level structured, can be time dependent, and can contain descriptive information about their corresponding business component. Content of an installed base component can include, for example, address and/or application specific extensions.

A Replicate Installed Base operation 4206 receives an Installed Base Replicate Request message 4204. The operation 4206 is included in an Installed Base Replication In interlace 4208. The operation 4206 creates, updates, or deletes installed base master data in a target system, using installed base master data from a source system or file. The operation 4206 uses a Replicate Installed Base inbound process agent 4210 to update the Installed Base business object 4202.

### Interactions Between Process Components “Data Migration System” and “Customer Problem and Solution Administration”

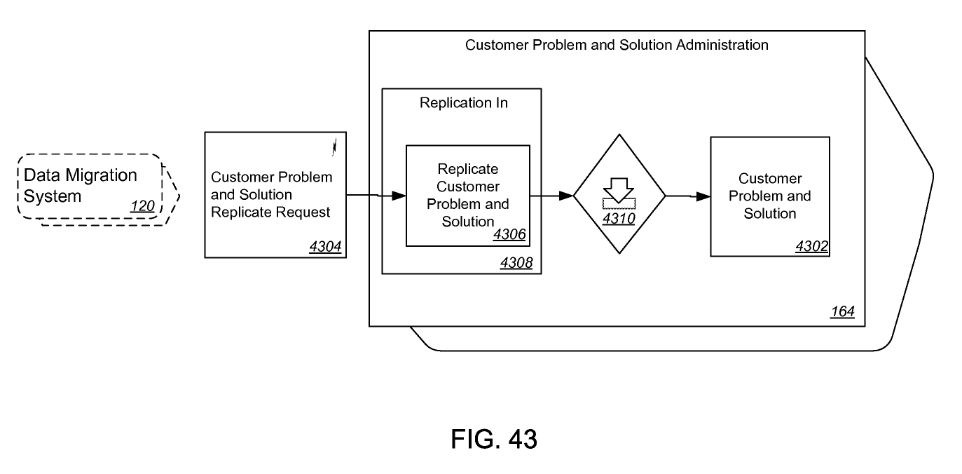

FIG. 43 is a block diagram showing interactions between the Data Migration System process component 120 and the Customer Problem and Solution Administration process component 164 in the architectural design of FIGS. 1A-D. The Data Migration System process component 120 provides data migration to the Customer Problem and Solution Administration process component 164. The interaction starts when customer problem and solution data is received for migrating from a source to the Customer Problem and Solution Administration process component 164.

As shown in FIG. 43, the Customer Problem and Solution Administration process component 164 includes the Customer Problem and Solution business object 4302. The Customer Problem and Solution business object 4302 represents a collection consisting of one or several problems reported by a customer, and one or several solutions provided by one or more experts.

A Replicate Customer Problem and Solution operation 4306 receives a Customer Problem and Solution Replicate Request message 4304. The operation 4306 is included in a Replication In interface 4308. The operation 4306 processes a customer problem and solution based on data from another system. The operation 4306 uses a Replicate Customer Problem and Solution inbound process agent 4310 to update the Customer Problem and Solution business object 4302.

### Interactions Between Process Components “Data Migration System” and “Accounting”

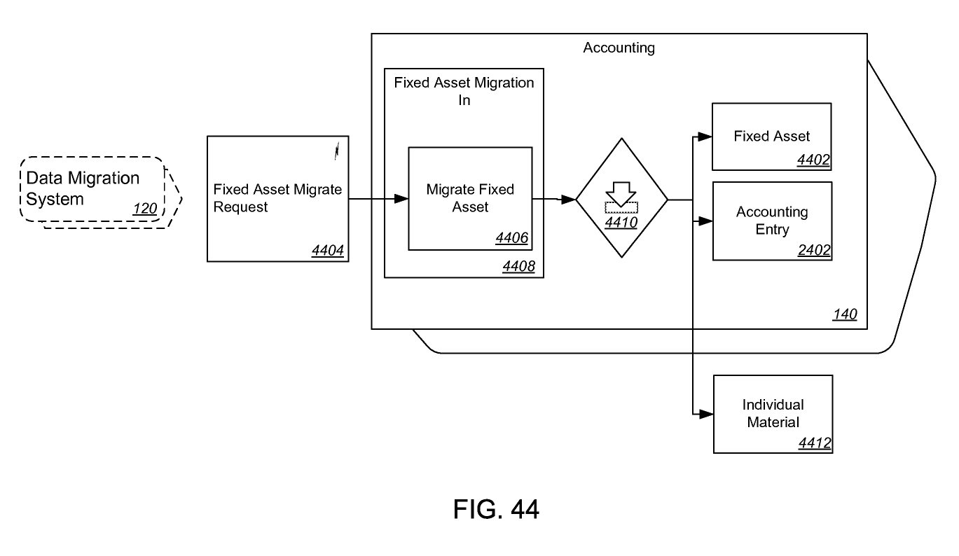

FIG. 44 is a block diagram showing interactions between the Data Migration System process component 120 and the Accounting process component 140, related to a fixed asset and an accounting entry, in the architectural design of FIGS. 1A-D. The Data Migration System process component 120 provides data migration to the Accounting process component 140. The interaction starts when legacy personnel data is received for migrating from a source to the Accounting process component 140.

As shown in FIG. 44, the Accounting process component 140 includes a Fixed Asset business object 4402 and the Accounting Entry business object 2502.

The Fixed Asset business object 4402 represents a view, defined for the purposes of financial accounting, of usually one or more physical objects, rights or other economic values belonging to a company. They are in long-term use, are recognized in the financial statements at closing, and must be individually identifiable. It also includes the recording of the values (based on the principle of double-entry bookkeeping) that reflects the effects of business transactions on this view. The Fixed Asset business object 4402 serves as a structuring element for collecting and evaluating postings in the asset sub-ledger. A fixed asset encompasses the given view definition and the values for this view resulting from acquisitions, retirements, depreciation, revaluation and interest. It also contains the calculation parameters to determine depreciation, revaluation, and interest. In addition to individual account movements related to business transactions, it contains period-based totals and balances that summarize the movements.

The Accounting Entry business object 2502 represents a captured business transaction concerning a value change in-the asset and equity structure of a company. The entry is made in relation to the accounts of the general ledger and of the sub-ledgers, applying the rules of one or more sets of books.

A Migrate Fixed Asset operation 4406 receives a Fixed Asset Migrate Request message 4404. The message 4404 is used to convert the information on the master data of an asset, its opening balance at the beginning of the migration year, and the transactions and depreciations posted in the migration year. The operation 4406 is included in a Fixed Asset Migration In interface 4408. The operation 4406 converts employment information which is to be migrated from a legacy system into Employment. The operation 4406 uses a Migrate Fixed Asset inbound process agent 4410 to update the Fixed Asset business object 4402 the Accounting Entry business object 2502, and an Individual Material business object 4412. The agent 4410 can perform all required steps related to fixed asset data migration. This includes master data creation, individual material assignment, and creation of postings (e.g., opening balance, current year transactions, and depreciation postings). The Individual Material business object 4412 represents a tangible product that occurs only once in the real world and is therefore uniquely identifiable.

### Interactions Between Process Components “Data Migration System” and “ZA Employer Regulatory Compliance”

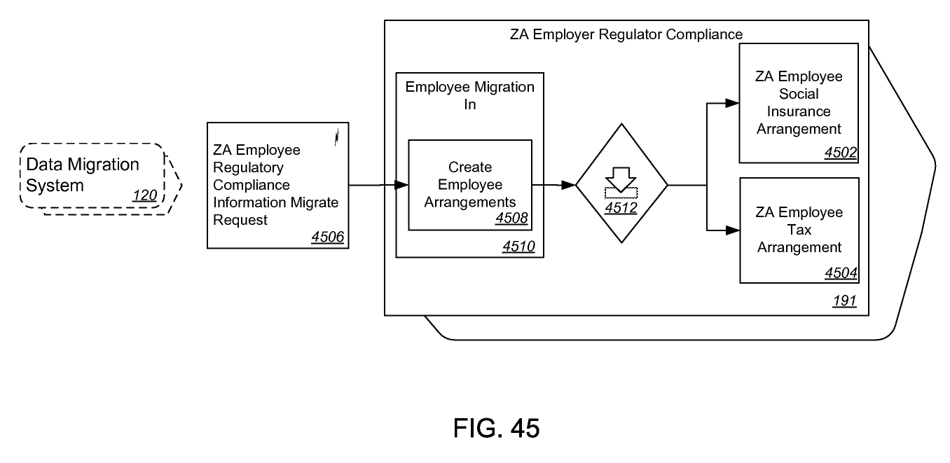

FIG. 45 is a block diagram showing interactions between the Data Migration System process component 120 and the ZA Employer Regulatory Compliance process component 191 in the architectural design of FIGS. 1A-D. The Data Migration System process component 120 provides data migration to the ZA Employer Regulatory Compliance process component 191. The interaction starts when employee arrangement information is posted.

As shown in FIG. 45, the ZA Employer Regulatory Compliance process component 191 includes a ZA Employee Tax Arrangement business object 4502 and a ZA Employee Social Insurance Arrangement business object 4504. The ZA Employee Tax Arrangement business object 4502 represents an arrangement between the employee and the tax authorities of South Africa that defines the rules of how the employer must calculate and report taxes for this employee to be compliant with the legal requirements of South Africa. The ZA Employee Social Insurance Arrangement business object 4504 represents an arrangement for the employee by all responsible South African bodies that are legally responsible for administering the employee's social insurance contributions. This arrangement concerns the information required for calculation of South African social insurance contributions and reporting according to the South African legal requirements.

A Create Employee Arrangements operation 4508 receives a ZA Employee Regulatory Compliance Information Migrate Request message 4506. The operation 4508 is included in an Employee Migration In interface 4510. The operation 4508 creates business objects for employee arrangements in the ZA Employer Regulatory Compliance process component 191. The operation 4508 uses a Create ZA Employee Arrangements based on Migration inbound process agent 4512 to update the ZA Employee Tax Arrangement business object 4502 and the ZA Employee Social Insurance Arrangement business object 4504.

### Interactions Between Process Components “Data Migration System” and “AU Employer Regulatory Compliance”

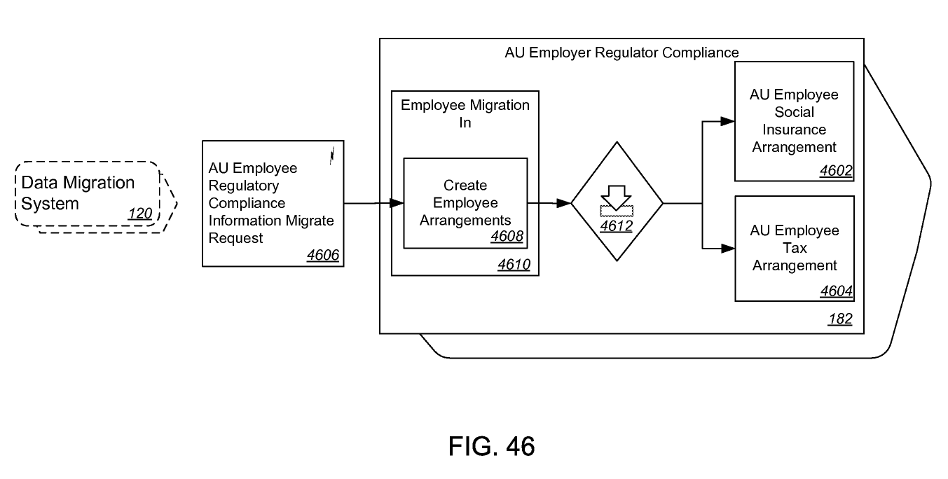

FIG. 46 is a block diagram showing interactions between the Data Migration System process component 120 and the AU Employer Regulatory Compliance process component 182 in the architectural design of FIGS. 1A-D. The Data Migration System process component 120 provides data migration to the AU Employer Regulatory Compliance process component 182. The interaction starts when employee arrangement information is posted.

As shown in FIG. 46, the AU Employer Regulatory Compliance process component 182 includes an AU Employee Tax Arrangement business object 4602 and an AU Employee Social Insurance Arrangement business object 4604. The AU Employee Tax Arrangement business object 4602 represents an arrangement between the employee and the tax authorities of Australia that defines the rules of how the employer must calculate and report taxes for this employee to be compliant with the legal requirements of Australia. The AU Employee Social Insurance Arrangement business object 4604 represents an arrangement for the employee by all responsible Australian bodies that are legally responsible for administering the employee's social insurance contributions. This arrangement concerns the information required for calculation of Australia pension insurance contributions and reporting according to the Australian legal requirements.

A Create Employee Arrangements operation 4608 receives an AU Employee Regulatory Compliance Information Migrate Request message 4606. The operation 4608 is included in an Employee Migration In interface 4610. The operation 4608 creates business objects for employee arrangements in the AU Employer Regulatory Compliance process component 182. The operation 4608 uses a Create AU Employee Arrangements based on Migration inbound process agent 4612 to update the AU Employee Tax Arrangement business object 4602 and the AU Employee Social Insurance Arrangement business object 4604.

### Interactions Between Process Components “Purchase Order Processing” and “Supplier Invoice Processing”

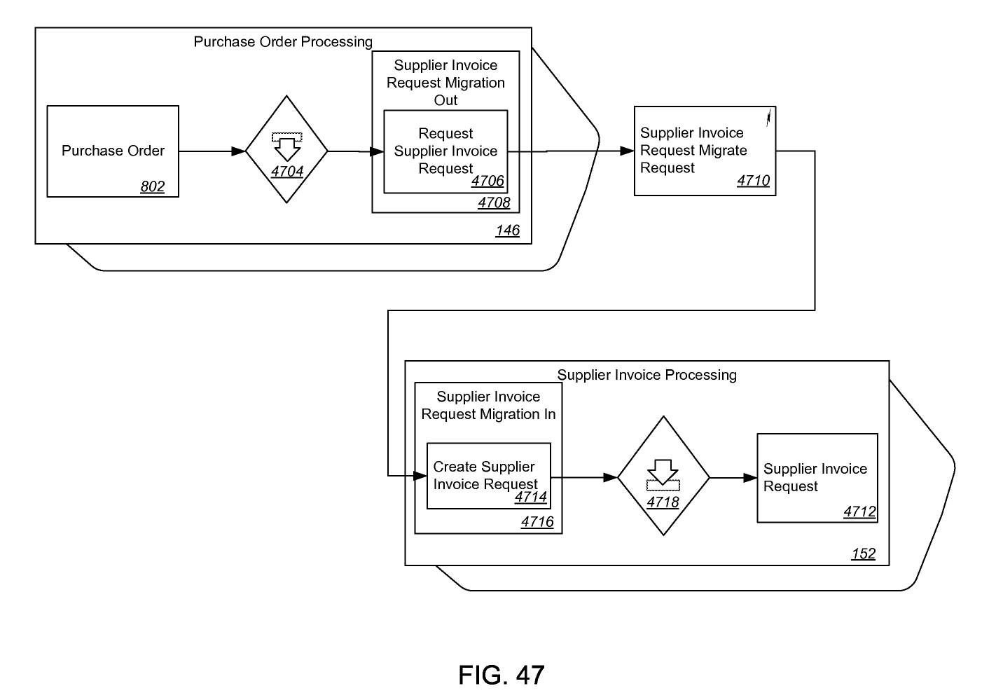

FIG. 47 is a block diagram showing interactions between the Purchase Order Processing process component 146 and the Supplier Invoice Processing process component 152 in the architectural design of FIGS. 1A-D. The interaction starts when supplier invoice data, purchase order data and/or purchase order delivery actual values are to be migrated. The Purchase Order Processing process component 146 notifies the Supplier Invoice Processing process component 152 about the invoicing-relevant data contained in the purchase order. The invoicing-relevant data includes details of the migrated purchase orders, as well as of the goods receipts and supplier invoices that existed in the source system.

As shown in FIG. 47, the Purchase Order Processing process component 146 includes the Purchase Order business object 802. The Purchase Order business object 802 represents a request from a buyer to a seller to deliver a specified quantity of material, or to perform a specified service, at a specified price within a specified time.

The Purchase Order business object 802 uses a Request Supplier Invoice Request Migration from Purchase Order to Supplier Invoice Processing outbound process agent 4704 to invoke a Request Supplier Invoice Request Migration operation 4706. The operation 4706 requests supplier invoice request migration based on the migrated purchase order data and/or purchase order delivery actual values. The operation 4706 is included in a Supplier invoice Request Migration Out interface 4708. The operation 4706 generates a Supplier Invoice Request Migrate Request message 4710.

A Create Supplier Invoice Request operation 4714 receives the Supplier Invoice Request Migrate Request message 4710. The operation 4714 creates a supplier invoice request based on a migrated purchase order and/or based on migrated actual values of the migrated purchase order. The operation 4714 is included in a Supplier Invoice Request Migration In interface 4716. The operation 4714 invokes a Create Supplier Invoice Request based on Migration inbound process agent 4718 to update invoice data into a Supplier Invoice Request business object 4712. The Supplier Invoice Request business object 4712 represents a request that is sent to invoice verification, advising that a supplier invoice for specified quantities and prices is expected, or is to be created through evaluation settlement.

### Interactions Between Process Components “Data Migration System” and “Product Data Maintenance”

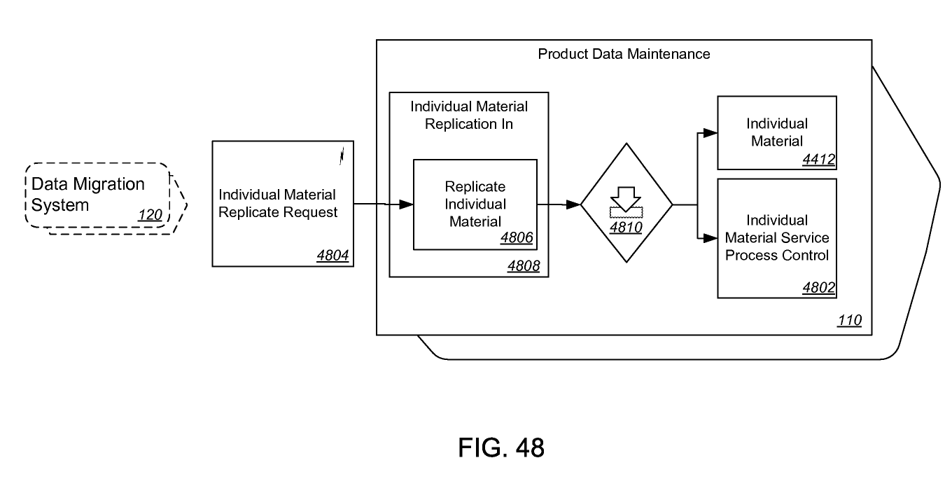

FIG. 48 is a block diagram showing interactions between the Data Migration System process component 120 and the Product Data Maintenance process component 110, related to an individual material and an individual material service process control, in the architectural design of FIGS. 1A-D. The Data Migration System process component 120 provides data migration to the Product Data Maintenance process component 110. The interaction starts when migration or replication is requested for individual material master data from a source system or file to a target system.

As shown in FIG. 48, the Product Data Maintenance process component 110 includes the Individual Material business object 4412 and an Individual Material Service Process Control business object 4802.

The Individual Material business object 4412 represents a tangible product that occurs only once in the real world and is therefore uniquely identifiable. The Individual Material Service Process Control business object 4802 represents a process-driven view that contains information about an individual material that is required to use the individual material in customer service processes.

A Replicate Individual Material operation 4806 receives an Individual Material Replicate Request message 4804. The operation 4806 is included in an Individual Material Replication In interface 4808. The operation 4806 creates or updates individual material master data in a target system, using individual material master data from a source system or file. The operation 4806 uses a Replicate Individual Material inbound process agent 4810 that migrates or replicates individual material master data from a source system or file to a target system and updates the Individual Material business object 4412 and the Individual Material Service Process Control business object 4802.

### Interactions Between Process Components “Data Migration System” and “Price Master Data Management”

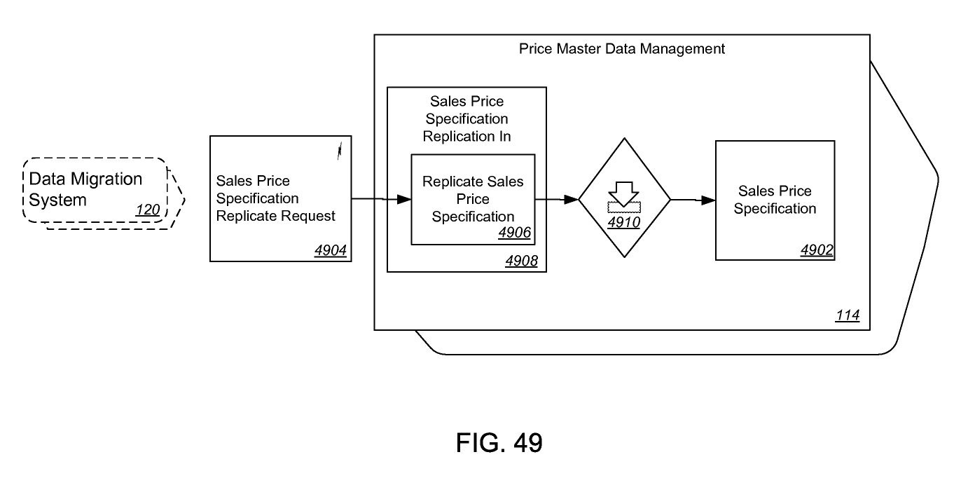

FIG. 49 is a block diagram showing interactions between the Data Migration System process component 120 and the Price Master Data Management process component 114, related to a sales price specification, in the architectural design of FIGS. 1A-D. The Data Migration System process component 120 provides data migration to the Price Master Data Management process component 114. The interaction starts when sales price specification data is received for replication to the Price Master Data Management process component 114.

As shown in FIG. 49, the Price Master Data Management process component 114 includes a Sales Price Specification business object 4902. The Sales Price Specification business object 4902 represents a specification of a price, a discount, or a surcharge for sales and service. The specification can be defined for a combination of properties and can be valid for a specific period.

A Replicate Sales Price Specification operation 4906 receives a Sales Price Specification Replicate Request message 4904. The operation 4906 is included in a Sales Price Specification Replication In interface 4908. The operation 4906 creates or changes a sales price specification based on input from another system. The operation 4906 uses a Replicate Sales Price Specification inbound process agent 4910 to update the Sales Price Specification business object 4902.

### Interactions Between Process Components “Data Migration System” and “Product Data Maintenance”

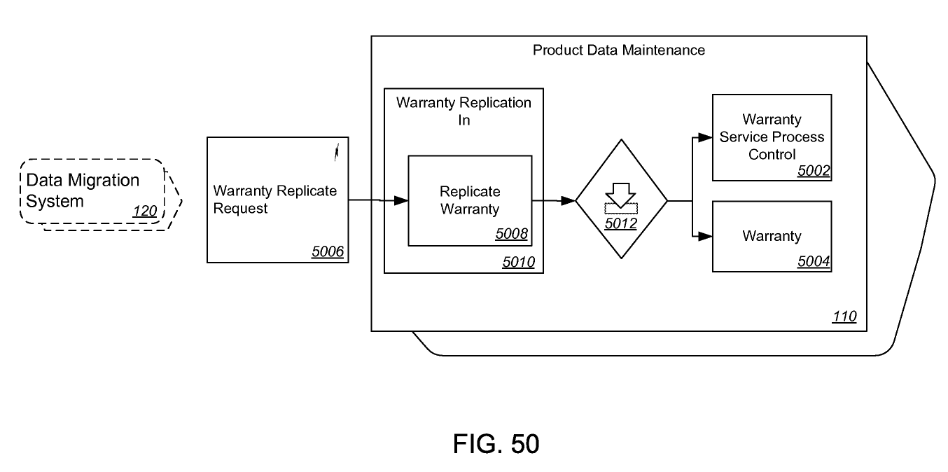

FIG. 50 is a block diagram showing interactions between the Data Migration System process component 120 and the Product Data Maintenance process component 110, related to a warranty service process control business and a warranty, in the architectural design of FIGS. 1A-D. The Data Migration System process component 120 provides data migration to the Product Data Maintenance process component 110. The interaction starts when migration or replication is requested for warranty master data from a source system or file to a target system.

As shown in FIG. 50, the Product Data Maintenance process component 110 includes a Warranty Service Process Control business object 5002 and a Warranty business object 5004. The Warranty Service Process Control business object 5002 represents a process-driven view that contains information about a warranty that is required to use the warranty in customer service processes. The Warranty business object 5004 represents a guarantee to vouch For defects or faults in the product purchased that is valid for a specific period of time. The type and scope of the services covered, such as repairing a defect for free or taking the product back, can be defined in the warranty.

A Replicate Warranty operation 5008 receives a Warranty Replicate Request message 5006. The operation 5008 is included in a Warranty Replication In interface 5010. The operation 5008 creates or updates warranty master data in a target system, using warranty master data from a source system or file. The operation 5008 uses a Replicate Warranty inbound process agent 5012 that migrates or replicates warranty master data from a source system or file to a target system and updates the Warranty Service Process Control business object 5002 and the Warranty business object 5004.

### Interactions Between Process Components “Purchase Order Processing” and “External Procurement Trigger and Response”

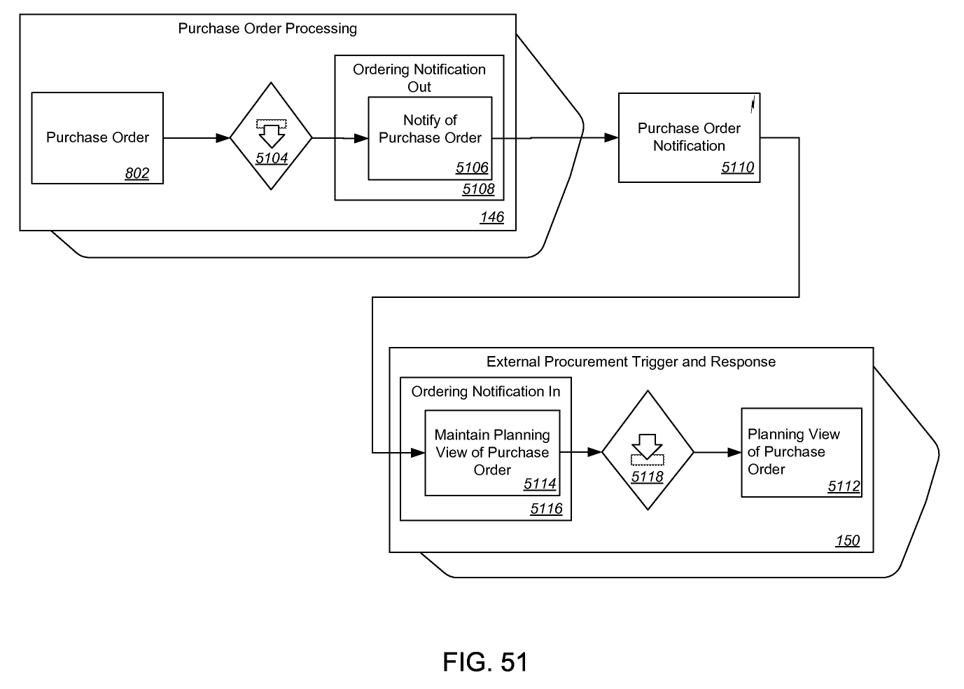

FIG. 51 is a block diagram showing interactions between the Purchase Order Processing process component 146 and the External Procurement Trigger and Response process component 150 in the architectural design of FIGS. 1A-D. The interaction starts when a purchase order is created or updated. The Purchase Order Processing process component 146 requests the creation or update of sub-ledger account (based on purchasing) from the External Procurement Trigger and Response process component 150.

As shown in FIG. 51, the Purchase Order Processing component 146 includes the Purchase Order business object 802. The Purchase Order business object 802 represents a request from a buyer to a seller to deliver a specified quantity of material, or perform a specified service, at a specified price within a specified time.

The Purchase Order business object 802 uses a Notify of Purchase Order to External Procurement Trigger and Response outbound process agent 5104 to invoke a Notify of Purchase Order operation 5106. The agent 5104 informs the External Procurement Trigger and Response process component 150 about a created, changed, or cancelled purchase order. The operation 5106 is included in an Ordering Notification Out interface 5108. The operation 5106 generates a Purchase Order Notification message 5110.

A Maintain Planning View of Purchase Order operation 5114 receives the Purchase Order Notification message 5110. The operation 5114 receives order accounting notification from the Purchase Order Processing process component 146. The notification can inform the External Procurement Trigger and Response process component 150 about the creation, change, or deletion of any kind of order business objects. The operation 5114 is included in an Ordering Notification In interface 5116. The operation 5114 uses a Maintain Planning View of Purchase Order inbound process agent 5118 to create or change the planning view of the enclosed purchase order and to update the Planning View of Purchase Order business object 5112. The Planning View of Purchase Order business object 5112 represents a planning view of the materials, date, quantities, delivery conditions, parties, and sources of supply of a purchase order that are relevant to planning.

### Interactions Between Process Components “Data Migration System” and “Identity Management”

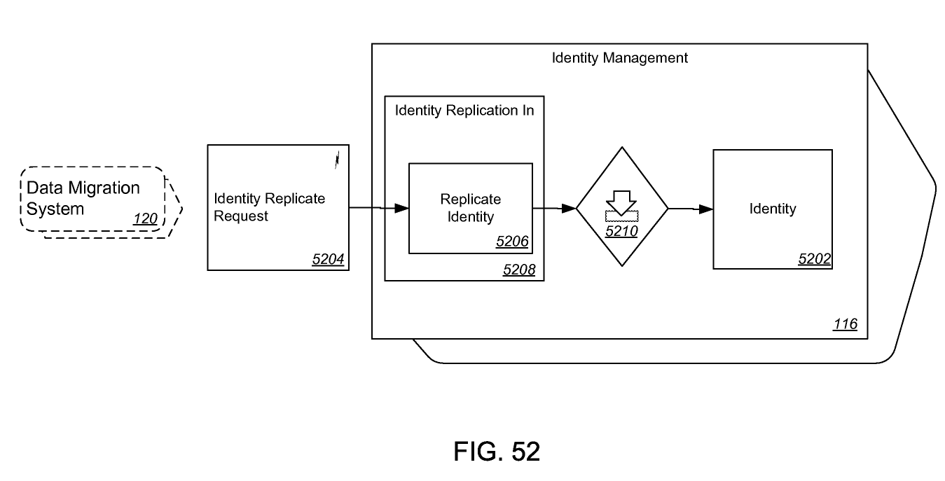

FIG. 52 is a block diagram showing interactions between the Data Migration System process component 120 and the Identity Management process component 116 in the architectural design of FIGS. 1A-D. The Data Migration System process component 120 provides data migration to the Identity Management process component 116. The interaction starts when identity data is received for migrating from a source to the Data Migration System process component 120.

As shown in FIG. 52, the Identity Management process component 116 includes the Identity business object 5202. The Identity business object 5202 represents a representation of the uniqueness of a human person or non-human subject in a uniform way. The identity specifies the person's or subject's credentials for accessing systems in a system landscape, the granted authorizations and the system settings which are valid for the person or subject.

A Replicate identity operation 5206 receives an Identity Replicate Request message 5204. The operation 5206 is included in an Identity Replication In interface 5208. The operation 5206 creates an identity based on a migrated data. The operation 5206 uses a Replicate Identity inbound process agent 5210 to update the Identity business object 5202.

### Interactions Between Process Components “Data Migration System” and “Time and Labor Management”

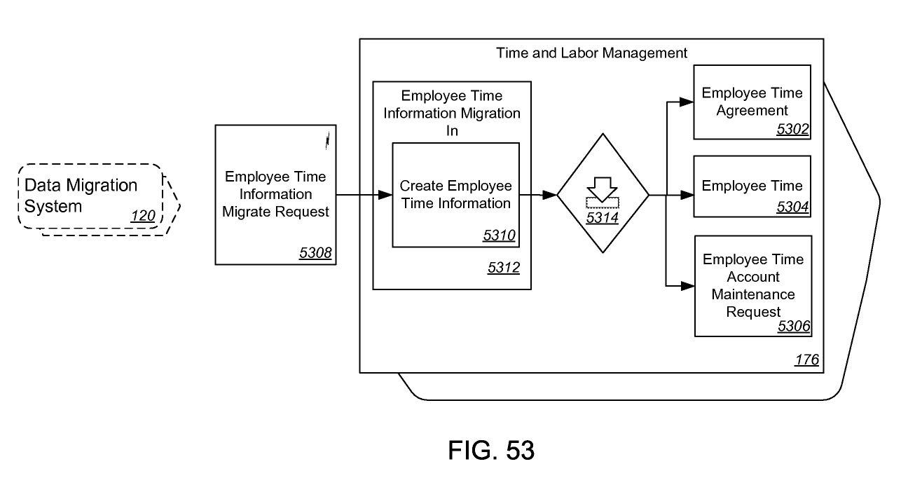

FIG. 53 is a block diagram showing interactions between the Data Migration System process component 120 and the Time and Labor Management process component 176 in the architectural design of FIGS. 1A-D. The Data Migration System process component 120 provides data migration to the Time and Labor Management process component 176. The interaction starts when legacy employee time information is received for migrating from a source to the Time and Labor Management process component 176.

As shown in FIG. 53, the Time and Labor Management process component 176 includes an Employee Time Agreement business object 5302, an Employee Time business object 5304, and an Employee Time Account Maintenance Request business object 5306.

The Employee Time Agreement business object 5302 represents an agreement between employer and employee consisting of time management stipulations that are derived from legal, company-specific, and pay-related provisions, and from terms agreed individually with the employee. The Employee Time business object 5304 represents a recorded document of the working times of an internal or external employee. In addition to planned and actual working times and activities carried out for the company, it also documents absence times, break times, and availability times. The Employee Time Account Maintenance Request business object 5306 represents a request to create, modify, or cancel an employee time account. It can request an increase or reduction of the times of one employee time account, a transfer of times from one employee time account to another, a payout of times, and/or a creation or cancellation of an employee time account.

A Create Employee Time Information operation 5310 receives an Employee Time Information Migrate Request message 5308. The message 5308 is used to convert information about an employee's time data that is to be migrated from a legacy system to the Time and Labor Management process component 176. The operation 5310 is included in an Employee Time Information Migration In interface 5312. The operation 5310 converts employment information which is to be migrated from a legacy system into Employment. The operation 5310 uses a Create Employee Time Information based on Migration inbound process agent 5314 to update the Employee Time Agreement business object 5302, the Employee Time business object 5304, and the Employee Time Account Maintenance Request business object 5306.

### Interactions Between Process Components “Migration Data Dispatching” and “Accounting”

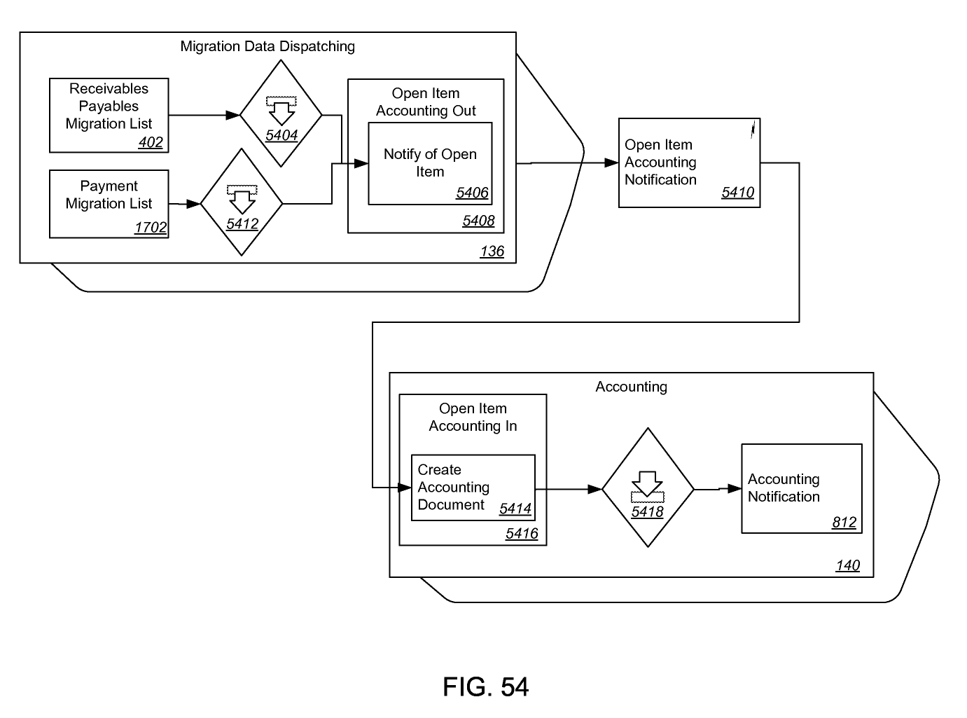

FIG. 54 is a block diagram showing interactions between the Migration Data Dispatching process component 136 and the Accounting process component 140 in the architectural design of FIGS. 1A-D. The Migration Data Dispatching process component 136 provides data migration to the Accounting process component 140. The interaction starts when accounting data is received for migrating from a source to the Accounting process component 140.

As shown in FIG. 54, the Migration Data Dispatching process component 136 includes the Receivables Payables Migration List business object 402 and the Payment Migration List business object 1702. The Receivables Payables Migration List business object 402 represents a list of open receivables or payables of a company that have to be migrated to a new system. The Payment Migration List business object 1702 represents a list of open payments of a company that are to be migrated to a new system.

The Receivables Payables Migration List business object 402 uses a Notify of Receivables Payables Migration List to Accounting outbound process agent 5404 to invoke a Notify of Open Item operation 5406. The operation 5406 sends information relevant for accounting to the Accounting process component 140. The operation 5406 is included in an Open Item Accounting Out interface 5408. The operation 5406 generates an Open Item Accounting Notification message 5410.

The Payment Migration List business object 1702 uses a Notify of Payment Migration List to Accounting outbound process agent 5412 to invoke the Notify of Open Item operation 5406. The operation 5406 generates the Open Item Accounting Notification message 5410.

The Accounting process component 140 includes the Accounting Notification business object 812. The Accounting Notification business object 812 represents a notification sent to Financial Accounting by an operational component regarding a business transaction. The notification represents this operational business transaction in a standardized form for all business transaction documents and contains the data needed to valuate the business transaction.

A Create Accounting Document operation 5414 receives the Open Item Accounting Notification message 5410. The operation 5414 is included in an Open Item Accounting In interface 5416. The operation 5414 receives open item accounting notifications from the Migration Data Dispatching process component 136. The operation 5414 uses a Maintain Payment Order inbound process agent 5418 to update the Accounting Notification business object 812.

### Interactions Between Process Components “Data Migration System” and “Migration Data Dispatching”

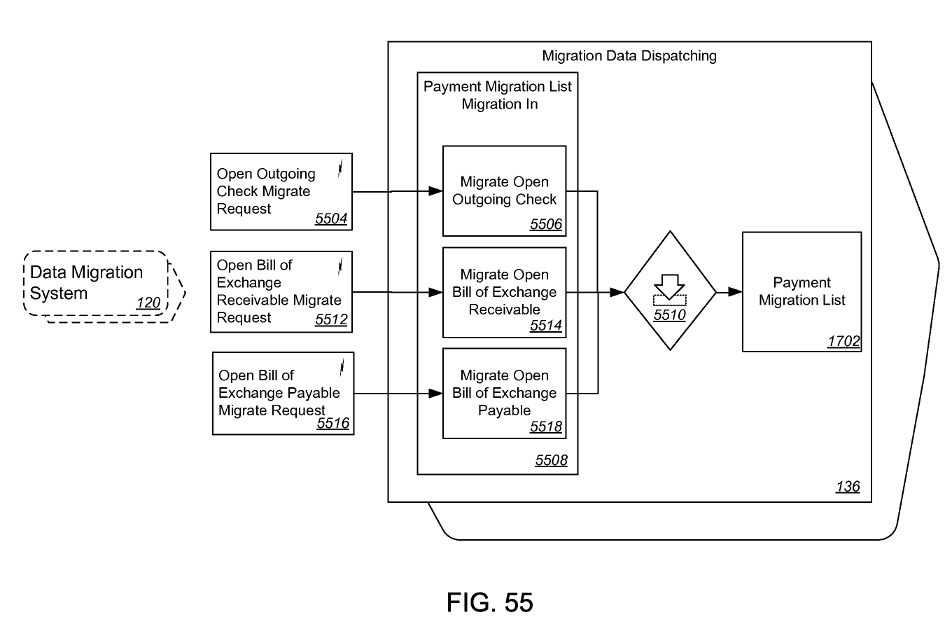

FIG. 55 is a block diagram showing interactions between the Data Migration System process component 120 and the Migration Data Dispatching process component 136, related to a payment migration list, in the architectural design of FIGS. 1A-D. The Data Migration System process component 120 provides data migration to the Migration Data Dispatching process component 136. The interaction starts when payment data is received for migrating from a source to the Migration Data Dispatching process component 136.

As shown in FIG. 55, the Migration Data Dispatching process component 136 includes the Payment Migration List business object 1702. The Payment Migration List business object 1702 represents a list of open payments of a company that have to be migrated to a new system.

A Migrate Open Outgoing Check operation 5506 receives an Open Outgoing Check Migrate Request message 5504. The operation 5506 is included in a Payment Migration List Migration In interface 5508. The operation 5506 converts information about open outgoing checks from migration data dispatching into a payment migration list for forwarding to the Payment Processing process component 144 and the Accounting process component 140. The operation 5506 uses a Migrate Payment Migration List inbound process agent 5510 to update the Payment Migration List business object 1702.

A Migrate Open Bill Of Exchange Receivable operation 5514 receives an Open Bill Of Exchange Receivable Migrate Request message 5512. The operation 5514 is included in the Payment Migration List Migration In interface 5508. The operation 5514 converts information about open bills of exchange receivable from Migration Data Dispatching into a payment migration list for forwarding to the Payment Processing process component 144 and the Accounting process component 140. The operation 5514 uses the Migrate Payment Migration List inbound process agent 5510 to update the Payment Migration List business object 1702.

A Migrate Open Bill Of Exchange Payable operation 5518 receives an Open Bill Of Exchange Payable Migrate Request message 5516. The operation 5518 is included in the Payment Migration List Migration In interface 5508. The operation 5518 converts information about open bills of exchange payable from Migration Data Dispatching into a payment migration list for forwarding to the Payment Processing process component 144 and the Accounting process component 140. The operation 5518 uses the Migrate Payment Migration List inbound process agent 5510 to update the Payment Migration List business object 1702.

### Interactions Between Process Components “Data Migration System” and “Employee Payroll Administration”

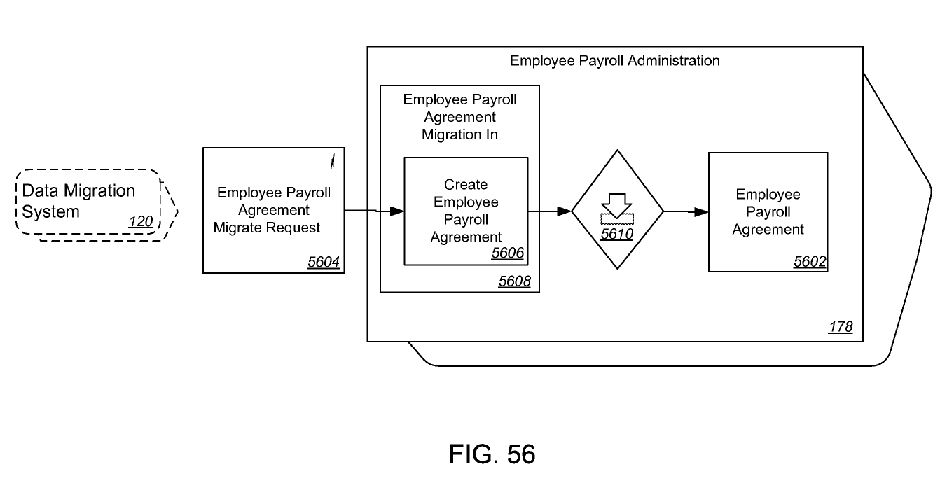

FIG. 56 is a block diagram showing interactions between the Data Migration System process component 120 and the Employee Payroll Administration process component 178 in the architectural design of FIGS. 1A-D. The Data Migration System process component 120 provides data migration to the Employee Payroll Administration process component 178. The interaction starts when employee payroll administration data is received for migrating from a source to the Employee Payroll Administration process component 178.

As shown in FIG. 56, the Employee Payroll Administration process component 178 includes an Employee Payroll Agreement business object 5602. The Employee Payroll Agreement business object 5602 represents an agreement between the employer and employee concerning the personal conditions for payroll processing. This agreement determines the fundamental differentials of the payroll behavior for the employee.

A Create Employee Payroll Agreement operation 5606 receives an Employee Payroll Agreement Migrate Request message 5604. The operation 5606 is included in an Employee Payroll Agreement Migration In interface 5608. The operation 5606 Converts information about payroll agreement data of an employee which is to be migrated from a legacy system into Employee Payroll Administration. The operation 5606 uses a Create Employee Payroll Agreement based on Migration inbound process agent 5610 to update the Employee Payroll Agreement business object 5602.

### Interactions Between Process Components “Data Migration System” and “AT Employer Regulatory Compliance”

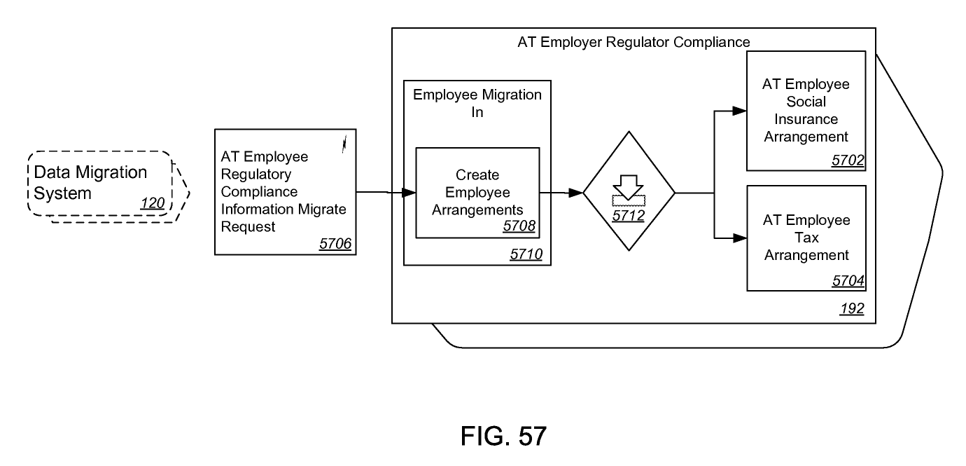

FIG. 57 is a block diagram showing interactions between the Data Migration System process component 120 and the AT Employer Regulatory Compliance process component 192 in the architectural design of FIGS. 1A-D. In some implementations, these interactions can be optional. The Data Migration System process component 120 provides data migration to the AT Employer Regulatory Compliance process component 192. The interaction starts when employee arrangement information is posted.

As shown in FIG. 57, the AT Employer Regulatory Compliance process component 192 includes an AT Employee Tax Arrangement business object 5702 and an AT Employee Social Insurance Arrangement business object 5704. The AT Employee Tax Arrangement business object 5702 represents an arrangement between the employee and the tax authorities of the People's Republic of China that defines the rules of how the employer must calculate and report taxes for this employee to be compliant with the legal requirements. The AT Employee Social Insurance Arrangement business object. 5704 represents an arrangement for the employee by the People's Republic of China bodies that are legally responsible for administering the employee's social insurance contributions and benefits. This arrangement concerns the information required for calculation of the People's Republic of China social insurance contributions and reporting according to the People's Republic of China Social Insurance Bodies.

A Create Employee Arrangements operation 5708 receives an AT Employee Regulatory Compliance Information Migrate Request message 5706. The operation 5708 is included in an Employee Migration In interface 5710. The operation 5708 creates business objects for employee arrangements in the AT Employer Regulatory Compliance process component 192. The operation 5708 uses a Create AT Employee Arrangements based on Migration inbound process agent 5712 to update the AT Employee Tax Arrangement business object 5702 and the AT Employee Social Insurance Arrangement business object 5704.

### Interactions Between Process Components “Data Migration System” and “CH Employer Regulatory Compliance”

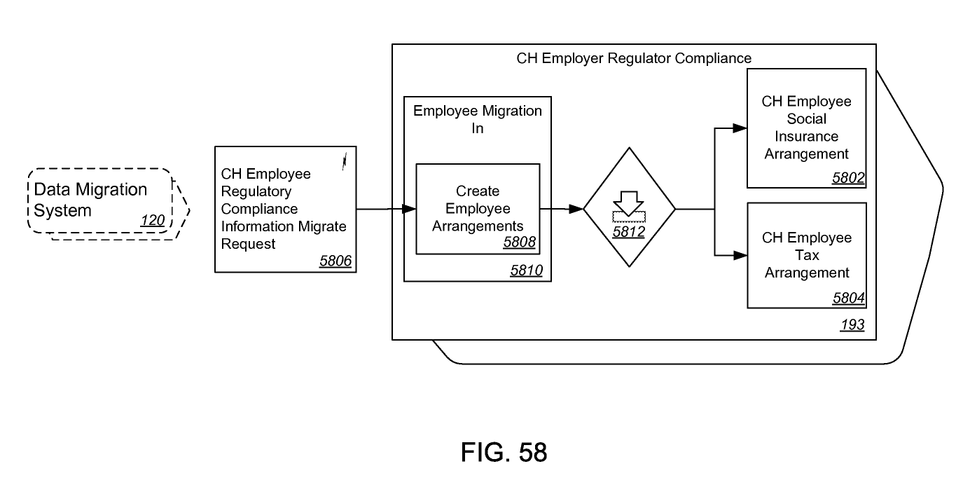

FIG. 58 is a block diagram showing interactions between the Data Migration System process component 120 and the CH Employer Regulatory Compliance process component 193 in the architectural design of FIGS. 1A-D. In some implementations, these interactions can be optional. The Data Migration System process component 120 provides data migration to the CH Employer Regulatory Compliance process component 193. The interaction starts when employee arrangement information is posted.

As shown in FIG. 58, the CH Employer Regulatory Compliance process component 193 includes a CH Employee Tax Arrangement business object 5802 and a CH Employee Social Insurance Arrangement business object 5804. The CH Employee Tax Arrangement business object 5802 represents an arrangement between the employee and the tax authorities of the People's Republic of China that defines the rules of how the employer must calculate and report taxes for this employee to be compliant with the legal requirements. The CH Employee Social Insurance Arrangement business object 5804 represents an arrangement for the employee by the People's Republic of China bodies that are legally responsible for administering the employee's social insurance contributions and benefits. This arrangement concerns the information required for calculation of the People's Republic of China social insurance contributions and reporting according to the People's Republic of China Social Insurance Bodies.

A Create Employee Arrangements operation 5808 receives a CH Employee Regulatory Compliance Information Migrate Request message 5806. The operation 5808 is included in an Employee Migration In interface 5810. The operation 5808 creates business objects for employee arrangements in the CH Regulatory Compliance process component 193. The operation 5808 uses a Create CH Employee Arrangements based on Migration inbound process agent 5812 to update the CH Employee Tax Arrangement business object 5802 and the CH Employee Social Insurance Arrangement business object 5804.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback; auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as an exemplification of preferred embodiments of the invention. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer program product comprising application software encoded on a tangible machine-readable information carrier, the application software being structured as process components interacting with each other through service interfaces, the software comprising:
a plurality of process components, each of the process components being a package of software implementing a respective and distinct business process, the plurality of process components including:
a migration data dispatching process component that processes data that must be migrated to more than one deployment unit and that must be kept consistent across the deployment units;
a due item processing process component that handles the collection, management, and monitoring or trade receivables or payables and corresponding sales tax or withholding tax;
an accounting process component that handles the representation of all relevant business transactions for valuation and profitability analysis;
a financial accounting master data management process component that handles the management of financial accounting master data that is used both for accounting and costing purposes;
a payment processing process component that handles the processing and management of all payments;
a purchase order processing process component that handles the creation and maintenance of purchase orders and purchase order confirmations;
a purchasing contract processing process component that handles the creation and maintenance of purchasing contracts;
an external procurement trigger and response process component that handles the management of all the tasks necessary for processing procurement planning orders and the interface to purchasing from a supply planning perspective; and
a supplier invoice processing process component that handles the management and volume processing of supplier invoices, including exception handling and approval; and
a plurality of service operations, each service operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
a data migration system process component and the migration data dispatching process component;
the purchase order processing process component and the accounting process component;
the migration data dispatching process component and the due item processing process component;
the data migration system process component and the purchase order processing process component;
the migration data dispatching process component and the payment processing process component;
the data migration system process component and the accounting process component;
the data migration system process component and the accounting process component related to an accounting entry;
the data migration system process component and the financial accounting master data management process component;
the data migration system process component and the purchasing contract processing process component;
the data migration system process component and the accounting process component related to an accounting notification;
the data migration system process component and the accounting process component related to a fixed asset and an accounting entry;
the purchase order processing process component and the supplier invoice processing process component;
the purchase order processing process component and the external procurement trigger and response process component;
the migration data dispatching process component and the accounting process component; and
the data migration system process component and the migration data dispatching process component related to a payment migration list.

2. The product of claim 1, wherein:
the plurality of process components further includes:
a product property management process component that manages product properties along with their valuations;
a production model management process component that maintains and releases master data required for production planning and production execution;
a business partner data management process component that manages all tile business partner master data of a company, including the information needed to describe the rights and obligations of a business partner participating in various business processes, such as sales, purchasing, and accounting processes;
a product data maintenance process component that maintains all product data that describes a company's tangible and intangible products, and that is used to control business processes such as sales, purchasing, planning, production, and accounting;
an installed base data management process component that manages and structures installed objects, such as personal computers or parts of a software installation, in an installed base, according to their logical or physical location;
a price master data management process component that manages prices and price-related data for sales and procurement processes;
an identity management process component that handles identifying individuals in a system landscape and controlling their access by associating user rights and restrictions;
an engineering change processing process component that processes changes to master data used in the product life-cycle phases engineering and manufacturing, including the definition of validity parameters and the release of the changes;
a sales order processing process component that handles the processing of customers' requests to seller for the delivery of goods, on a specific date, for a specific quantity, and for a specific price;
a service request processing process component that handles the logging and resolving of service requests concerning issues that customers have, usually with regard to products;
a customer problem and solution administration process component that handles the administration and maintenance of customer problem and solution master data that has, for example, been migrated or replicated from an external system;
an inventory processing process component that handles the management of inventory and recording of inventory changes;
a project processing process component that handles the structuring, planning, and execution of simple short-term measures and complex projects;
a personnel administration process component that handles the administration of personnel changes concerning employee master data and work agreements;
a compensation management process component that handles the planning and specification of compensation data for employees using appropriate reward strategies, which are based on predefined compensation structures and components;
a time and labor management process component that handles the management of employees' planned working times, and the recording and valuation of work performed and absence times;
an employee payroll administration process component that handles the administration of the employee specific payroll agreement and the overview of completed and planned payroll processes;
a DE employer regulatory compliance process component that handles the administration of employee data and reporting to authorities that employers in Germany are legally obligated to perform;
a US employer regulatory compliance process component that handles the administration of employee data and reporting to authorities that employers in the United States of America are legally obligated to perform;
an AU employer regulatory compliance process component that combines all activities an employer in Australia is obliged to perform with respect to employees;
a CA employer regulatory compliance process component that combines all activities an employer in Canada is obliged to perform with respect to employees;
a CN employer regulatory compliance process component that combines all reporting and other administrative activities that employers in China, with respect to employees, are legally obligated to perform;
a DK employer regulatory compliance process component that combines all reporting and other administrative activities that an employer in Denmark is obliged to perform with respect to employees;
an FR employer regulatory compliance process component that handles the administration of employee data and reporting to authorities that employers in France are legally obligated to perform;
a GB employer regulatory compliance process component that handles the administration of employee data and reporting to authorities that employers in the United Kingdom are legally obligated to perform;
an IT employer regulatory compliance process component that handles the administration of employee data and reporting to authorities that employers in Italy are legally obligated to perform;
an NL employer regulatory compliance process component that combines all activities an employer in the Netherlands is obliged to perform with respect to employees;
an SG employer regulatory compliance process component that combines all activities an employer in Singapore is obliged to perform with respect to employees;
a ZA employer regulatory compliance process component that combines all activities an employer in South Africa is obliged to perform with respect to employees;
an AT employer regulatory compliance process component that combines all reporting and other administrative activities that an employer in Austria is obliged to perform with respect to employees; and
a CH employer regulatory compliance process component that combines all reporting and other administrative activities that an employer in Switzerland is obliged to perform with respect to employees; and
the pair-wise interactions between pairs of the process components further include interactions between:
the data migration system process component and the product data maintenance process component;
the data migration system process component and the product property management process component;
the data migration system process component and the business partner data management process component;
the data migration system process component and the installed base data management process component;
the data migration system process component and the business partner data management process component related to a supplier;
the data migration system process component and the product data maintenance process component related to a service product, a service product sales process control, a service product financials process control, and the service product procurement process control;
the data migration system process component and the production model management process component;
the data migration system process component and the business partner data management process component related to a customer, a payment agreement, and the sales arrangement;
the data migration system process component and the price master data management process component;
the data migration system process component and the business partner data management process component related to a business partner;
the data migration system process component and the production model management process component related to a production bill of material;
the data migration system process component and the engineering change processing process component;
the data migration system process component and the product data maintenance process component related to an identified stock;
the data migration system process component and the installed base data management process component related to an installed base;
the data migration system process component and the product data maintenance process component related to an individual material and an individual material service process control;
the data migration system process component and the price master data management process component related to a sales price specification;
the data migration system process component and the product data maintenance process component related to a warranty service process control business and the warranty;
the data migration system process component and the identity management process component;
the data migration system process component and the inventory processing process component;
the data migration system process component and the sales order processing process component;
the data migration system process component and the service request processing process component;
the data migration system process component and the compensation management process component;
the data migration system process component and the project processing process component;
the data migration system process component and the personnel administration process component;
the data migration system process component and the customer problem and solution administration process component;
the data migration system process component and the time and labor management process component;
the data migration system process component and the employee payroll administration process component;
the data migration system process component and the CN employer regulatory compliance process component;
the data migration system process component and the IT employer regulatory compliance process component;
the data migration system process component and the DE employer regulatory compliance process component;
the data migration system process component and the US employer regulatory compliance process component;
the data migration system process component and the GB employer regulatory compliance process component;
the data migration system process component and the DK employer regulatory compliance process component;
the data migration system process component and the NL employer regulatory compliance process component;
the data migration system process component and the SG employer regulatory compliance process component;
the data migration system process component and the FR employer regulatory compliance process component;
the data migration system process component and the CA employer regulatory compliance process component;
the data migration system process component and the ZA employer regulatory compliance process component;
the data migration system process component and the AU employer regulatory compliance process component;
the data migration system process component and the AT employer regulatory compliance process component; and
the data migration system process component and the CH employer regulatory compliance process component.

3. The product of claim 1, wherein:
each of the plurality of process components is assigned to exactly one deployment unit among multiple deployment units, and each deployment unit is deployable on a separate computer hardware platform independent of every other deployment unit; and
all interaction between a process component in one deployment unit and any other process component in any other deployment unit takes place through the respective service interfaces of the two process components.

4. The product of claim 3, wherein the deployment units comprise:
a foundation deployment unit that includes a product property management process component, a production model management process component, a business partner data management process component, a product data maintenance process component, an installed base data management process component, a price master data management process component, an identity management process component, and an engineering change processing process component;
a migration adapter deployment unit that includes a migration data dispatching process component;
a due item management deployment unit that includes a due item processing process component;
a financial accounting deployment unit that includes an accounting process component and a financial accounting master data management process component;
a payment deployment unit that includes a payment processing process component;
a purchasing deployment unit that includes a purchase order processing process component and a purchasing contract processing process component;
a supply chain control deployment unit that includes an external procurement trigger and response process component;
a supplier invoicing deployment unit that includes a supplier invoice processing process component;
a customer relationship management deployment unit that includes a sales order processing process component, a service request processing process component, and a customer problem and solution administration process component;
a production and site logistics execution deployment unit that includes an inventory processing process component;
a project management deployment unit that includes a project processing process component; and
a human capital management deployment unit that includes a personnel administration process component, a compensation management process component, a time and labor management process component, an employee payroll administration process component, a DE employer regulatory compliance process component, a US employer regulatory compliance process component, an AU employer regulatory compliance process component, a CA employer regulatory compliance process component, a CN employer regulatory compliance process component, a DK employer regulatory compliance process component, an FR employer regulatory compliance process, a GB employer regulatory compliance process component, an IT employer regulatory compliance process component, an NL employer regulatory compliance process component, an SG employer regulatory compliance process component, a ZA employer regulatory compliance process component, an AT employer regulatory compliance process component, and a CH employer regulatory compliance process component.

5. The product of claim 1, wherein:
each of the process components includes one or more business objects; and
none of the business objects of any one of the process components interacts directly with any of the business objects included in any of the other process components.

6. The product of claim 5, wherein the business objects comprise a business process object.

7. The product of claim 5, wherein none of the business objects included in any one of the process components is included in any of the other process components.

8. The product or claim 1, further comprising a plurality of process agents, each process agent being either an inbound process agent or an outbound process agent, an inbound process agent being operable to receive a message from an inbound operation, an outbound process agent being operable to cause an outbound operation to send a message, and each process agent being associated with exactly one process component.

9. The product of claim 8, wherein the inbound process agents comprise a first inbound process agent operable to start the execution of a business process step requested in a first inbound message by creating or updating one or more business object instances.

10. The product of claim 8, wherein the outbound process agents comprise a first asynchronous outbound process agent that is called after a business object that is associated with the first outbound process agent changes.

11. The product of claim 1, wherein the operations comprise synchronous and asynchronous operations.

12. A system, comprising:
a computer system comprising one or more hardware platforms for executing a computer software application;
a plurality of process components, each of the process components being a package of software implementing a respective and distinct business process, the plurality of process components including:
a migration data dispatching process component that processes data that must be migrated to more than one deployment unit and that must be kept consistent across the deployment units;
a due item processing process component that handles the collection, management, and monitoring of trade receivables or payables and corresponding sales tax or withholding tax;
an accounting process component that handles the representation of all relevant business transactions for valuation and profitability analysis;
a financial accounting master data management process component that handles the management of financial accounting master data that is used both for accounting and costing purposes;
a payment processing process component that handles the processing and management of all payments;
a purchase order processing process component that handles the creation and maintenance of purchase orders and purchase order confirmations;
a purchasing contract processing process component that handles the creation and maintenance of purchasing contracts;
an external procurement trigger and response process component that handles the management of all the tasks necessary for processing procurement planning orders and the interface to purchasing from a supply planning perspective; and
a supplier invoice processing process component that handles the management and volume processing of supplier invoices, including exception handling and approval; and
the purchase order processing process component and the accounting process component;
the migration data dispatching process component and the due item processing process component;
the data migration system process component and the purchase order processing process component;
the migration data dispatching process component and the payment processing process component;
the data migration system process component and the accounting process component;
the data migration system process component and the accounting process component related to an accounting entry;
the data migration system process component and the financial accounting master data management process component;
the data migration system process component and the purchasing contract processing process component;
the data migration system process component and the accounting process component related to an accounting notification;
the data migration system process component and the accounting process component related to a fixed asset and an accounting entry;
the purchase order processing process component and the supplier invoice processing process component;
the purchase order processing process component and the external procurement trigger and response process component;
the migration data dispatching process component and the accounting process component; and
the data migration system process component and the migration data dispatching process component related to a payment migration list.

13. The system of claim 12, wherein the plurality of process components further includes:
a product property management process component that manages product properties along with their valuations;
a production model management process component that maintains and releases master data required for production planning and production execution;
a business partner data management process component that manages all the business partner master data of a company, including the information needed to describe the rights and obligations of a business partner participating in various business processes, such as sales, purchasing, and accounting processes;
a product data maintenance process component that maintains all product data that describes a company's tangible and intangible products, and that is used to control business processes such as sales, purchasing, planning, production, and accounting;
an installed base data management process component that manages and structures installed objects, such as personal computers or parts of a software installation, in an installed base, according to their logical or physical location;
a price master data management process component that manages prices and price-related data for sales and procurement processes;
an identity management process component that handles identifying individuals in a system landscape and controlling their access by associating user rights and restrictions;
an engineering change processing process component that processes changes to master data used in the product life-cycle phases engineering and manufacturing, including the definition of validity parameters and the release of the changes;
a sales order processing process component that handles the processing of customers' requests to seller for the delivery of goods, on a specific date, for a specific quantity, and for a specific price;
a service request processing process component that handles the logging and resolving of service requests concerning issues that customers have, usually with regard to products;
a customer problem and solution administration process component that handles the administration and maintenance of customer problem and solution master data that has, for example, been migrated or replicated from an external system;
an inventory processing process component that handles the management of inventory and recording of inventory changes;
a project processing process component that handles the structuring, planning, and execution of simple short-term measures and complex projects;
a personnel administration process component that handles the administration of personnel changes concerning employee master data and work agreements;
a compensation management process component that handles the planning and specification of compensation data for employees using appropriate reward strategies, which are based on predefined compensation structures and components;
a time and labor management process component that handles the management of employees' planned working times, and the recording and valuation of work performed and absence times;
an employee payroll administration process component that handles the administration of the employee specific payroll agreement and the overview of completed and planned payroll processes;
a DE employer regulatory compliance process component that handles the administration of employee data and reporting to authorities that employers in Germany are legally obligated to perform;
a US employer regulatory compliance process component that handles the administration of employee data and reporting to authorities that employers in the United States of America are legally obligated to perform;
an AU employer regulatory compliance process component that combines all activities an employer in Australia is obliged to perform with respect to employees;
a CA employer regulatory compliance process component that combines all activities an employer in Canada is obliged to perform with respect to employees;
a CN employer regulatory compliance process component that combines all reporting and other administrative activities that employers in China, with respect to employees, are legally obligated to perform;
a DK employer regulatory compliance process component that combines all reporting and other administrative activities that an employer in Denmark is obliged to perform with respect to employees;
an FR employer regulatory compliance process component that handles the administration of employee data and reporting to authorities that employers in France are legally obligated to perform;
a GB employer regulatory compliance process component that handles the administration of employee data and reporting to authorities that employers in the United Kingdom are legally obligated to perform;
an IT employer regulatory compliance process component that handles the administration of employee data and reporting to authorities that employers in Italy are legally obligated to perform;
an NL employer regulatory compliance process component that combines all activities an employer in the Netherlands is obliged to perform with respect to employees;
an SG employer regulatory compliance process component that combines all activities an employer in Singapore is obliged to perform with respect to employees;
a ZA employer regulatory compliance process component that combines all activities an employer in South Africa is obliged to perform with respect to employees;
an AT employer regulatory compliance process component that combines all reporting and other administrative activities that an employer in Austria is obliged to perform with respect to employees; and
a CH employer regulatory compliance process component that combines all reporting and other administrative activities that an employer in Switzerland is obliged to perform with respect to employees; and
the pair-wise interactions between pairs of the process components include interactions between:
the data migration system process component and the product data maintenance process component;
the data migration system process component and the product property management process component;
the data migration system process component and the business partner data management process component;
the data migration system process component and the installed base data management process component;
the data migration system process component and the business partner data management process component related to a supplier;
the data migration system process component and the product data maintenance process component related to a service product, a service product sales process control, a service product financials process control, and the service product procurement process control;
the data migration system process component and the production model management process component;
the data migration system process component and the business partner data management process component related to a customer, a payment agreement, and the sales arrangement;
the data migration system process component and the price master data management process component;
the data migration system process component and the business partner data management process component related to a business partner;
the data migration system process component and the production model management process component related to a production bill of material;
the data migration system process component and the engineering change processing process component;
the data migration system process component and the product data maintenance process component related to an identified stock;
the data migration system process component and the installed base data management process component related to an installed base;
the data migration system process component and the product data maintenance process component related to an individual material and an individual material service process control;
the data migration system process component and the price master data management process component related to a sales price specification;
the data migration system process component and the product data maintenance process component related to a warranty service process control business and the warranty;
the data migration system process component and the identity management process component;
the data migration system process component and the inventory processing process component;
the data migration system process component and the sales order processing process component;
the data migration system process component and the service request processing process component;
the data migration system process component and the compensation management process component;
the data migration system process component and the project processing process component;
the data migration system process component and the personnel administration process component;
the data migration system process component and the customer problem and solution administration process component;
the data migration system process component and the time and labor management process component;
the data migration system process component and the employee payroll administration process component;
the data migration system process component and the CN employer regulatory compliance process component;
the data migration system process component and the IT employer regulatory compliance process component;
the data migration system process component and the DE employer regulatory compliance process component;
the data migration system process component and the US employer regulatory compliance process component;
the data migration system process component and the GB employer regulatory compliance process component;
the data migration system process component and the DK employer regulatory compliance process component;
the data migration system process component and the NL employer regulatory compliance process component;
the data migration system process component and the SG employer regulatory compliance process component;
the data migration system process component and the FR employer regulatory compliance process component;
the data migration system process component and the CA employer regulatory compliance process component;
the data migration system process component and the ZA employer regulatory compliance process component;
the data migration system process component and the AU employer regulatory compliance process component;
the data migration system process component and the AT employer regulatory compliance process component; and
the data migration system process component and the CH employer regulatory compliance process component.

14. The system of claim 12, wherein:
each of the process components includes one or more business objects; and
none of the business objects of any one of the process components interacts directly with any of the business objects included in any of the other process components.

15. The system of claim 12, wherein none of the business objects included in any one of the process components is included in any of the other process components.

16. The system of claim 12, further comprising a plurality of process agents, each process agent being either an inbound process agent or an outbound process agent, an inbound process agent being operable to receive a message from an inbound operation, an outbound process agent being operable to cause an outbound operation to send a message, and each process agent being associated with exactly one process component.

17. The system of claim 12, the system comprising multiple hardware platforms, wherein:
the product property management process component, the production model management process component, the business partner data management process component, the product data maintenance process component, the installed base data management process component, the price master data management process component, the identity management process component, and the engineering change processing process component are deployed on a first hardware platform;
the migration data dispatching process component is deployed on a second hardware platform;
the due item processing process component is deployed on a third hardware platform;
the accounting process component and the financial accounting master data management process component are deployed on a fourth hardware platform;
the payment processing process component is deployed on a fifth hardware platform;
the purchase order processing process component and the purchasing contract processing process component are deployed on a sixth hardware platform;
the external procurement trigger and response process component is deployed oil a seventh hardware platform;
the supplier invoice processing process component is deployed on an eighth hardware platform;
the sales order processing process component, the service request processing process component, and the customer problem and solution administration process component are deployed on a ninth hardware platform;
the inventory processing process component is deployed on a tenth hardware platform;
the project processing process component is deployed on an eleventh hardware platform; and
the personnel administration process component, the compensation management process component, the time and labor management process component, the employee payroll administration process component, the DE employer regulatory compliance process component, the US employer regulatory compliance process component, the AU employer regulatory compliance process component, the CA employer regulatory compliance process component, the CN employer regulatory compliance process component, the DK employer regulatory compliance process component, the FR employer regulatory compliance process, the GB employer regulatory compliance process component, the IT employer regulatory compliance process component, the NL employer regulatory compliance process component, the SG employer regulatory compliance process component, the ZA employer regulatory compliance process component, the AT employer regulatory compliance process component, and the CH employer regulatory compliance process component are deployed on a twelfth hardware platform.

18. The system of claim 17, wherein each of the first through the twelfth hardware platforms are distinct and separate from each other.

19. A method for developing a computer software application, comprising:
obtaining in a computer system digital data representing an architectural design for a set of processes implementing an end-to-end application process, the design specifying a process component for each process in the set of processes and the design further specifying a set of process component interactions, wherein:
the specified process components include:
a migration data dispatching process component that processes data that must be migrated to more than one deployment unit and that must be kept consistent across the deployment units;
a due item processing process component that handles the collection, management, and monitoring of trade receivables or payables and corresponding sales tax or withholding tax;
an accounting process component that handles the representation of all relevant business transactions for valuation and profitability analysis;
a financial accounting master data management process component that handles the management of financial accounting master data that is used both for accounting and costing purposes;
a payment processing process component that handles the processing and management of all payments;
a purchase order processing process component that handles the creation and maintenance of purchase orders and purchase order confirmations;
a purchasing contract processing process component that handles the creation and maintenance of purchasing contracts;
an external procurement trigger and response process component that handles the management of all the tasks necessary for processing procurement planning orders and the interface to purchasing from a supply planning perspective; and
a supplier invoice processing process component that handles the management and volume processing of supplier invoices, including exception handling and approval; and
the process component interactions include interactions between:
a data migration system process component and the migration data dispatching process component;
the purchase order processing process component and the accounting process component;
the migration data dispatching process component and the due item processing process component;
the data migration system process component and the purchase order processing process component;
the migration data dispatching process component and the payment processing process component;
the data migration system process component and the accounting process component;
the data migration system process component and the accounting process component related to an accounting entry;
the data migration system process component and the financial accounting master data management process component;
the data migration system process component and the purchasing contract processing process component;
the data migration system process component and the accounting process component related to an accounting notification;
the data migration system process component and the accounting process component related to a fixed asset and an accounting entry;
the purchase order processing process component and the supplier invoice processing process component;
the purchase order processing process component and the external procurement trigger and response process component;
the migration data dispatching process component and the accounting process component; and
the data migration system process component and the migration data dispatching process component related to a payment migration list; and
using the design including the specified process components and the specified process component interactions to develop a computer software application to perform the set of processes.

20. The method of claim 19, wherein:
the specified process components further include:
a product property management process component that manages product properties along with their valuations;
a production model management process component that maintains and releases master data required for production planning and production execution;
a business partner data management process component that manages all the business partner master data of a company, including the information needed to describe the rights and obligations of a business partner participating in various business processes, such as sales, purchasing, and accounting processes;
a product data maintenance process component that maintains all product data that describes a company's tangible and intangible products, and that is used to control business processes such as sales, purchasing, planning, production, and accounting;
an installed base data management process component that manages and structures installed objects, such as personal computers or parts of a software installation, in an installed base, according to their logical or physical location;
a price master data management process component that manages prices and price-related data for sales and procurement processes;
an identity management process component that handles identifying individuals in a system landscape and controlling their access by associating user rights and restrictions;
an engineering change processing process component that processes changes to master data used in the product life-cycle phases engineering and manufacturing, including the definition of validity parameters and the release of the changes;
a sales order processing process component that handles the processing of customers' requests to seller for the delivery of goods, on a specific date, for a specific quantity, and for a specific price;
a service request processing process component that handles the logging and resolving of service requests concerning issues that customers have, usually with regard to products;
a customer problem and solution administration process component that handles the administration and maintenance of customer problem and solution master data that has, for example, been migrated or replicated from an external system;
an inventory processing process component that handles the management of inventory and recording of inventory changes;
a project processing process component that handles the structuring, planning, and execution of simple short-term measures and complex projects;
a personnel administration process component that handles the administration or personnel changes concerning employee master data and work agreements;
a compensation management process component that handles the planning and specification of compensation data for employees using appropriate reward strategies, which are based on predefined compensation structures and components;
a time and labor management process component that handles the management of employees' planned working times, and the recording and valuation of work performed and absence times;
an employee payroll administration process component that handles the administration of the employee specific payroll agreement and the overview of completed and planned payroll processes;
a DE employer regulatory compliance process component that handles the administration of employee data and reporting to authorities that employers in Germany are legally obligated to perform;
a US employer regulatory compliance process component that handles the administration of employee data and reporting to authorities that employers in the United States of America are legally obligated to perform;
an AU employer regulatory compliance process component that combines all activities an employer in Australia is obliged to perform with respect to employees;
a CA employer regulatory compliance process component that combines all activities an employer in Canada is obliged to perform with respect to employees;
a CN employer regulatory compliance process component that combines all reporting and other administrative activities that employers in China, with respect to employees, are legally obligated to perform;
a DK employer regulatory compliance process component that combines all reporting and other administrative activities that an employer in Denmark is obliged to perform with respect to employees;
an FR employer regulatory compliance process component that handles the administration of employee data and reporting to authorities that employers in France are legally obligated to perform;
a GB employer regulatory compliance process component that handles the administration of employee data and reporting to authorities that employers in the United Kingdom are legally obligated to perform;
an IT employer regulatory compliance process component that handles the administration of employee data and reporting to authorities that employers in Italy are legally obligated to perform;
an NL employer regulatory compliance process component that combines all activities an employer in the Netherlands is obliged to perform with respect to employees;
an SG employer regulatory compliance process component that combines all activities an employer in Singapore is obliged to perform with respect to employees;
a ZA employer regulatory compliance process component that combines all activities an employer in South Africa is obliged to perform with respect to employees;
an AT employer regulatory compliance process component that combines all reporting and other administrative activities that an employer in Austria is obliged to perform with respect to employees; and
a CH employer regulatory compliance process component that combines all reporting and other administrative activities that an employer in Switzerland is obliged to perform with respect to employees; and
the process component interactions further include interactions between:
the data migration system process component and the product data maintenance process component;
the data migration system process component and the product property management process component;
the data migration system process component and the business partner data management process component;
the data migration system process component and the installed base data management process component;
the data migration system process component and the business partner data management process component related to a supplier;
the data migration system process component and the product data maintenance process component related to a service product, a service product sales process control, a service product financials process control, and the service product procurement process control;
the data migration system process component and the production model management process component;
the data migration system process component and the business partner data management process component related to a customer, a payment agreement, and the sales arrangement;
the data migration system process component and the price master data management process component;
the data migration system process component and the business partner data management process component related to a business partner;
the data migration system process component and the production model management process component related to a production bill of material;
the data migration system process component and the engineering change processing process component;
the data migration system process component and the product data maintenance process component related to an identified stock;
the data migration system process component and the installed base data management process component related to an installed base;
the data migration system process component and the product data maintenance process component related to an individual material and an individual material service process control;
the data migration system process component and the price master data management process component related to a sales price specification;
the data migration system process component and the product data maintenance process component related to a warranty service process control business and the warranty;
the data migration system process component and the identity management process component;
the data migration system process component and the inventory processing process component;
the data migration system process component and the sales order processing process component;
the data migration system process component and the service request processing process component;
the data migration system process component and the compensation management process component;
the data migration system process component and the project processing process component;
the data migration system process component and the personnel administration process component;
the data migration system process component and the customer problem and solution administration process component;
the data migration system process component and the time and labor management process component;
the data migration system process component and the employee payroll administration process component;
the data migration system process component and the CN employer regulatory compliance process component;
the data migration system process component and the IT employer regulatory compliance process component;
the data migration system process component and the DE employer regulatory compliance process component;
the data migration system process component and the US employer regulatory compliance process component;
the data migration system process component and the GB employer regulatory compliance process component;
the data migration system process component and the DK employer regulatory compliance process component;
the data migration system process component and the NL employer regulatory compliance process component;
the data migration system process component and the SG employer regulatory compliance process component;
the data migration system process component and the FR employer regulatory compliance process component;
the data migration system process component and the CA employer regulatory compliance process component;
the data migration system process component and the ZA employer regulatory compliance process component;
the data migration system process component and the AU employer regulatory compliance process component;
the data migration system process component and the AT employer regulatory compliance process component; and
the data migration system process component and the CH employer regulatory compliance process component.

21. The method of claim 19, wherein each process in the set of processes is a business process transforming a defined business input into a defined business outcome.

22. The method of claim 21, wherein obtaining digital data representing the architectural design further comprises editing the design before using the design.
